(19) United States
(12) Patent Application Publication
(10) Pub. No.: US 2022/0252550 A1
(43) Pub. Date: Aug. 11, 2022

(54) Ultrasound Acoustic Field Manipulation Techniques

(71) Applicant: Ultraleap Limited, Bristol (GB)

(72) Inventors: Salvador Catsis, Bristol (GB); Jurek Dziewierz, Bristol (GB); Benjamin John Oliver Long, Bristol (GB); Brian Kappus, Campbell, CA (US)

(21) Appl. No.: 17/583,230

(22) Filed: Jan. 25, 2022

Related U.S. Application Data
(60) Provisional application No. 63/266,972, filed on Jan. 20, 2022.
(60) Provisional application No. 63/167,855, filed on Mar. 30, 2021.
(60) Provisional application No. 63/156,829, filed on Mar. 4, 2021.
(60) Provisional application No. 63/141,897, filed on Jan. 26, 2021.

(51) Int. Cl. G01N 29/26; G10K 11/34; G06F 3/01

(52) U.S. Cl. CPC G01N 29/262; G06F 3/016; G01N 2291/106; G10K 11/346

(57) ABSTRACT

Two methods for rendering haptic surfaces through spatial modulation of ultrasound are described: Singular Value Decomposition (SVD) with Tikhonov Regularization and Mini-Batch, Stochastic Gradient Descent with Momentum (MSGDM). Further, adjustment in the placement of transducers, arrays can be generated which allow for variable focus points using a limited set of driving signals. This is accomplished by generating a set of mutually-exclusive transducer placement layouts which when driven together produce a set of sufficiently orthogonal fields at various points of interest. Further, using basic transformations on sampling locations a field can be translated or rotated in 3-dimensional space. This enables the creation of spatiotemporal modulated haptics with reduced computation. Further, mid-air haptics using ultrasound can be generated via amplitude modulation or via spatial modulation of control points defined at spatial locations in an acoustic field above a phased array device.

### PRIOR APPLICATIONS

This application claims the benefit of:

(1) U.S. Provisional Patent Application No. 63/141,897, filed Jan. 26, 2021;

(2) U.S. Provisional Patent Application No. 63/156,829, filed on Mar. 4, 2021;

(3) U.S. Provisional Patent Application No. 63/167,855, filed on Mar. 30, 2021; and

(4) U.S. Provisional Patent Application No. 63/266,972, filed on Jan. 20, 2022.

All of these applications are incorporated by reference in their entirety.

### FIELD OF THE DISCLOSURE

The present disclosure relates generally to improved manipulation techniques in acoustic transducer structures used in mid-air haptic systems.

### BACKGROUND

Ultrasonic phased arrays can be used to create arbitrary acoustic fields. These can be used for haptic feedback, parametric audio, acoustic trapping, etc. The rendering of haptic surfaces is desirable for various applications areas such as; virtual reality, augmented reality and gesture control. The current method for rendering haptic surfaces involves the spatiotemporal modulation of single or multiple focal points. The problem we are trying to solve is the development of alternative methods for rendering haptic surfaces.

Gavrilov et al. pioneered early research into the possibility of using focused ultrasound as a non-invasive method for stimulating nerve structures in humans. Gavrilov, Leonid R., et al. “A study of reception with the use of focused ultrasound. I. Effects on the skin and deep receptor structures in man.” Brain research 135.2 (1977): 265-277; Gavrilov, Leonid R., et al. “A study of reception with the use of focused ultrasound. II. Effects on the animal receptor structures.” Brain research 135.2 (1977): 279-285; Gavrilov, L. R. “Use of focused ultrasound for stimulation of nerve structures.” Ultrasonics 22.3 (1984): 132-138.

Gavrilov et al. went on to describe the mechanism by which focused ultrasound could be used to elicit tactile sensations. The non-linear, acoustic radiation force of focused ultrasound induces a shear wave in the skin. This shear wave produces an associated displacement that triggers certain mechanoreceptors in the skin. Gavrilov, L., and E. Tsirulnikov. “Mechanisms of stimulation effects of focused ultrasound on neural structures: Role of nonlinear effects.” Nonlinear Acoust. at the Beginning of the 21st Cent (2002): 445-448.

Hoshi et al. developed a prototype two dimensional, ultrasonic phased-array capable of translating a single high intensity, focal point in a volume above the array. This system enabled users to interact with virtual objects through haptic feedback. Algorithms for producing multiple high intensity focal points using ultrasonic phased arrays had already been developed in the medical ultrasound community. Hoshi, Takayuki, et al. “Noncontact tactile display based on radiation pressure of airborne ultrasound.” IEEE Transactions on Haptics 3.3 (2010): 155-165.

In particular, the conjugate field method of Ibinni et al. and the pseudo-inverse method of Ebbini et al. Ibbini, Mohammed S., and Charles A. Cain. “A field conjugation method for direct synthesis of hyperthermia phases-array heating patterns.” IEEE transactions on ultrasonics, ferroelectrics, and frequency control 36.1 (1989): 3-9. Ebbini, Emad S., and Charles A. Cain. “Multiple-focus ultrasound phased-array pattern synthesis: optimal driving-signal distributions for hyperthermia.” IEEE transactions on ultrasonics, ferroelectrics, and frequency control 36.5 (1989): 540-548.

Drawing on research from the field of computer-generated holography. Hertzberg et al. demonstrated that the iterative, weighted Gerchberg-Saxton (GSW) algorithm could be adapted to efficiently produce multiple high intensity focal points in 2D. Hertzberg, Yoni, et al. “Towards multifocal ultrasonic neural stimulation: pattern generation algorithms.” Journal of neural engineering 7.5 (2010): 056002.

In an attempt to develop a more stable and more efficient algorithm, Long et al. extended the pseudo-inverse method with a power iteration step. The power iteration step aims to find the set of phases that should be assigned to the focal points in order to maximize the constructive interference and minimize the destructive interference. Long, Benjamin. et al. “Rendering volumetric haptic shapes in mid-air using ultrasound.” ACM Transactions on Graphics (TOG) 33.6 (2014): 181.

This produced higher intensity focal points with a lower computational cost than Ebbini et al.'s weighted generalized inverse algorithm.

Kappus et al. presented a more efficient implementation of this method by exploiting a property of the pseudo-inverse. Kappus, Brian, and Ben Long. “Spatiotemporal modulation for mid-air haptic feedback from an ultrasonic phased array.” The Journal of the Acoustical Society of America 143.3 (2018): 1836-1836.

Marzo et al. provided the iterative backpropagation algorithm which is essentially an iterative extension of Ibinni et al.'s conjugate field method. Marzo Pérez, Asier, and Bruce W. Drinkwater. “Holographic acoustic tweezers.” Proceedings of The National Academy of Sciences, 116 (1), 84-89(2019). More recently, Inoue et al. formulated the problem as a semi-definite programming problem and solved it using a block coordinate descent method. Inoue, Seki, Yasutoshi Makino, and Hiroyuki Shinoda. “Active touch perception produced by airborne ultrasonic haptic hologram.” 2015 IEEE World Haptics Conference (WHC). IEEE, 2015.

Further, a phased array of acoustic transducers requires individually addressable elements in order to have flexibility in focus locations. This requires many separate drive circuits which themselves need to be supplied with variable phase and amplitude. This adds cost and sophistication. In many applications, this level of flexibility is not necessary. For instance, one application of phased acoustic arrays is mid-air haptics from focused ultrasound. Adding haptics to a fixed interface may only require 3-4 selectable focus locations and having an array capable of thousands of different focus locations will leave that functionality wasted. This invention shows how to design a phased array system with minimal drive signals to achieve only the necessary number of focal points using specific, derived, arrangements of transducers.

There have been 2 prior different arrangements which provide a focus using a specific layout.

1. A bowl arrangement provides a focus at the geometric center of the bowl with all transducers driven in parallel.

2. A ring arrangement where each ring is spaced at one or one-half wavelength from a focus above the center of the rings.

Further, in order to generate mid-air haptics from a phased array of ultrasonic transducers, a focus must be formed and intersect the hand or body part for which haptics is desired. Generating this field requires a set of driving (phase and amplitude) values to be produced for each transducer in the phased array. In addition, this solution must be updated dynamically as the target moves relative to the array. This is a computationally expensive task.

There are many different ‘solvers’ which exist to approach this problem. In most cases, they use some kind of transducer model which, along with linear algebra, is used to create a set of activation coefficients. This requires a costly level of computation. This invention instead uses basic transformations on a pre-computed solution stored in memory to deliver a similar level of flexibility using less computation.

Further, a continuous distribution of sound energy, which will be referred to as an “acoustic field”, can be used for a range of applications including haptic feedback in mid-air, sound-from-ultrasound systems and producing encoded wave fields for use by tracking and imaging systems.

By defining one of more control points in space, the acoustic field can be controlled. Each point can be assigned a value equating to a desired amplitude at the control point. A physical set of transducers can then be controlled to create an acoustic field exhibiting the desired amplitude at the control points.

By using an ultrasonic carrier frequency, the points of control can be made small enough to be useful and with no consequent audible sound effect. However, a static acoustic field at a power level suitable for a wide range of use cases imparts too small a force to be detectable by human skin, so consequently a fluctuation in time must be added that sensitizes the skin to the acoustic field by exploiting frequencies and skin movement speeds that create more noticeable haptic sensations. Creating extra fluctuations in time using traditional methods involves complicated systems to control the system through time.

Typically, the amplitude or position must be modified in time to generate a frequency that excites the mechanoreceptors in human skin to produce a strong haptic response. There are a number of ways to provoke such a suitable frequency component, although mostly this is achieved by directly modulating either the position or amplitude at an appropriate frequency.

This can be achieved indirectly however by using beat frequencies—frequencies generated as the sum or difference between two time-harmonic acoustic fields at different frequencies, such that given an acoustic field at a single frequency ω₁ and a second acoustic field at a frequency ω₂, when overlaid, an amplitude modulation effect is created which may be a frequency suitable for creating a haptic effect. This may be written as:

s₁(x,t)= [symbol] (φ₁(x)exp(i(ω₁t+ϕ₁))),

s₂(x,t)= [symbol] (φ₂(x)exp(i(ω₂t+ϕ₂))),

where φ is a complex valued function that varies spatially defining the wavefunction, which includes phase and amplitude, with the frequency ω and phase offset ϕ.

By then defining the combined system as the superposition, that is:

$$s ( x , t ) = ( {\sum }_{k = 1}^{2} {φ}_{k} ( x ) exp ( i ( {ω}_{k} t + {ϕ}_{k} ) ) ) = {\sum }_{k = 1}^{2} \vert {φ}_{k} ( x ) \vert cos ( arg ( {φ}_{k} ( x ) ) + {ω}_{k} t + {ϕ}_{k} ) ,$$

where the equal-amplitude component can be written as a product, which is equivalent to an amplitude modulation of the average by the difference:

$$= 2 \vert {φ}_{1} ( x ) \vert cos ( \frac{{ρ}_{1} + {ρ}_{2}}{2} ) cos ( \frac{{ρ}_{1} - {ρ}_{2}}{2} ) + ( \vert {φ}_{2} ( x ) \vert - \vert {φ}_{1} ( x ) \vert ) cos ( {ρ}_{2} )$$

$$= 2 \vert {φ}_{2} ( x ) \vert cos ( \frac{{ρ}_{2} + {ρ}_{1}}{2} ) cos ( \frac{{ρ}_{2} - {ρ}_{1}}{2} ) + ( \vert {φ}_{1} ( x ) \vert - \vert {φ}_{2} ( x ) \vert ) cos ( {ρ}_{1} ) ,$$

where the sinusoidal angle is defined by:

ρₖ=arg(φₖ(x))+ωₖt+ϕₖ.

When using this to create an amplitude modulation for acoustic mid-air haptics for example, one could use a 39950 Hz and 40050 Hz tone with equal amplitude to create a 50 Hz amplitude modulation of a carrier frequency at 40000 Hz. This is especially useful for transducers that exhibit strong resonant properties or are otherwise designed for use at a specific frequency; by driving them at slightly offset frequencies to generate the difference tone with high efficiency, this can create specific haptic effects with electronics that only needs to generate simple tones.

This has previously been exploited to generate single or multiple points of amplitude modulated haptic feedback.

### SUMMARY

Two methods for rendering haptic surfaces through spatial modulation of ultrasound are shown: Singular Value Decomposition (SVD) with Tikhonov Regularization and Mini-Batch, Stochastic Gradient Descent with Momentum (MSGDM). These methods are variations of extant algorithms from the medical ultrasound and human-computer interaction (HCI) literature.

Further, traditional phased arrays of acoustic transducers require independent drive circuitry for each element to adjust the output field in a useful way. This invention introduces a method whereby allowing for adjustment in the placement of transducers, arrays can be generated which allow for variable focus points using a limited set of driving signals. This is accomplished by generating a set of mutually-exclusive transducer placement layouts which when driven together produce a set of sufficiently orthogonal fields at various points of interest. When driven at specific relative phases the resulting fields sum to produce a specific high pressure acoustic focus at one point of interest while minimizing all others. Focus points can be activated one at a time or in sequence using amplitude modulation or multiple frequencies.

Further, by sampling a set of activation coefficients on a pre-computed focusing solution, one can reproduce that field. Then, using basic transformations on the sampling locations, this field can be translated or rotated in 3-dimensional space. This enables the creation of spatiotemporal modulated haptics with reduced computation.

Further, mid-air haptics using ultrasound can be generated via amplitude modulation or via spatial modulation of control points defined at spatial locations in an acoustic field above a phased array device. The amplitude modulation effect can be generated using a previously disclosed method to generate a difference tone at one or more points, however, there has been no prior disclosure of a method to achieve spatial modulation of points in any equivalent fashion. In this disclosure, methods to use the same effect in conjunction with phased arrays at multiple frequencies to generate complex patterns that mimic spatially modulated motion using the phase of the difference tone will be described.

### BRIEF DESCRIPTION OF THE DRAWINGS

The accompanying figures, where like reference numerals refer to identical or functionally similar elements throughout the separate views, together with the detailed description below, are incorporated in and form part of the specification, serve to further illustrate embodiments of concepts that include the claimed invention and explain various principles and advantages of those embodiments.

FIGS. 1, 2, and 3 are plots depicting the activation coefficients required to generate the Ultrahaptics with the Chebyshev directivity model.

FIG. 4 is a plot where amplitude utilization is defined as the sum of the amplitudes of all the transducers divided by the total number of transducers.

FIGS. 5 and 6 are plots demonstrating the measured acoustic field obtained by propagating the activation coefficients with the Chebyshev directivity model.

FIG. 7 depicts a solution field using reciprocity with array simulation.

FIG. 8 depicts a solution field using a pseudoinverse with array simulation.

FIG. 9 depicts a real projection of a set of simulated pressure fields.

FIG. 10 depicts an imaginary projection of a set of simulated pressure fields.

FIG. 11 depicts a structured acoustic field generation using a solution field to guide transducer placement.

FIG. 12 shows a decision flow chart for populating transducers for multiple solutions fields simultaneously.

FIG. 13 depicts an example execution of the algorithm in FIG. 12.

FIG. 14 depicts the final populated transducer array built using solution fields from FIG. 13.

FIG. 15 shows plots of the normalized real projection of the simulated acoustic field produced by each group from FIG. 14.

FIG. 16 shows plots of normalized pressure field simulation produced by transducer arrangement and grouping from FIG. 14.

FIG. 17 shows plots of example populated transducer arrays using pre-rotation of source solution fields.

FIG. 18 depicts an example layout with a center-excluded region.

FIG. 19 shows a time-domain simulation of a 6-point, 117 transducer at 40 kHz embodiment.

FIGS. 20, 21, 22, and 23 show a time-domain simulation of a 6-point, 117 transducer at 40 kHz embodiment.

FIG. 24 is an example 256-element solution sampling.

FIGS. 25, 26, 27, 28, and 29 show example 256-element solution samplings with offset.

FIG. 30 shows an example 256-element solution sampling with rotation offset.

FIG. 31 shows an example 256-element solution sampling with a z-offset transformation.

FIG. 32 shows an example 256-element solution sampling with a translation in x followed by a z-offset transformation.

FIG. 33 shows an example 256-element solution sampling, illustrating the sum of two solutions.

FIGS. 34, 35, 36, 37, and 38 show slices of the acoustic field generated from one of the carrier frequencies, where shading is linearly proportional to amplitude and phase angle.

FIG. 39 shows a grouped-transducer layout design based upon solution fields generated to form a heart-shaped pattern in a plane at z=10 cm.

FIG. 40 shows the populated transducer array produced by data from FIG. 39.

FIG. 41 shows a simulation of the normalized pressure amplitude at z=10 cm generated by data from FIG. 40.

FIG. 42 shows a normalized pressure produced by an acoustic field simulation of the array shown in FIG. 40.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

### 1) Algorithms for Rendering Haptic Surfaces

### I. Defining the Problem

We can approximate the far-field acoustic pressure field emitted by a single ultrasonic transducer as:

Ψ_{q}(r_{kq},X_{q})=H(r_{kQ})X_{q}

where
Ψ_{q}(r_{kq},X_{q}) is the complex-valued, far-field acoustic pressure field emitted by a single ultrasonic transducer.
r_{kq} is the vector oriented from the transducer q to the sampling point k.
X_{q}=A_{q}e^{iφ}^{_{q}} is the complex-valued activation coefficient.
H(r_{kq}) is the directivity function which models the transducer.

We then assume that the total field emitted by a phased array of an ultrasonic transducer, excited by independent signals, can be modelled as a linear combination of the fields emitted by each individual transducer yielding

$$Ψ ( {r}_{k *} , x ) = {\sum }_{q = 1}^{n} {Ψ}_{q} ( {r}_{kq} , {X}_{q} ) ,$$

where:
r_{k*}=rₖ₁, rₖ₂, . . . , rₖₙ is a list of vectors from each transducer q to a given point k.
r_{**}=r₁₁, r₁₂, . . . , r₁ₙ, . . . , rₘ₁, rₘ₂, . . . , rₘₙ is a list of all the vectors from each transducer q to each point k.
x=X₁, X₂, . . . , Xₙ is a vector containing the activation coefficients for each transducer.

Let Ψ^{D} be the discretised, desired field defined on a set of points r₁, r₂, . . . , rₘ. We can now formalize the problem as an optimization problem of the form:

$${min}_{x} [ {\sum }_{k = 1}^{m} Ψ ( {r}_{k *} , x ) - {Ψ}^{D} ( {r}_{k} ) ]$$

such that

0≤|X_{q}|≤1,∀q∈(1,2, . . . ,n)

### II. Singular Value Decomposition (SVD) with Tikhonov Regularization

A. Formulating the Linear System

Building on the notation above, we can formulate the minimization problem as finding a solution to a complex-valued linear system Ax=b where A is the complex-valued, forward propagation operator, x is the complex-valued vector of activation coefficients and b is the complex-valued, desired field collapsed into a vector. In particular we have,

$$A ∈ {ℂ}^{m \times n} , x ∈ {ℂ}^{n \times 1} , b ∈ {ℂ}^{m \times 1}$$

$$A = [ \begin{matrix}H ( {r}_{11} ) & … & H ( {r}_{1 n} ) \\ ⋮ & ⋱ & ⋮ \\ H ( {r}_{m 1} ) & … & H ( {r}_{mn} )\end{matrix} ]$$

$$x = [ \begin{matrix}{X}_{1} \\ ⋮ \\ {X}_{n}\end{matrix} ]$$

$$b = [ \begin{matrix}{Ψ}^{D} ( {r}_{1} ) \\ ⋮ \\ {Ψ}^{D} ( {r}_{m} )\end{matrix} ]$$

B. Column Weighing

In order to improve the numerical accuracy of any solution to the linear system, we can normalize the operator A using the 2-norm of each column. We can construct a weighting operator, W_{c}∈ [symbol] ^{n×n}, defined as:

$${W}_{c} = [ \begin{matrix}\frac{1}{{‖ {A}_{* 1} ‖}_{2}} & … & 0 \\ ⋮ & ⋱ & ⋮ \\ 0 & … & \frac{1}{{‖ {A}_{* n} ‖}_{2}}\end{matrix} ]$$

We can then define a new linear system to solve:

AW_{c}x=b

C. Row Weighing

Standard techniques used to find the least-squares solution to the linear system assume homoscedasticity in the error terms. For this linear system, this means that the error between the generated field and the desired field would be assumed to have the same variance for each point in the desired field:

E[ϵₖ²|x]=σ²

where,

ϵₖ²=|Ψ(r_{k*},x)−Ψ^{D}(rₖ)|

When this assumption does not hold, one can improve the results of the solution by weighting the operator A with a weighting operator, Wᵣ∈ [symbol] ^{m×m}, defined as:

$${W}_{r} = [ \begin{matrix}{W}_{11} & … & 0 \\ ⋮ & ⋱ & ⋮ \\ 0 & … & {W}_{m m}\end{matrix} ]$$

The diagonal elements, Wₖₖ, reflect the influence that each point in the desired field has in generating the activation coefficients. We can then define a new linear system:

WᵣAx=b

This weighting operator allows a user more control over the field they would like to produce. For instance, they may care more or less about the value of the field in the area outside the desired shape and therefore choose to weight these field points accordingly.

D. Tikhonov Regularization

For what follows, let us assume that the user has decided to use neither row weighting nor column weighting. It is worth noting that this does not change the derivation significantly. The complex-valued forward propagation operator can also be interpreted as a mapping from one space to another A: [symbol] ⁿ→ [symbol] ⁿ. Given this mapping, regularisation can be defined as a parametric family of approximate inverse operators R_{α}: [symbol] ⁿ→ [symbol] ⁿ.

Tikhonov's regularization seeks to find a solution to the least-squares problem with a small 2-norm. The problem can be expressed as a minimization problem of the form:

min [symbol] (∥Ax−b∥₂+α∥x∥₂)

The solution can be written as:

x_{α}=R_{α}b

=(A^{H}A+αI)⁻¹A^{H}b

E. SVD Solution

In general, the singular value decomposition or SVD can be used to solve a linear system. The SVD of a complex-valued operator A is given by A=UΣV^{H}. The solution of a linear system Ax=b can then be computed using the Moore-Penrose pseudoinverse, A⁺, as

x=A⁺b

where the Moore-Penrose pseudoinverse can be expressed in terms of the SVD

A⁺=VΣ⁺U^{H}.

We can then exploit an identity of the pseudoinverse to reduce the computational cost of the algorithm. Given the relationship:

A⁺=(A^{H}A)⁺A^{H}

we can express the solution of the linear system Ax=b as

x=(A^{H}A)⁺A^{H}b

=VₚΣₚ⁺Uₚ^{H}A^{H}b

where:

(A^{H}A)⁺=VₚΣₚ⁺Uₚ^{H}

Given that A is an (m×n) matrix and A^{H} is an (n×m) matrix the product (A^{H}A)⁺ is an (n×n) matrix. Since the computation of the SVD is the bottleneck in this algorithm, performing the SVD on an (n×n) provides a significant speed up over computing the SVD on an (m×n) matrix. This also makes the algorithm more scalable to larger problems, as the computation of the SVD now scales with O(n³(k+k′)) as opposed to O(knm²+k′n³).

F. SVD with Tikhonov Regularization

The solution to the Tikhonov regularization problem posed in II.D can be expressed using the SVD:

$${x}_{α} = {R}_{a} b = {( {A}^{H} A + α I )}^{- 1} {A}^{H} b = {V ( {Σ}^{+} Σ + α I )}^{- 1} {Σ}^{+} {U}^{H} b$$

This solution can be rewritten using the identity described in II.E:

$${x}_{α} = {V ( {Σ}^{+} Σ + α I )}^{- 1} {Σ}^{+} {U}^{h} b = {{V}_{p} ( {Σ}_{p}^{+} {Σ}_{p} + α I )}^{- 1} {Σ}_{p}^{+} {U}_{p}^{H} {A}^{H} b$$

The parameter α reduces the contribution of the singular values of A to the solution vector x_{α} as a function of the size of the singular value. The reciprocal of the i-th singular value,

$$\frac{1}{{σ}_{i}} ,$$

is scaled by the function:

$$\frac{{σ}_{i}^{2}}{{σ}_{i}^{2} + α}$$

This means that the reciprocal of smaller singular values is attenuated more than the reciprocal of larger singular values. An (m×n) matrix A can be thought of as a linear transformation operator which maps a vector in [symbol] ⁿ to a vector in [symbol] ^{m}. The SVD shows us that the linear transformation operator A can be decomposed into the weighted sum of k linear transformations, where k is the rank of A.

The singular values determine the influence of each of these linear transformations. Large singular values indicate that the contribution of the corresponding linear transformation is large and vice versa. In addition, the magnitude of the singular values determines the magnitude of the norm of the solution vector x_{α}. Scaling the reciprocal of the singular values with the function defined above, reduces the magnitude of the norm of the solution vector by attenuating the contribution of the less influential linear transformations more than the more influential linear transformations. The idea is that we can reduce the power output of the transducers without significantly affecting the quality of the solution.

We have implemented this algorithm in Python using numpy. It runs quite fast but could be accelerated using the randomized SGD algorithm and porting the code to OpenCL so that it can run on a GPU.

G. Optimal Value for the Tikhonov Regularization Parameter α

The choice of the Tikhonov regularization parameter α affects the quality and magnitude of the solution vector obtained x_{α}. In particular, there is a trade-off between the accuracy and magnitude of the solution. For large values of α the solution x_{α} is inaccurate but has a small magnitude and vice versa. There are various methods that can be used to determine the optimal value of α for the given problem such as; the discrepancy principle, the L-curve and the GCV. These methods are generally computationally expensive as they involve solving a minimization problem.

To obviate this computational cost, we suggest determining reasonable values of α with a data-based approach. An example of such an approach could involve determining the best α for a range of different surfaces and then finding the average α.

### III. Mini-Batch, Stochastic Gradient Descent with Momentum (MSGDM)

We can use the mini-batch, stochastic gradient descent (SGD) with momentum algorithm to solve a minimization problem similar to that posed in Section I. We begin by defining an error function at a given point k as:

E(r_{k*},x)=(Ψ(r_{k*},x)−Ψ^{D}(rₖ))(Ψ(r̅_̅{̅k̅*̅}̅,̅x̅)̅−Ψ̅^̅{̅D̅}̅(̅r̅ₖ̅)̅).

Given this error function, we can define a real-valued objective function that we would like to minimize:

$$F ( {r}_{B *} , x ) = \frac{1}{b} {\sum }_{k ∈ B} E ( {r}_{k *} , x ) ,$$

where
B is a set of b uniformly selected points from the range {1, 2, . . . , m} where b<m.
The cardinality of B is b, i.e., |B|=b.
r_{B*}:=r_{k*}∀k∈B.

We then find the partial derivatives of the objective function with respect to each of the transducer activation coefficients X_{q}. The function is defined on a complex-valued parameter space so we must use Wirtinger calculus to determine the partial derivatives as:

$$\frac{\partial }{\partial {X}_{q}} F ( {r}_{B *} , x ) = \frac{1}{2} ( \frac{\partial }{\partial ℝ [ {X}_{q} ]} F ( {r}_{B *} , x ) - i \frac{\partial }{\partial 𝕀 [ {X}_{q} ]} F ( {r}_{B *} , x ) ) .$$

We can then use these partial derivatives to determine the update equations for the real and imaginary components of the activation coefficients:

$$ℝ [ {X}_{q}^{t + 1} ] = ℝ [ {X}_{q}^{t} ] - \frac{γ}{2 b} \frac{\partial }{\partial ℝ [ {X}_{q}^{t} ]} F ( {r}_{B *} , {x}^{t} ) , 𝕀 [ {X}_{q}^{t + 1} ] = 𝕀 [ {X}_{q}^{t} ] + \frac{γ}{2 b} \frac{\partial }{\partial 𝕀 [ {X}_{q}^{t} ]} F ( {r}_{B *} , {x}^{t} ) .$$

The hyperparameter γ∈ [symbol] ⁺ controls the step-size of the gradient descent.

We have just described vanilla mini-batch, stochastic gradient descent. This algorithm does not always proceed in the optimal direction because we are estimating the derivative of the objective function as opposed to computing it exactly. In addition, SGD has trouble navigating ravines near local minima. A ravine is an area where the surface of the objective function has a steeper gradient in one dimension than in another. The SGD algorithm tends to oscillate between the steep slopes rather than moving directly towards the minimum along the shallow gradient. Both of these problems can be mitigated by introducing the idea of momentum. Momentum is defined as a moving average of the gradients of the objective function. SGD with momentum works by first computing the momentum and then using this momentum to update the activation coefficients.

The update equations are then given by:

$$ℝ [ {V}_{q}^{t + 1} ] = β ℝ [ {V}_{q}^{t} ] + ( 1 - β ) \frac{y}{2 b} \frac{\partial }{\partial ℝ [ {X}_{q}^{t} ]} F ( {r}_{B *} , {x}^{t} ) , 𝕀 [ {V}_{q}^{t + 1} ] = β 𝕀 [ {V}_{q}^{t} ] + ( 1 - β ) \frac{γ}{2 b} \frac{\partial }{\partial 𝕀 [ {X}_{q}^{t} ]} F ( {r}_{B *} , {x}^{t} ) , ℝ [ {X}_{q}^{t + 1} ] = ℝ [ {X}_{q}^{t} ] - ℝ [ {V}_{q}^{t} ] , 𝕀 [ {X}_{q}^{t + 1} ] = I [ {X}_{q}^{t} ] + 𝕀 [ {V}_{q}^{t} ] ,$$

where [symbol] [V_{q}^{t}] and [symbol] [V_{q}^{t}] represents the momentum at time t in the direction of the axis defining the real part of X_{q} and the imaginary part of X_{q} respectively. The hyperparameter β∈ [symbol] ⁺ roughly determines the number of gradients, backwards in time, that are used to form the moving average.

A. MSGDM with Tikhonov Regularization

We can introduce a Tikhonov regularization term into the objective function to constrain the magnitude of our solution vector x yielding;

$$F ( {r}_{B *} , x ) = \frac{1}{b} {\sum }_{k ∈ B} E ( {r}_{k *} , x ) + λ x . \overline{x} ,$$

where λ∈ [symbol] ⁺ is a hyperparameter which controls the amount of regularisation.

As before, we can then find the partial derivatives of this objective function with respect to each activation coefficient to determine the update equations for the real and imaginary components of the activation coefficients which gives:

$$ℝ [ {V}_{q}^{t + 1} ] = β ℝ [ {V}_{q}^{t} ] + ( 1 - β ) \frac{y}{2 b} ( \frac{\partial }{\partial ℝ [ {X}_{q}^{t} ]} F ( {r}_{B *} , {x}^{t} ) + 2 λℝ [ {X}_{q}^{t} ] ) , [ {V}_{q}^{t + 1} ] = β 𝕀 [ {V}_{q}^{t} ] + ( 1 - β ) \frac{γ}{2 b} ( \frac{\partial }{\partial 𝕀 [ {X}_{q}^{t} ]} F ( {r}_{B *} , {x}^{t} ) , + 2 λ𝕀 [ {X}_{q}^{t} ] ) , ℝ [ {X}_{q}^{t + 1} ] = ℝ [ {X}_{q}^{t} ] - ℝ [ {V}_{q}^{t} ] , [ {X}_{q}^{t + 1} ] = [ {X}_{q}^{t} ] + 𝕀 [ {V}_{q}^{t} ] .$$

B. MSGDM with Amplitude Regularization

One of the main benefits of using the gradient descent approach is that we have more control over the error function that we would like to minimize. We can introduce a different term into the update equations that acts to push the activation coefficients onto a circle of an unknown radius in the complex plane. This can be beneficial as it increases the magnitude of the activation coefficients which can increase the acoustic pressure over the desired surface. This leads to new update equations given by

$$ℝ [ {V}_{q}^{t + 1} ] = β ℝ [ {V}_{q}^{t} ] + ( 1 - β ) \frac{y}{2 b} \frac{\partial }{\partial ℝ [ {X}_{q}^{t} ]} F ( {r}_{B *} , {x}^{t} ) ( γ - α \vert {X}_{q}^{t} \vert ) , [ {V}_{q}^{t + 1} ] = β 𝕀 [ {V}_{q}^{t} ] + ( 1 - β ) \frac{γ}{2 b} \frac{\partial }{\partial 𝕀 [ {X}_{q}^{t} ]} F ( {r}_{B *} , {x}^{t} ) , ( γ - α \vert {X}_{q}^{t} \vert ) , ℝ [ {X}_{q}^{t + 1} ] = ℝ [ {X}_{q}^{t} ] - ℝ [ {V}_{q}^{t} ] , [ {X}_{q}^{t + 1} ] = [ {X}_{q}^{t} ] + 𝕀 [ {V}_{q}^{t} ] , where \\ [ {X}_{q}^{t} ] = {( {ℝ [ {X}_{q}^{t} ]}^{2} + {[ {X}_{q}^{t} ]}^{2} )}^{\frac{1}{2}}$$

and α∈ [symbol] ⁺ is a hyperparameter which controls the extent to which the algorithm increases the magnitude of the activation coefficients.

We have implemented both types of the MSGDM algorithms in OpenCL so that they can run efficiently on any laptop that contains a GPU. It is worth noting that the implementation uses a first order approximation to the expression for the partial derivatives in order to reduce the computational cost of computing the update equations.

C. Alternative Objective Function

It is worth noting that the objective function discussed above is only differentiable in a small radius R around the origin of the complex plane z=0. This means that it is difficult to provide any convergence guarantees for the algorithm. In practice, the algorithm works sufficiently well. But if we wanted to be more rigorous, we could use a different objective function that is differentiable on the entire complex plane. We can first define a differentiable error function as

E(r_{k*},x)=(Ψ(r_{k*},x)−Ψ^{D}(rₖ))(Ψ(r_{k*},x)−Ψ^{D}(rₖ))

and use this to define a complex-valued objective function as

$$F ( {r}_{B *} , x ) = \frac{1}{b} {\sum }_{k ∈ B} E ( {r}_{k *} , x ) .$$

This complex-valued objective function will have multiple local minima that have the same absolute error |E(r_{k*},x)|. There will be an infinite number of local minima that have the same absolute error. This may increase or decrease the convergence rate for a given initial vector.

### IV. Examples

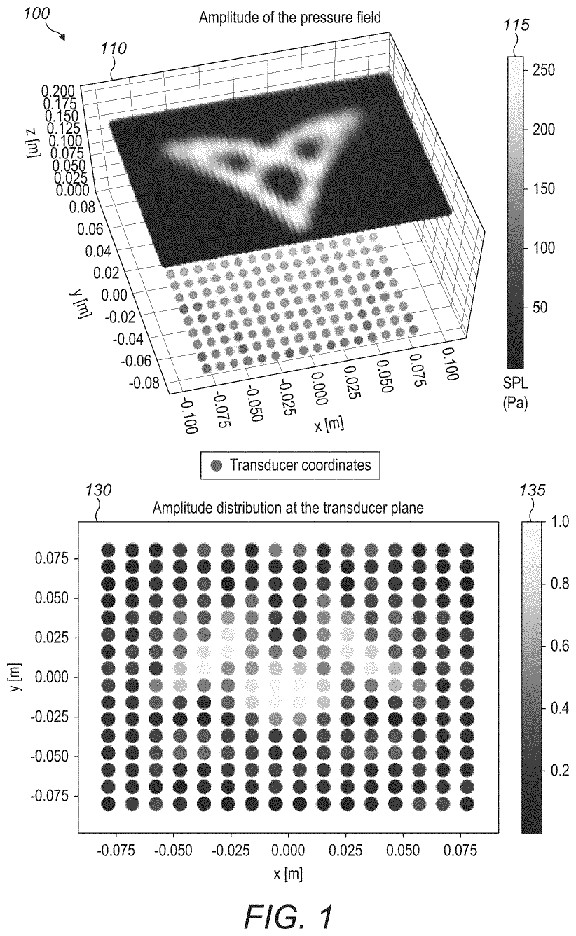

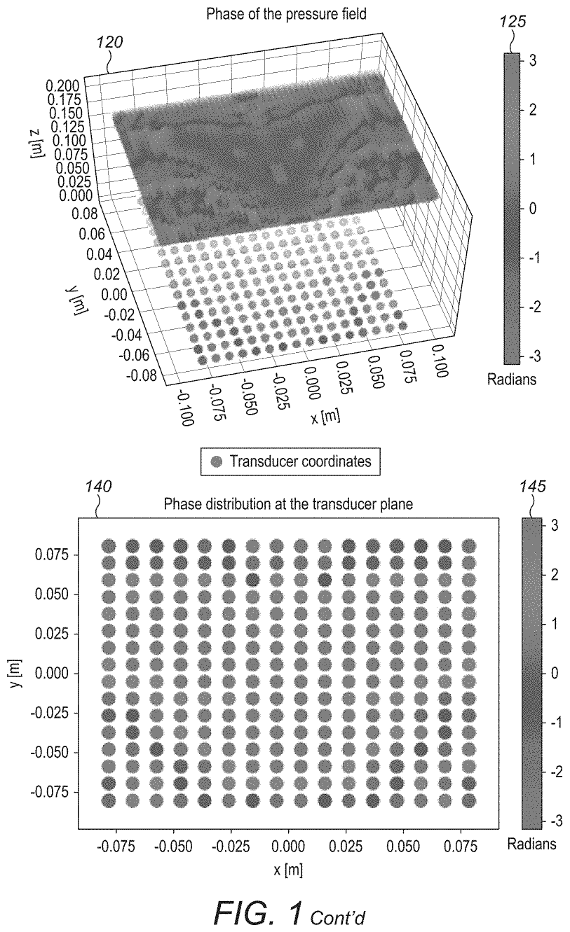

Shown in FIG. 1 are a group of plots 100 depicting the activation coefficients required to generate the Ultrahaptics logo at a height of 200 mm above the array and the simulated acoustic field obtained by propagating the activation coefficients with the Chebyshev directivity model. The first figure 110 shows a plot of the amplitude of the pressure field with the scale 115 of sound pressure level (SPL) in Pascals. The second FIG. 130 shows a plot of the amplitude distribution at the transducer plane of the pressure field with the scale 135 showing driving amplitude where 1.0 is full drive. The third FIG. 120 shows a plot of the phase of the pressure field with the scale 125 in radians. The fourth FIG. 140 shows a plot of the phase distribution at the transducer plane with the scale 145 in radians. The activation coefficients were computed using the SVD with Tikhonov regularization algorithm.

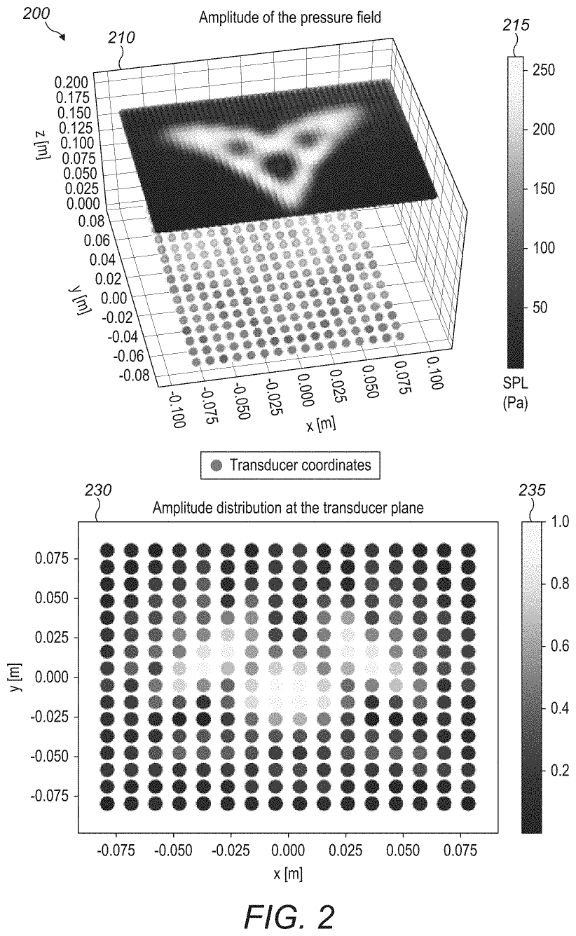

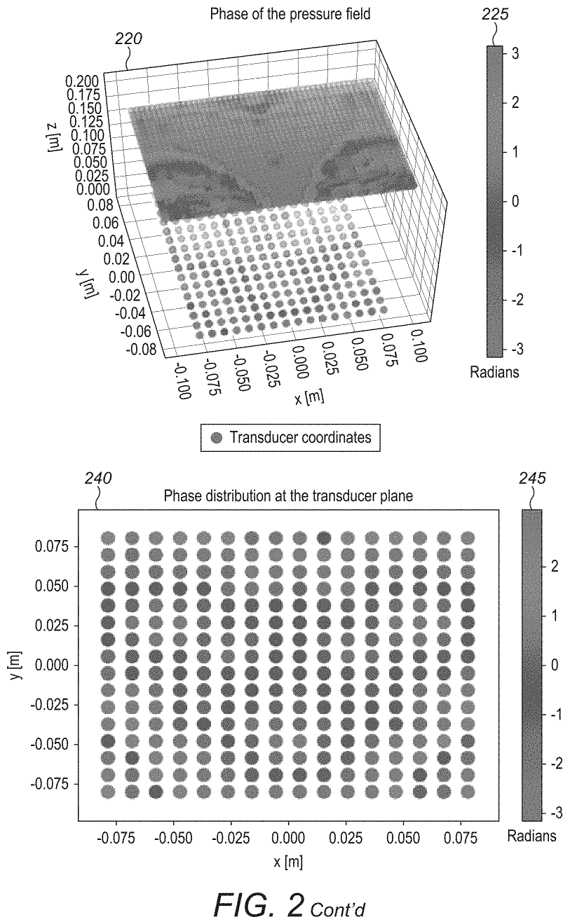

Shown in FIG. 2 are a group of plots 200 depicting the activation coefficients required to generate the Ultrahaptics logo at a height of 200 mm above the array and the simulated acoustic field obtained by propagating the activation coefficients with the Chebyshev directivity model. The first FIG. 210 shows a plot of the amplitude of the pressure field with the scale 215 of SPL in Pascals. The second FIG. 230 shows a plot of the amplitude distribution at the transducer plane of the pressure field with the scale 235 showing driving amplitude where 1.0 is full drive. The third FIG. 220 shows a plot of the phase of the pressure field with the scale 225 in radians. The fourth FIG. 240 shows a plot of the phase distribution at the transducer plane with the scale 245 in radians. The activation coefficients were computed using the MSGDM with Tikhonov regularization algorithm.

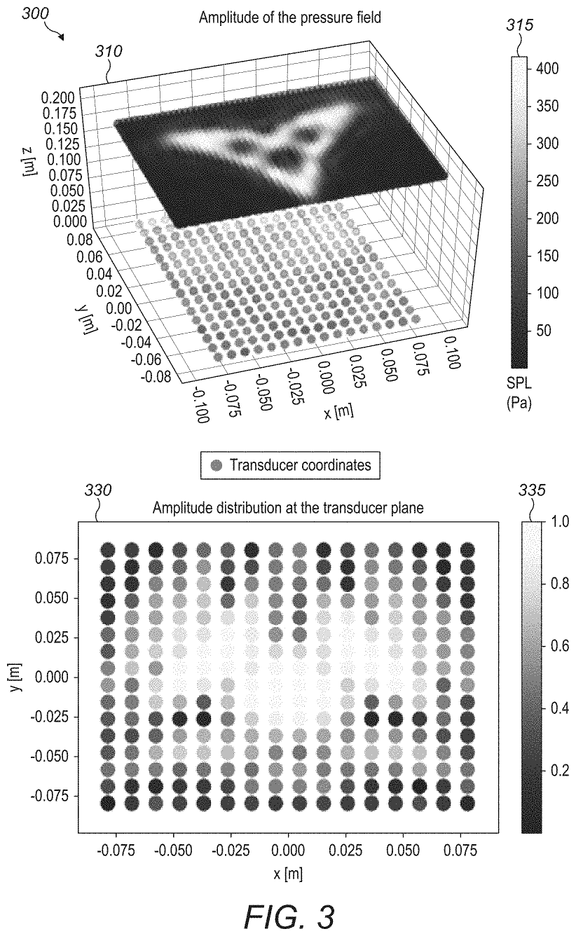

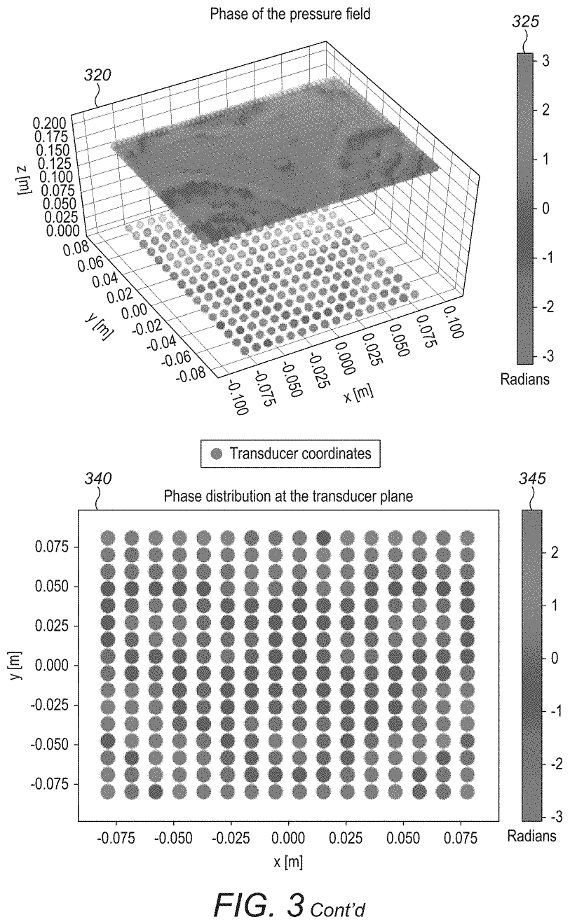

Shown in FIG. 3 are plots 300 depicting the activation coefficients required to generate the Ultrahaptics logo at a height of 200 mm above the array and the simulated acoustic field obtained by propagating the activation coefficients with the Chebyshev directivity model. The first FIG. 310 shows a plot of the amplitude of the pressure field with the scale 315 of SPL in Pascals. The second FIG. 330 shows a plot of the amplitude distribution at the transducer plane of the pressure field with the scale 335 showing driving amplitude where 1.0 is full drive. The third FIG. 320 shows a plot of the phase of the pressure field with the scale 325 in radians. The fourth FIG. 340 shows a plot of the phase distribution at the transducer plane with the scale 345 in radians. The activation coefficients were computed using the MSGDM with amplitude regularization algorithm.

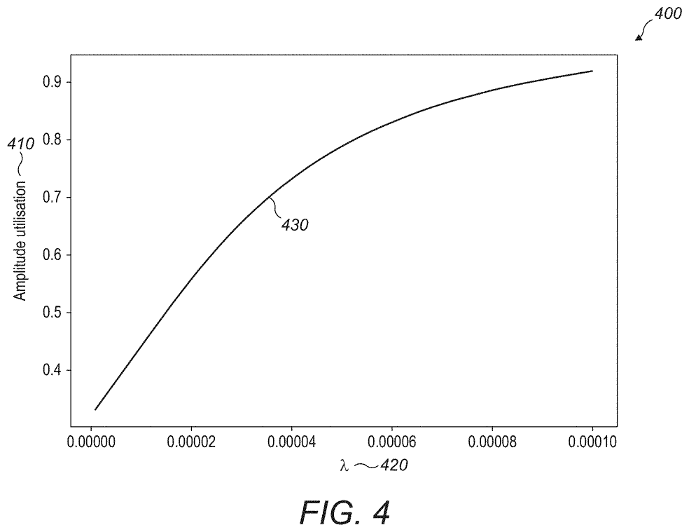

Shown in FIG. 4 is a plot 400 where amplitude utilization is defined as the sum of the amplitudes of all the transducers divided by the total number of transducers. This graph demonstrates how the parameter λ 420 of the MSGDM with amplitude regularization 410 affects the amplitude utilization of the array. It can be seen from the result 40 that increasing λ, increases the amplitude utilization of the array as predicted.

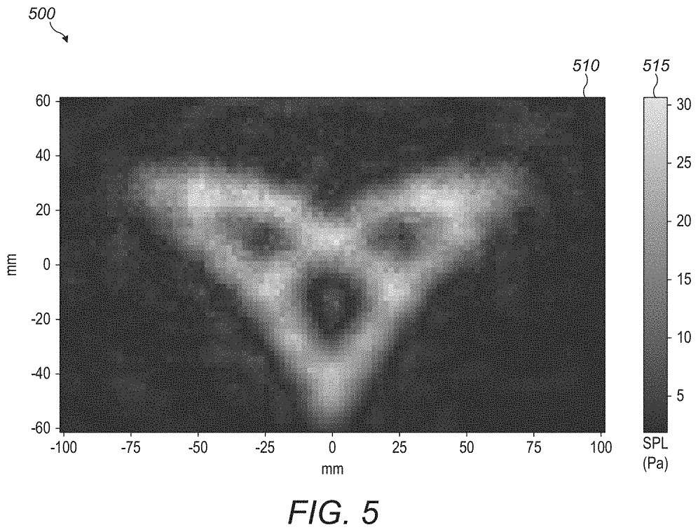

Shown in FIG. 5 is a plot 500 demonstrating the measured acoustic field 510 with a scale of SPL in Pascals 515 obtained by propagating the activation coefficients with the Chebyshev directivity model. The activation coefficients were computed using the SVD with Tikhonov regularization algorithm. The acoustic measurement was made using a microphone mounted in a converted 3D printer.

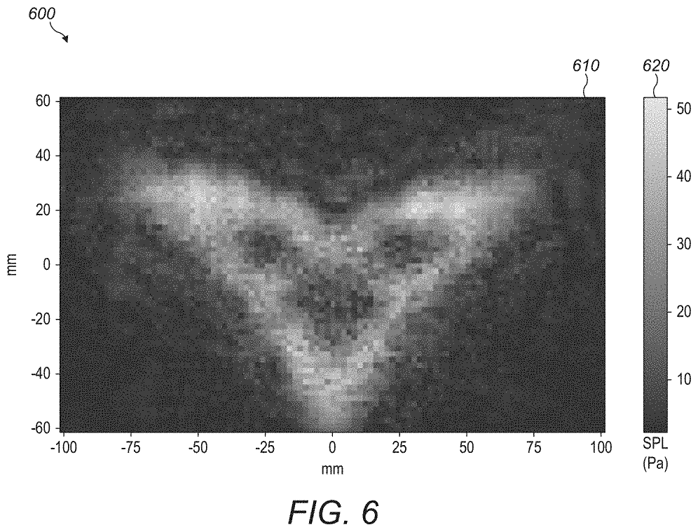

Shown in FIG. 6 is a plot 600 shows the measured acoustic field 610 with a scale of SPL in Pascals 615 obtained by propagating the activation coefficients with the Chebyshev directivity model. The activation coefficients were computed using the MSGDM with amplitude regularization. The acoustic measurement was made using a microphone mounted in a converted 3D printer.

### V. Additional Disclosure

A. SVD with Tikhonov Regularization

Long et al. presented a Tikhonov regularization approach to solving the linear system. Their application of Tikhonov regularization requires the augmentation of the linear system. This increases the size of the matrix from (m×n) to ((m+n)×n)). This increases the computational cost of solving the linear system.

The algorithm presented here allows one to apply Tikhonov regularization without having to augment the linear system. This enables one to achieve the benefits of Tikhonov regularization without increasing the computational cost of solving the linear system.

We also present a method for reducing the SVD computation to an (n×n) matrix instead of an (m×n) matrix.

In addition, we present a method for determining the optimal value for the Tikhonov regularization parameter which is absent from the work of Long et al.

B. Mini-Batch Stochastic Gradient Descent with Momentum and Tikhonov regularization

Ebbini et al. present a sketch of using basic gradient descent to determine the activation coefficients required to generate multiple focal points.

The algorithm presented here develops this approach by using Stochastic gradient descent with momentum and Tikhonov regularization.

Stochastic gradient descent is more computationally efficient that gradient descent. For n transducers and m field points, it reduces the computational complexity from O(mn) to O(bn) for each iteration.

The stochastic nature of the algorithm allows for the possibility of escape from local minima.

Including momentum involves calculating the parameter step using exponentially weighted average derivatives. This smooths out some of the stochasticity in the algorithm.

Ravines, regions where the error function has a steeper gradient in one dimension than in another, are common near local minima.

Standard SGD tends to oscillate up and down these ravines. Momentum helps to accelerate the algorithm towards local or global minima.

The addition of Tikhonov regularization helps to reduce the magnitude of the solution. This is beneficial as it forces the algorithm to find a set of activation coefficients that use less power.

We truncate the expressions for the partial derivatives of the objective function in order to reduce the computational cost of computing the update equations.

C. Mini-Batch Stochastic Gradient Descent with Momentum and Amplitude Regularization

This could apply as above for all points apart from the regularization.

Ebbini et al. introduce a second computational stage in their Pseudo-inverse method in an attempt to increase the power output of the transducer in the array. They use an iterative method to find an optimal weighting matrix with which to modify their linear system.

The algorithm presented here includes a regularization term in the update equations for mini-batch SGD with momentum that pushes the activation coefficients towards a circle of radius R in the complex plane. The result of this is to increase the power output of the transducers.

This could be advantageous for generating stronger haptic surfaces.

We truncate the expressions for the partial derivatives of the objective function in order to reduce the computational cost of computing the update equations.

### 2) Variable-Focus Acoustic Transducer Array Using Grouped Driving Signals

I. Introduction

The basic operation of an acoustic phased array consists of deriving a set of drive conditions (phase and amplitude) using the desired field and the location of each transducer as input parameters. This requires flexibility in the drive circuitry to produce the necessary phase and amplitude for each element. This invention takes the familiar setup and reverses the assumptions: for a desired field, assume all transducers have the same drive. Then, determine where should be placed to achieve the desired output. In other words, the instead of allowing drive to change, change the transducer placement to achieve the desired field.

Transducer placement to achieve a given field is a underdetermined system, allowing many solutions. This allows for multiple, independent fields to be generated simultaneously using mutually exclusive placement solutions. If chosen properly, together they facilitate the ability to sum these fields with independent phasing, allowing customizable interference patterns. If used with multiple focus points, for instance, one can form solutions which can constructively add pressure to one or multiple focus points while destructively damping others. The result is a custom layout of transducers where groups of which are driven together. The relative phase, amplitude, and drive frequency of each group determines the output field.

To begin determining transducer placement, an array of phase and amplitude values, herein called a solution field, must be generated. This field is defined as an array of phase and amplitude values with corresponding real-world locations wherein if a set of transducers are placed at locations specified in the array and driven at the phase and amplitude values contained in those locations, the resulting output of the array would approach a known field. Traditional phased arrays calculate these values for each new field desired, at its known transducer locations. Similarly, the same algorithms can be used to generate what—if arrays of solutions—if transducers were at a wide variety of locations, what would the necessary drive be?

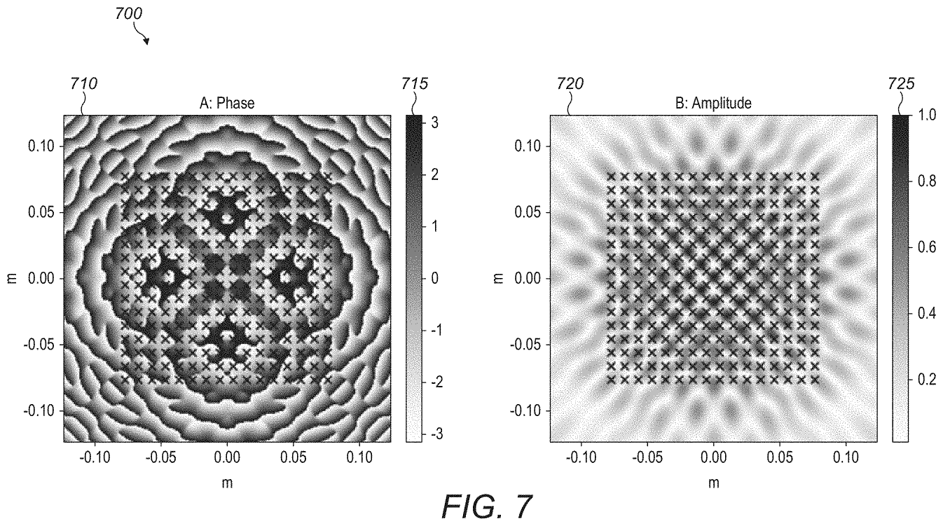

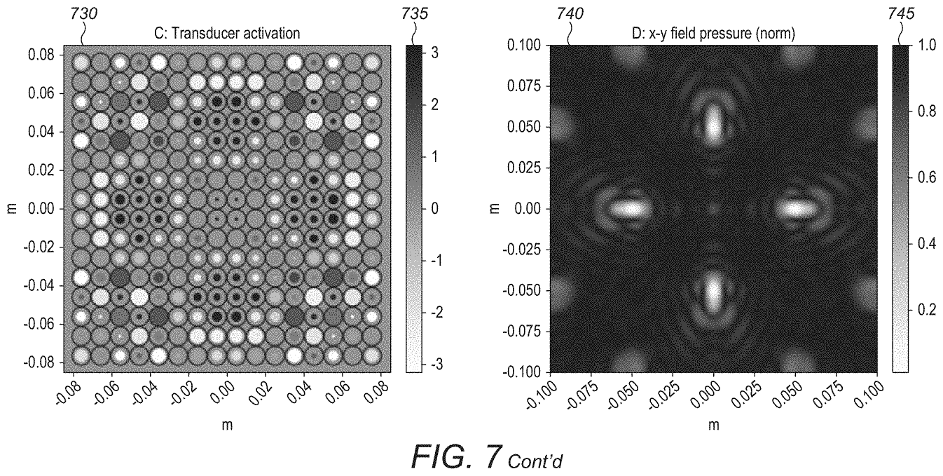

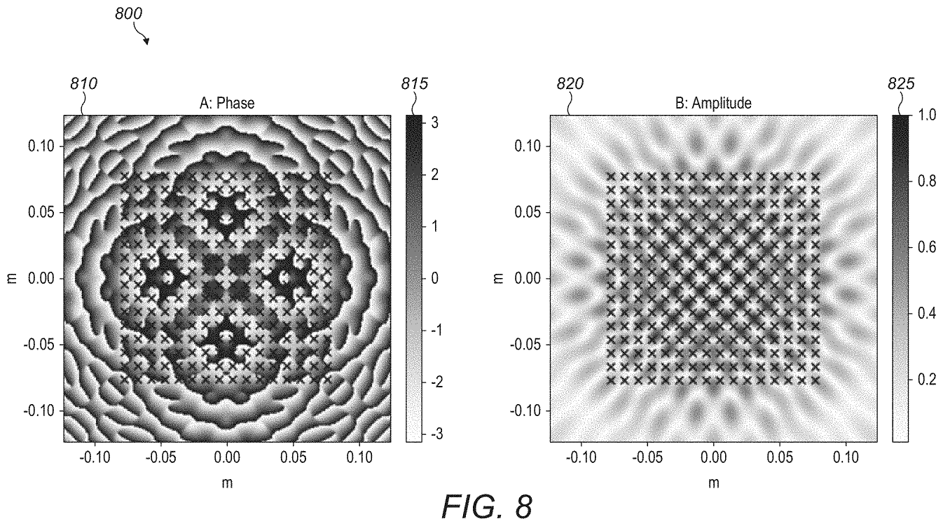

An example solution field is given in FIG. 7 along with a simulation of the field produced by a rectilinear array of 40 kHz transducers using the solution. This solution method involves simulating the field of a transducer placed at the desired focus locations and driven at the desired relative phase projected back to the z=0 plane. By taking the complex conjugate of the results, this reverses the direction of propagation and thereby produces a solution which creates converging fields towards the simulated sources. For multiple, simultaneous focus points each projected field needs to be scaled appropriately before the sum in order to project back at to the correct amplitude relative to the other focal points. If all foci are at equal distance to the origin of the solution, this scaling is unnecessary. Otherwise an iterative technique needs to be employed whereby a simulation of the field produced by a sampled subset is used to check the relative amplitudes and that is then used to readjust the relative amplitudes of the “source” transducers.

Specifically, FIG. 7 shows a set of plots 700 depicting an example solution field using reciprocity with array simulation. Plot A 710 and intensity scale 715 is the phase in radians, and plot B 720 and intensity scale 725 is the amplitude (scaled to 1) and solution field generated by the reciprocity technique for a field of 4 focus points at [x,y]=[5,0], [0,5], [−5,0], and [0,−5] cm. The ‘x’s in plots A 710 and B 720 show sampled values used in a 16×16 rectilinear arrangement simulation at 1.03 cm pitch. The extracted transducer phase and drive amplitude are given in plot C 730 with intensity scale 735 in radians with shade showing phase and filled circle radius proportional to amplitude. A simulation of the resulting acoustic field produced by this array (normalized to the max value) in an x-y slice at the focus height (z=0.1 cm) (simulated using a frequency of 40 kHz) is shown in plot D 740 with an intensity scale 745 in normalized pressure. The simulation shows the 4 desired focus points at 5 cm radius from x,y=0.

Another method to create a solution field involves solving,

Ax=b, (Equation 1)

where x is a column vector representing the complex driving amplitude of each transducer in an array, and A is given by,

$$A = [ \begin{matrix}{α}_{1} ( {χ}_{1} ) & … & {α}_{n} ( {χ}_{1} ) \\ ⋮ & ⋱ & ⋮ \\ {α}_{1} ( {χ}_{m} ) & … & {α}_{n} ( {χ}_{m} )\end{matrix} ] ,$$

where αⱼ(χₖ) describes the complex-valued scalar linear acoustic quantity α produced by transducer j at a position offset from the array center χₖ, which may evaluate to be acoustic pressure or an acoustic particle velocity in a chosen direction. b is the desired scalar linear acoustic quantity α at each point of interest χₖ. The total number of transducers is n in this notation. Solving for set of driving amplitudes for a desired field quantities is simply,

x′=A⁻¹b,

where A⁻¹ is the Moore-Penrose inverse (pseudoinverse) of A. This generates a minimum-norm solution. A solution field can be generated with this technique by considering an array of many point-like transducers distributed at pitch representing a desired resolution of the solution field. The transducer model a represents the field produced by a real-world transducer if its center were placed at each location. Next, a set of desired focal points are indicated by specifying those as points of interest paired with non-zero values in b.

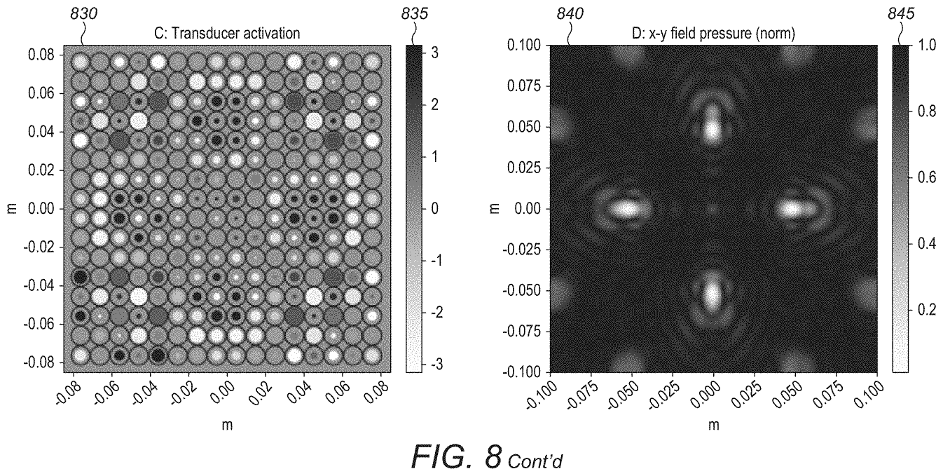

An example of the pseudoinverse technique is shown in FIG. 8. In this case the virtual transducers considered in A were populated at 1 mm pitch in a rectilinear arrangement from x,y=−0.125 m to x,y=0.125 m. At each point α was a transducer model representing pressure output from a common 40 kHz, 1.03 cm diameter, ultrasonic transducer. 4 points of interest at 5 cm radius along each major axis at z=10 cm were chosen with real, equal pressure values in b. Sampling the solution for a realistic array at 1.03 mm pitch results in the expected pressure field.

Specifically, FIG. 8 shows a set of plots 800 depicting an example solution field using a pseudoinverse with array simulation. Plot A 810 with an intensity scale 815 is the phase in radians and plot B 820 with an intensity scale 825 is the amplitude (scaled to 1) solution field generated by the pseudoinverse technique for a field of 4 focus points at [x,y]=[5,0], [0,5], [−5,0], and [0,−5] cm. The ‘x’s in plots A 810 and B 820 show sampled values used in a 16×16 rectilinear arrangement simulation at 1.03 cm pitch. The extracted transducer phase and drive amplitude are given in plot C 830 with an intensity scale 835 in radians with shade showing phase and filled circle radius proportional to amplitude. A simulation of the resulting acoustic field produced by this array (normalized to the max value) in an x-y slice at the focus height (z=0.1 cm) (simulated using a frequency of 40 kHz) is shown in plot D 840 with an intensity scale 845 in normalized pressure. The simulation shows the 4 desired focus points at 5 cm radius from x,y=0.

An advantage of the pseudoinverse method over the reciprocity method is the ability to easily specify relative pressures among points of interest. This extends to specifying zero (null) values in the field.

While these two examples of field solution generation are some of the easiest to use, they are by no means the only ones possible. Other solvers include but are not limited to, Fourier transform methods to translate the field from one plane to another, iterative methods which check the simulated field and make stepwise changes, and genetic algorithms which introduce mutations (randomness) and select for the best performing results, repeating many times. Any solution field will work which satisfies the criteria: a set of transducers placed in the solution field and driven with the phase and amplitude specified will produce a field with approaches a desired field.

This invention concerns the grouping of transducers rather than providing individualized driving signals. To formulate the solution mathematically, equation Error! Reference source not found. now becomes,

Cx=b

where here x is a column vector now representing the complex drive per group, and, similar to A, C is given by.

$$C = [ \begin{matrix}{α}_{1} ( {χ}_{1} ) & … & {α}_{n} ( {χ}_{1} ) \\ ⋮ & ⋱ & ⋮ \\ {α}_{1} ( {χ}_{m} ) & … & {α}_{n} ( {χ}_{m} )\end{matrix} ] ,$$

where αⱼ(χₖ) describes the complex-valued scalar linear acoustic quantity α produced by group j at a position offset from the array center χₖ. b, as before, is the desired scalar linear acoustic quantity α at each point of interest χₖ. In this notation, the columns of C are not simply a single transducer output at various points in space but rather a predicted or measured output from a group of transducers with known locations at those points.

A particular set of fields and the resulting C matrix which results in an orthogonal set of addressable points of interest is key to this invention. This will be referred to as C′ and its entries are defined as

$${C}_{xy}^{′} = {α}_{x}^{′} ( {χ}_{y} ) = \frac{1}{\sqrt{n}} {e}^{\{ - 2 π i ( \frac{xy}{n} ) \}} ,$$

where the subscript x and y are now used as indexes in the matrix, i is the imaginary unit and n is the number of groups in the system. In this case, α represents a scaled value, proportional to a real scalar value in the field. Normalization can occur on a point-by-point basis allowing for different real values in the field among each point. In addition, to achieve a square C′ matrix, this must also be equal to the number of points of interest (χₖ). If a set of fields are chosen to satisfy this condition, the system can be driven with

$${x}_{m}^{′} ( δ ) = \frac{1}{\sqrt{n}} {e}^{\{ δ 2 π i ( \frac{m}{n} ) \}} , δ = [ 0 , n - 1 ] ∈ ℤ \qquad ( Equation 2 )$$

where here the subscript m refers to an index of x, which is equivalently the complex conjugate of row δ in C′. The resulting system satisfies,

$${C}^{′} {x}^{′} ( δ ) = {b}^{′} , \\ {b}_{m}^{′} = \{ \begin{matrix}1 , & m = δ \\ 0 , & otherwise\end{matrix} .$$

In other words, this setup provides a driving solution whereby all points of interest have a zero scalar field except for one which is maximized. Note that while x′ may specify absolute values less than 1, this does not mean that drive conditions need not be maximized—specifying values less than 1 merely illustrates the orthonormality condition and can be scaled back to maximum as necessary in a real-world device. This arrangement of fields and groups yield a set of driving solutions which yield a series of selectable pressure points at locations specified by χₖ.

An example of how to construct a set of fields satisfying this condition is to make each point of interest, (χₘ), a high-pressure focal point. Next, solution fields are constructed using the constraint in the construction of C′. The number of fields required is equal to the number of focus points and the scalar value α must be consistent for each point between fields.

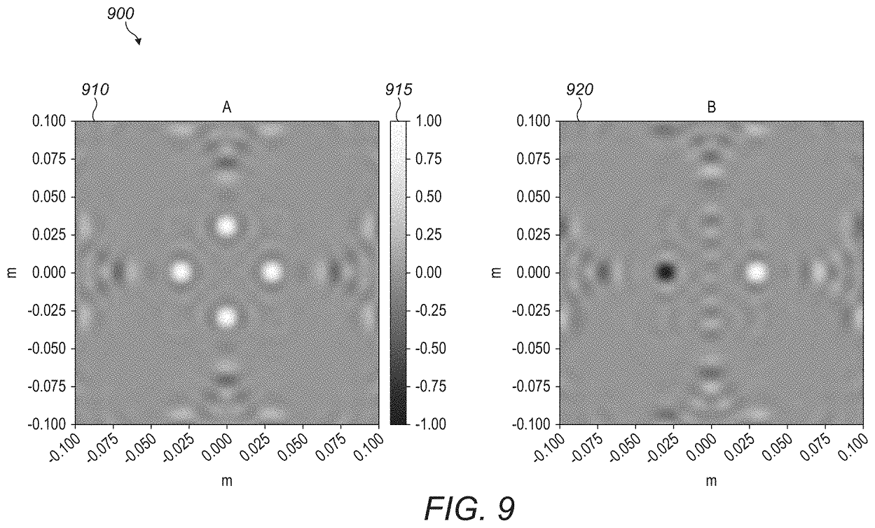

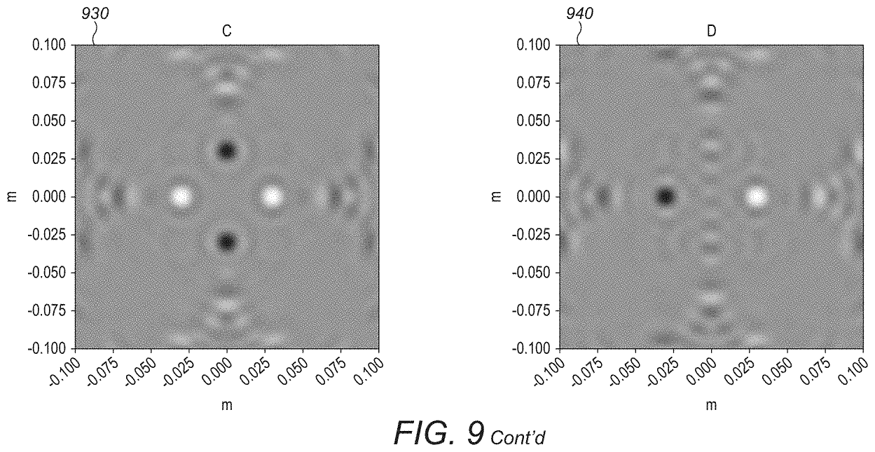

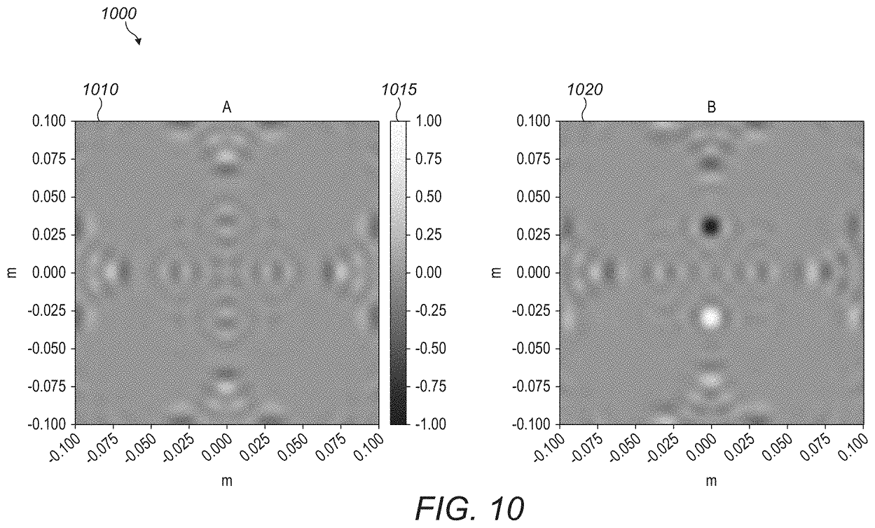

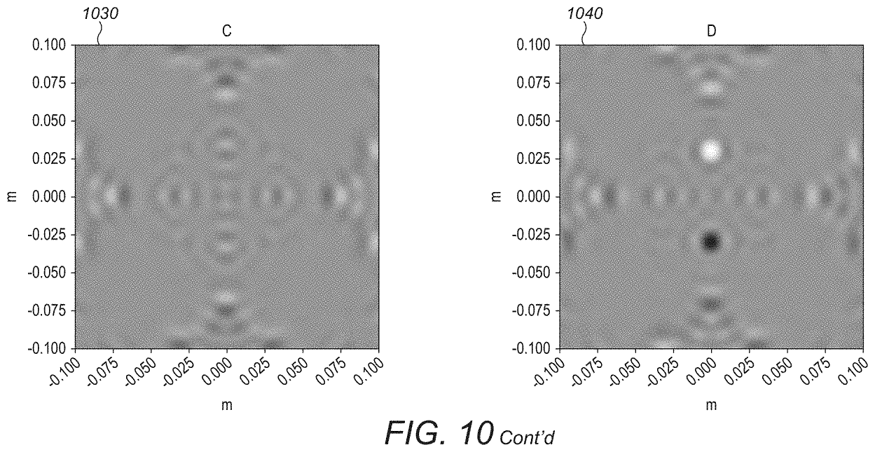

FIG. 9 and FIG. 10 show an example of a 4 simulated fields which satisfy the orthonormality condition specified by C′. In this example it takes the form,

$${C}^{′} = \frac{1}{2} [ \begin{matrix}1 & 1 & 1 & 1 \\ 1 & - i & - 1 & i \\ 1 & - 1 & 1 & - 1 \\ 1 & i & - 1 & - i\end{matrix} ] ,$$

with points arranged as [x,y]=[3,0],[0,3],[−3,0],[0,−3] at z=10 cm respectively. As seen in the figures, the phases of each focus point follow the phases specified by rows of C′. The simulation presented uses a rectilinear set of transducers and new driving conditions to produce each field. Even so, it is simple to imagine adding all the fields together—this is equivalent to a diving condition x′=[1,1,1,1]. The resulting field at each focus point will obey the sum of each row of C′ which is clearly 1 for the first point and 0 for the others. Likewise, if we apply a phase shift to each field equal to the conjugate of a row in C′, that will activate that point and nullify the others.

This simulation is purely for illustration purposes—to realize this invention, each field must be produced simultaneously by different groups of transducers. In this way, the fields can be added together at different relative phases and produce each focal point as desired. Constructing each group relies on first producing a solution field for each desired set of focus points using a method presented above. Next each solution field is considered for transducer placement as given by methods presented in the next section.

The C′ matrix and resulting solution fields it generates represent perfect orthonormality and simplifies the theoretical analysis. In reality, a non-activated point is “off” when it falls below the threshold of sensitivity for a given application. An alternate formulation of C could be used which is equally effective which is not quite orthonormal as long as a set of driving conditions can be found which substantially reduces all but one point to near-background conditions. This can be generated through slight permutations to C′ while still following driving parameters given by equation Error! Reference source not found. Alternately, for a given C, a desired output per point can be attempted using its Moore-Penrose pseudoinverse and multiplying by a goal output vector b″, or x″=C⁻¹b″. Given the reduced flexibility caused by grouping of transducers, not all goal output can be achieved.

Specifically, shown in FIG. 9 are a group of plots 900 depicting example normalized real projection of a set of simulated pressure fields satisfying orthogonality as specified by C′. The 4 focus points are located at [x,y]=[3,0],[0,3],[−3,0],[0,−3] cm at z=10 cm respectively. These pressure field simulations are an x-y slice in the z=10 cm plane. The fields presented are simulations of a rectilinear 16×16 array of 40 kHz transducers at 1.03 cm pitch. The activation coefficients are generated by the pseudoinverse method. Plot A 910 having intensity scale 915 showing normalized pressure is δ=0 and therefore all points are in phase with positive real pressure. Plots B 920 and D 940 are δ=1 and 3 respectively, which specifies point 2 and 4 as being completely imaginary and therefore are almost zero in this projection. Plot C 930 is δ=2 which specifies points 2 and 4 as negative real.

Shown in FIG. 10 are a group of plots 1000 depicting example normalized imaginary projection of a set of simulated pressure fields satisfying orthogonality as specified by C′. These fields in plot A 1010 having intensity scale 1015 showing normalized pressure, plot B 1020, plot C 1030, and plot D 1040 are the same as shown in FIG. 9, only now projected into the imaginary plane instead of the real. This illustrates the phase differences between points 2 and 4 in with δ=1 and 3. All other points in these simulations are phased to be real and are not visible in this projection.

II. Transducer Placement

A desired field can be realized using a single driving phase through arrangement guided by a solution field. A solution field represents ideal driving phases and amplitudes for transducers placed at positions specified—all that is required is to only consider placements which agree in phase and forgo using a pre-defined pattern.

Selecting locations for a desired number of transducers is an iterative process. First, the complex solution field is projected into a given phase. One method to do this is to first multiply the solution field by a unit complex number e^{-iϕ} where ϕ is the desired phase, followed by taking the real projection. For most solution fields, the larger the values in this projected field, the more a transducer placed at that location will contribute to that field. A minimum-norm solution field, such as one generated by the pseudoinverse, necessarily has this property. If no amplitude information is contained in the solution field or if it doesn't correspond to the transducer contribution to the field, then the contribution must be computed separately and the solution field must be modulated by that contribution so that the largest values correspond to the largest contribution. A simple algorithm to place transducers is then to start with the point with the highest contribution, exclude a region in the field representing the physical size of the transducer, repeat for the next highest point, and so on until the desired number of transducers have been placed or there is no longer room for any more transducers in the physical extent of the solution field. Placement can be further optimized by considering both the most positive value as well as the most negative. Negative values represent transducers whose placement in phase would result in destructive interference to the desired field. This can be remedied, however, by wiring these transducers with reverse polarity, thereby flipping the phase of the resulting acoustic field. Most ultrasonic transducers do not lose any output when wired in reverse polarity and therefore no other modifications need to be made other than noting the polarity on the final printed circuit board (PCB) and wiring appropriately. Transducers that are asymmetric will not contribute as much to the field when wired in reverse, and this needs to be considered when judging the most valuable placement points by scaling negative value in agreement with the relative performance of each driving polarity from real-world transducer data.

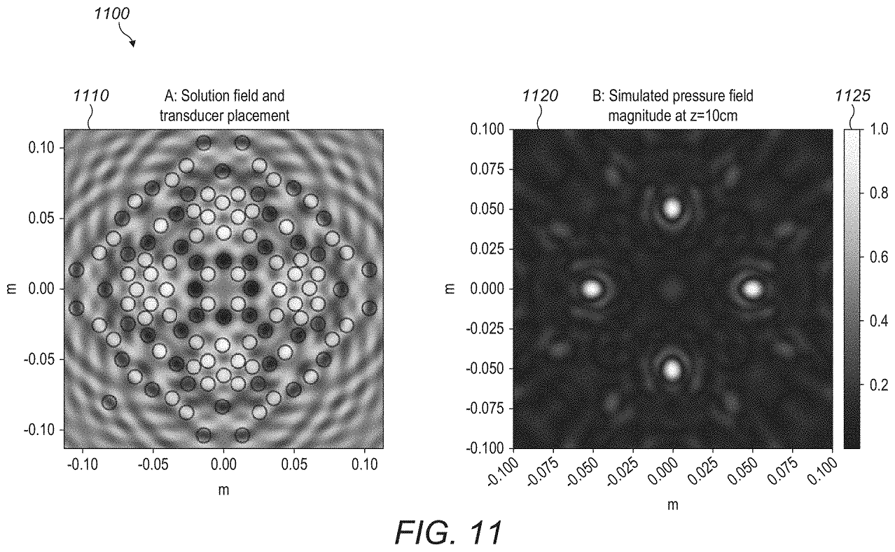

An example of this placement technique is shown in FIG. 11. The solution field to generate 4 focus points at [x,y]=[5,0],[0,5],[−5,0], and [0,−5] cm at z=10 cm is generated using the pseudoinverse method discussed above. Transducers with 1.03 cm radius are iteratively placed from highest absolute contribution to lowest. A simulation of the resulting field at z=10 cm when all transducers are driven in phase (or 180 degrees out of phase for transducers placed on negative contribution locations) at maximum amplitude at 40 kHz is shown. The resulting acoustic field reproduces the desired focus points.

Specifically, FIG. 11 shows plots 1100 depicting an example of a structured acoustic field generation using a solution field to guide transducer placement. In this example a solution field is generated using the pseudoinverse method with desired focus points at [x,y]=[5,0],[0,5],[−5,0], and [0,−5] cm at a height of z=10 cm from the simulated array. Plot A 1110 shows the solution field as well as iteratively-placed transducers represented by circles. Transducers placed on light-shaded values are driven in phase while those placed on dark locations are driven out of phase. The simulated transducers are driven at full amplitude. The resulting simulated pressure field in the z=10 cm plane at a frequency of 40 kHz is shown in plot B 1120 having intensity scale 1125 normalized to the peak value. As expected, this arrangement of transducers produces 4 focal points at the positions desired in the solution field.

This technique produces a single field which can be amplitude modulated. The functionality is increased, however, by populating a set of transducers to produce a set of orthogonal fields as specified by C′ such as those shown in FIG. 9 and FIG. 10. To populate transducers on a single PCB which can generate multiple fields requires considering all solution fields simultaneously, and populate transducer locations considering which field can most benefit.

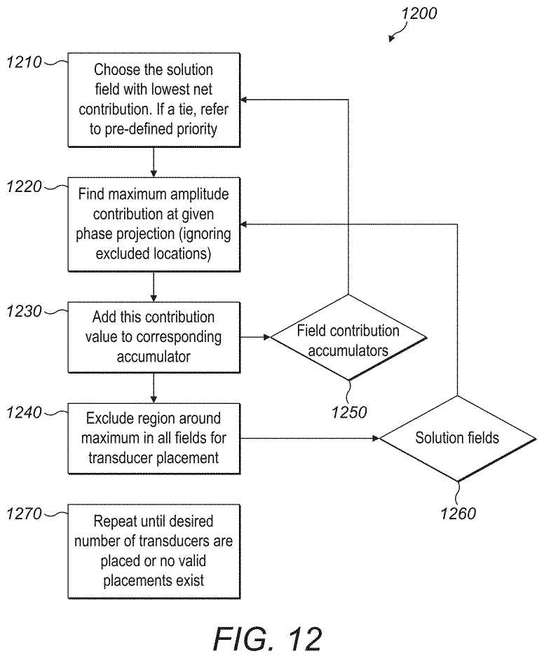

To achieve this, transducers are populated for each field while keeping a running total contribution referred to here as an accumulator. For each placement step, the group with the lowest running total is considered next. If there is a tie, such as at the very beginning of the algorithm, a pre-defined priority, such as basic ordering, must be followed. After a transducer placement is determined, a region related to the physical size of the transducer now becomes excluded from all further placement, in all solution fields. The magnitude of the solution field at the placement location represents the contribution to the field and it is this value that is added to the group accumulator before the next placement is considered. This algorithm is expressed as a flow chart in FIG. 12Error! Reference source not found.

FIG. 12 shows a decision flow chart 1200 for populating transducers for multiple solutions fields simultaneously. For step 1, the algorithm chooses the solution field with the lowest net contribution. If it is a tie, the algorithm refers to pre-defined priority 1210.

For step 2, the algorithm finds the maximum amplitude contribution at given phase protections (ignoring excluded locations) 1220. The maximum amplitude contribution can also be the most negative contribution if wiring allows for reverse polarity. In that case the field contribution receives the absolute value of the contribution.

For step 3, the algorithm adds this contribution value to the corresponding accumulator 1230. In addition, the algorithm interfaces with the field contribution accumulators 1250, which are running totals of the running contribution of previously populated transducers that can be modified by priority modifiers. This then interfaces with step 1 1210.

For step 4 the algorithm excludes the region around the maximum in all fields for transducer placement 1240. In addition, the algorithm interfaces with solution fields 1260, which can be considered independently or may be summed or modulated with each other's values. This then interfaces with step 2 1220.

The entire algorithm repeats until the desired number of transducers are placed or no valid placements exits 1270.

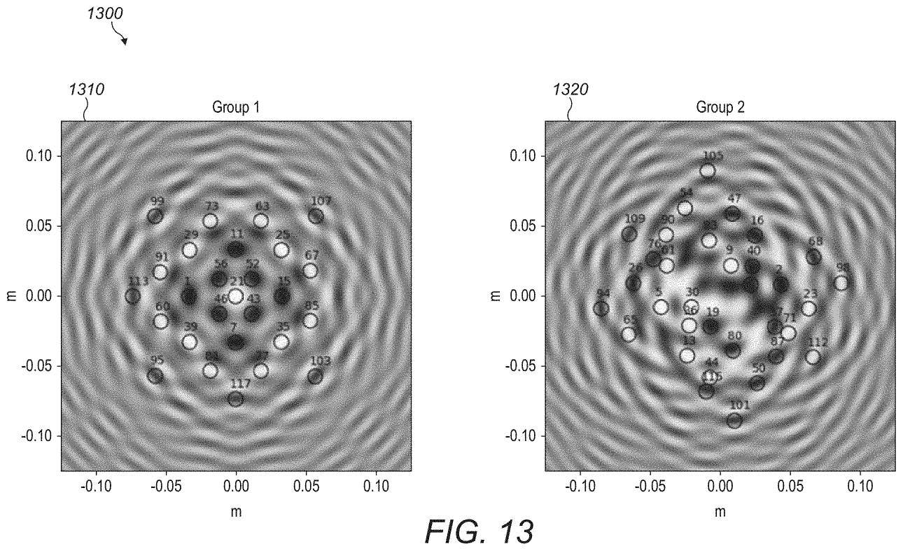

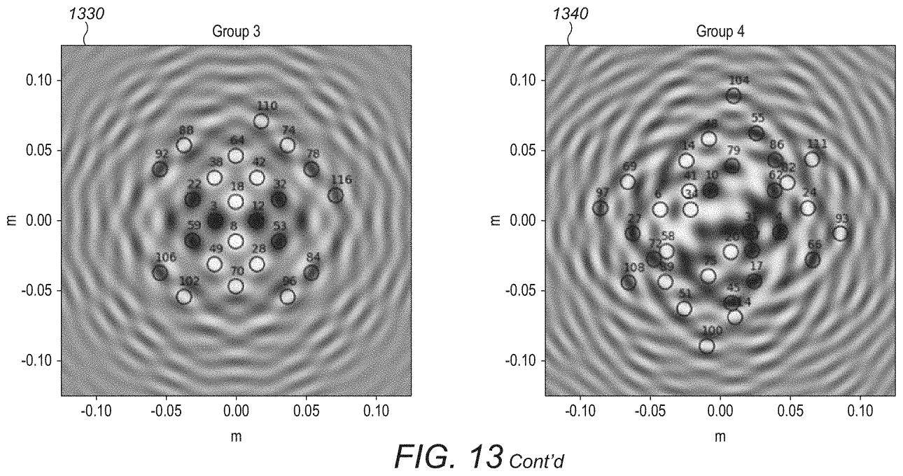

An example use of this method is shown in FIG. 13 using the same set of desired focus points as FIG. 7 and FIG. 8, seeking a 117 transducer array.

Shown in FIG. 13 are plots 1300 depicting an example execution of the algorithm in FIG. 12 with 4 orthogonal solution fields generated using the reciprocity approach for a set of focus points at [x,y]=[5,0],[0,5],[−5,0], and [0,−5] cm at a height of z=10 cm. The fields shown are real projections with light values positive and dark values negative. Transducers for Group 1 1310, Group 2 1320, Group 3 1330, and Group 4 1340 are shown as circles (with 1.03 cm diameter) and the absolute order of placement is shown as a number directly above each circle. Groups were prioritized based upon their number with 1 given highest and 4 given lowest. Transducers were allowed to be wired in reverse polarity with dark centers representing this reversed behavior. In this example 117 transducers were populated by design.

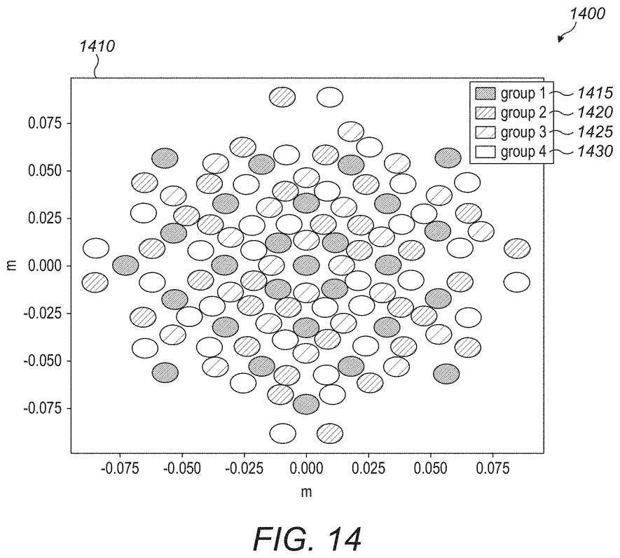

The resulting output is shown in FIG. 14.

FIG. 14 shows a plot 1400 depicting the final populated transducer array built using solution fields from FIG. 13. The group designations of Group 1 1415, Group 2 1420, Group 3 1425, and Group 4 1430 specifies which field is being produced as shown on the graph 1410.

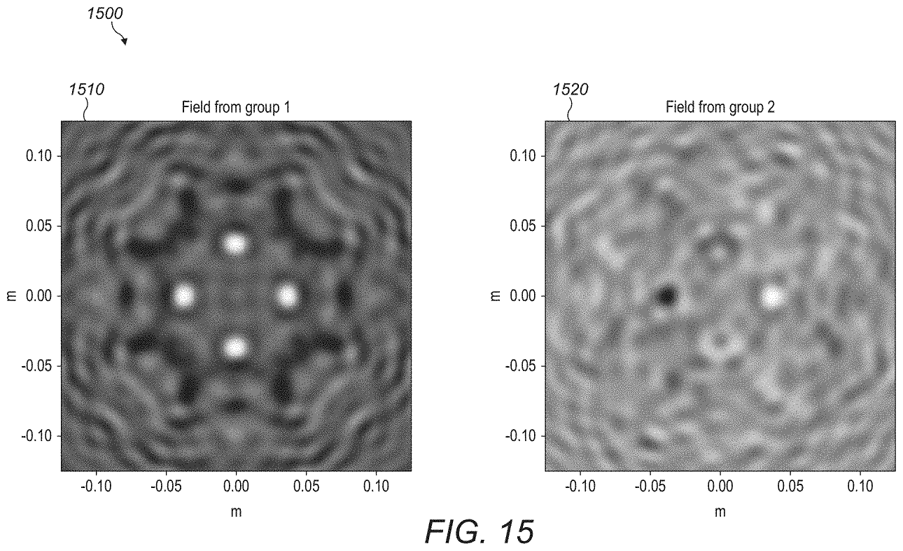

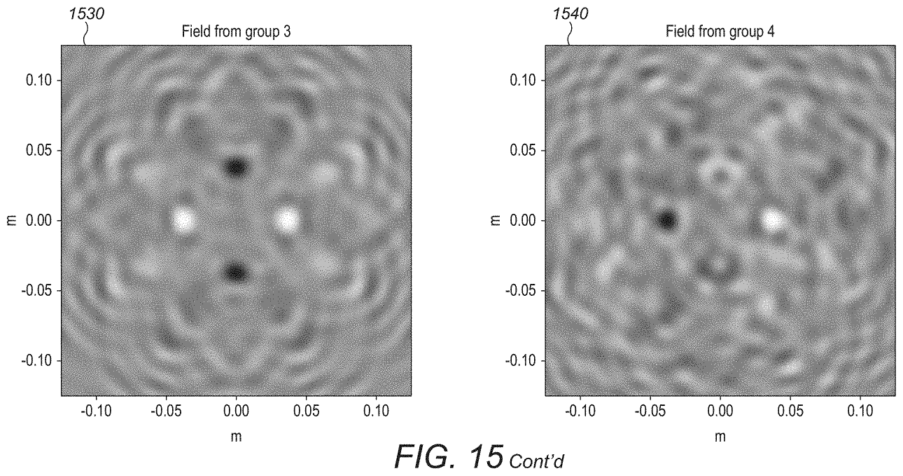

The fields this array is capable of producing is shown in FIG. 15.

FIG. 15 shows plots 1500 of the normalized real projection of the simulated acoustic field produced by each group from FIG. 14 in the z=10 cm plane at 40 kHz frequency. Each of Group 1 1510, Group 2 1520, Group 1530 3, and Group 4 1540, is driven independently and in phase to form the simulated field. These fields are directly comparable to FIG. 9, except here they can all be produced simultaneously and addressed individually. Like FIG. 9, points 2 and 4 in group 2 and 4 have phases which are completely imaginary and therefore are not visible in this projection. But an imaginary projection would reveal similar phase behavior as in FIG. 10.

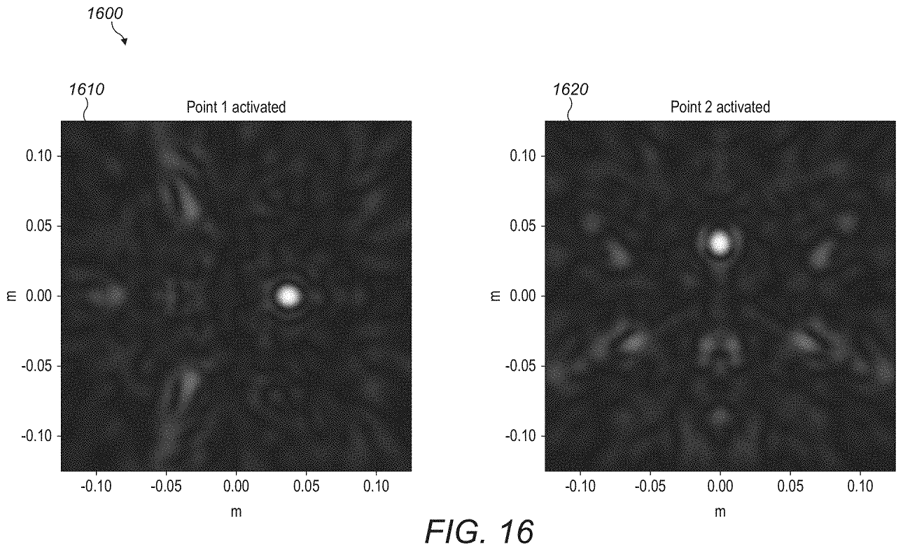

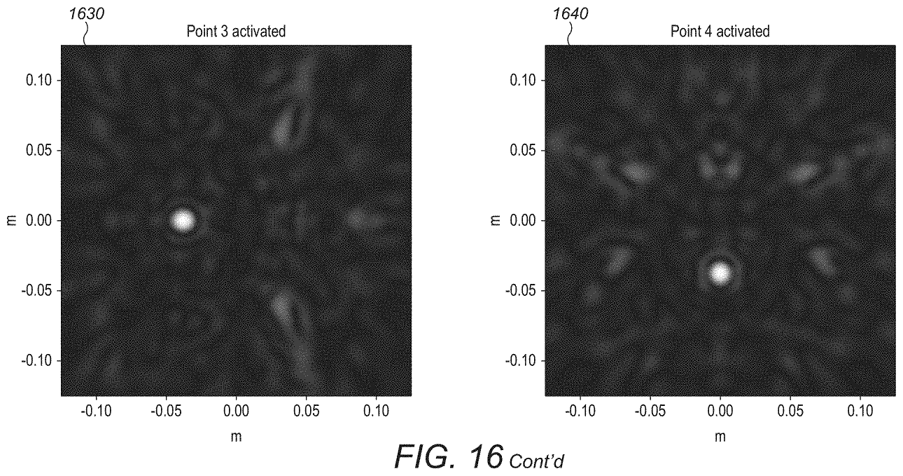

Those fields can be produced simultaneously resulting in selectable focus points as shown in FIG. 16. That figure is illustrating the normalized, absolute value of the pressure field, not a projection, so any high-pressure regions, regardless of phase, would be visible.

Shown in FIG. 16 are plots 1600 of normalized pressure field (absolute value) simulation produced by transducer arrangement and grouping given in FIG. 14. For each subplot, a different point is activated by driving each group with phases specified by equation 2. Each value of delta from 0 to 3 activates point 1 to 4 respectively in the 4 plots 1610, 1620, 1630, 1640. As expected, the desired point is activated with the others being disabled.

In another arrangement, instead of using accumulators, the best point among all solution fields is chosen on every round of placement. For points with very balanced placement (such as those symmetric about the origin), this can result in an efficient arrangement. There can be problems, however, if one point is very easy to contribute to, while the others are difficult. This will result in one field being over-populated relative to the others and as a result will not sum to cancel unselected points.

Focus points with different desired peak pressures can be generated using the placement techniques discussed. The solution fields each still need to obey the relative phases specified in C′ while simultaneously enforcing the desired peak pressure for each. As an example, if a 2-point array is desired with relative pressures of 1.0 and 0.5, then each solution field must generate those pressures at the necessary phases—in this case the first group would generate pressures of 0.5 and 0.25 while the second field would generate pressures at 0.5 and −0.25. When summed in phase, the first point in produced at the desired pressure, and when summed out of phase, the second point is generated at the desired pressure.

The orthogonal phase matrix C′ does not inherently specify a specific projection but merely relative phase among each group. In the examples given to this point, the real values were assumed to be real and imaginary values imaginary. In fact, the system would build to a working system if the system (and solution fields) were rotated such that the real parts of C′ were imaginary and the imaginary parts were negative real, for example. All solution fields must be rotated by the same amount—this is equivalent to multiplying C′ by e^{-iϕ} were ϕ is the desired phase. This, in effect, rotates all solution fields by the same amount. Performing this rotation will result in a new array arrangement which given the peculiars of the interplay between transducer size and field may result in a better final design.

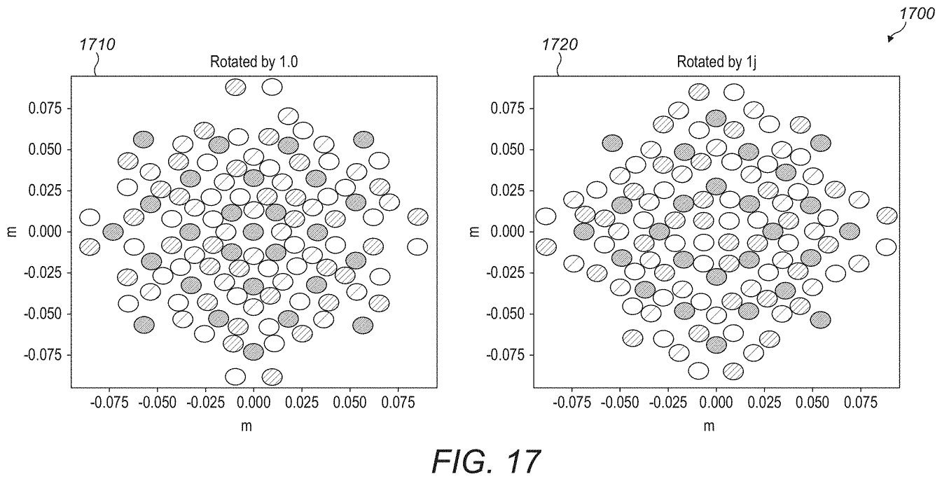

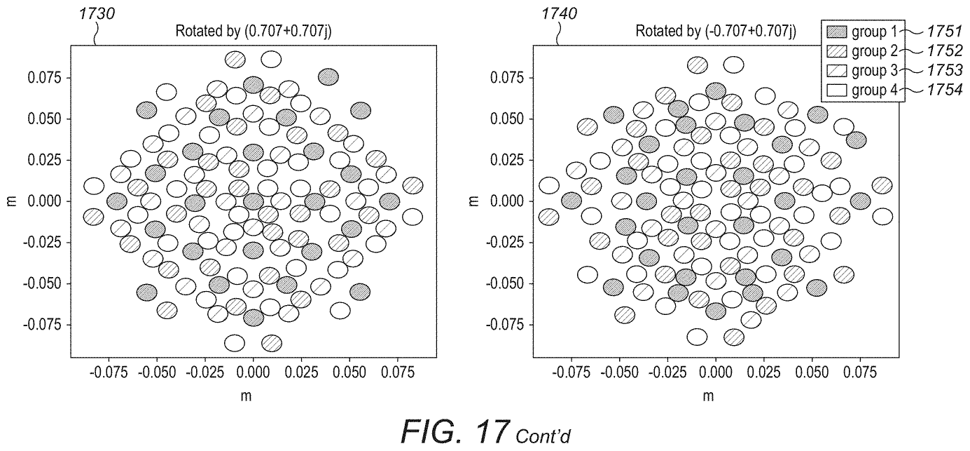

Example output from different rotations is shown in FIG. 17.

Shown in FIG. 17 are plots 1700 showing example populated transducer arrays using pre-rotation of source solution fields. Base solution fields and goal focus points are identical to FIG. 13, but are first multiplied by the complex number given in each subfigure title. The upper-left plot 1710 shows the unmodified arrangement, identical to FIG. 14. The other plots 1720, 1730, 1740 show the resulting arrangements when pre-rotation is allowed. Each plot use the designated Group 1 1751, Group 2 1752, Group 3 1753, and Group 4 1754. All produce similar acoustic fields.

Optimizing through this method can be done by using a performance metric which is evaluated after each array constructed. Example performance metrics are, but are not limited to, array footprint, standard deviation of focus point pressures, or sum of absolute focus pressures. Searching through a large range of pre-rotation phases can yield incremental improvements to the final design.

Placement techniques presented are flexible enough to accommodate regions which might not be able to be populated with transducers for some reason. For instance, the center of the PCB might need to include a button or sensor instead of transducers. In the same way that when a transducer location is chosen and then that physical location is excluded in all fields from further placement, regions which might not be available can be excluded before population has begun.

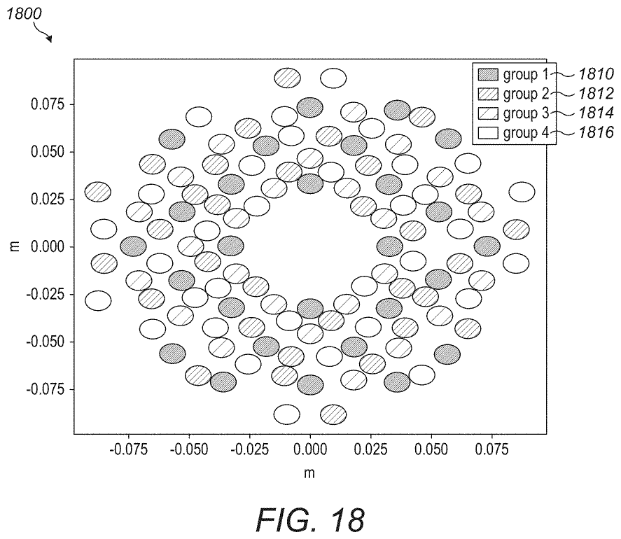

An example of this modification is shown in FIG. 18.

FIG. 18 shows a plot 1800 depicting an example layout 1810 with a center excluded region showing Group 1 1810, Group 2 1812, Group 3 1814, and Group 4 1816. This array is generated with the solution fields given in FIG. 13, only now a circle with 3 cm radius, centered at the origin, is excluded. The exclusion prevents the center of transducers to be within its region, while the full extent of the transducer edge can overlap. If the full width of the transducers needs to be excluded, the center region can be increased by the necessary amount. Excluding transducers in this way will affect the focus pressure and efficiency relative to an array with the exclusion.

Another possible refinement of transducer placement is achieved by using a solver after transducer positions have been populated. For each desired focus point, a solver algorithm can be run to evaluate the best possible phase for each transducer. For a perfectly optimized array this will predict the exact driving phases for each group as specified by C′. This, however, is unlikely given the real-world constraints brought in by the physical size of the transducer. The deviation for each focus point for every transducer must be evaluated independently. The deviation generated can be used to rank transducers by their performance with the highest deviation from ideal being the worst and lowest deviation, the best. This can be the total deviation sum from each point, the worst deviation from among all points independently, or some other weighted sum. After ranking, the worst transducers can be removed, or adjusted in position to achieve better performance.

Another refinement possibility is to make adjustments using a genetic-style algorithm. In this case, after a transducer array is populated, the transducers are given random displacements. A large number of different displacement sets are evaluated for performance, and some best-performing subset is chosen. Another round of random displacement is done, followed by another selection. This process can be repeated until desired performance is reached or no significant progress is being made.

Another possible refinement to transducer placement is to consider permutations to C′. As discussed above, effective operation does not require perfect orthonormality. Applying a phase or amplitude shift to one or more solution fields relative to the others will slightly shift the respective group's phases or amplitudes out of perfect cancellation, but may result in a board with more desirable attributes such as size or efficiency while preserving operating effectiveness.

Yet another placement refinement can be achieved by modifying the solution fields before placement. One such modification is to blur the real and imaginary part of the field using the physical size of the transducer as the blurring kernel. This would result in possible locations which have high phase-variability to be de-prioritized. This is beneficial because a transducer placed in such a region would not contribute effectively, given its size. This is important when populating transducers which are much larger than the wavelength of sound being used.

Another possible modification to the solution fields is to use the other solution fields as a modulating basis. For instance, the locations with large absolute value of one solution field represents the best contribution locations while the zeros of that field represent locations with little to no contribution. The latter case gives the possibility of finding locations which contribute to one field without contributing significantly to another. This can be achieved by using one minus the absolute value of one field and multiplying that by another field. The resulting solution field will contribute to the second while minimizing the contribution to the first. More than one modulating field can be used simultaneously. This technique has the possibility of optimizing the efficiency of the transducer placement but can come at the cost of total layout size.

Another refinement of this technique is to change the basis solution fields after every transducer placement. When a transducer is placed and assigned to a group, this defines a source and phase (different for each desired point) that can be factored into the solution fields. The field which received the transducer placement will not be changed but all the others can consider it using the placement already determined at phase given by C′. The new solution fields after each iteration w ill better be able to compensate for the placed transducer.

In another refinement of the technique, a performance metric can be created and evaluated after each transducer placement, and if too low, another placement can be selected. For instance, a simple performance metric is the contribution to each field, as a complex weighted sum. When placement only considers the highest value in one field, it is ignoring the others. With a performance metric which considers the total contribution to all fields, some placements might be skipped, in favor of others which better contributes to all, resulting in a more efficient array.

Note that all examples shown consist of 40 kHz, round transducers 1.03 cm in diameter. This is not a limitation of the invention. One skilled in the art will recognize that different transducer frequencies or shapes can be adapted by simply changing the solution fields and iterative exclusion regions respectively. Additionally, all examples shown use solution fields which populate in a plane. This also is not a limitation. The locations specified in a solution field and the resulting populating of transducers can take place on a non-planar surface including planes at multiple levels. In this case the solution field will need to contain information on the necessary orientation at each point in the field.

III. Driving Methods

One application is mid-air haptics. This is accomplished by focusing high-pressure ultrasonic fields onto a user's hand or other body part. While the human sense of touch can detect static pressure, it is much more sensitive to low-frequency vibration. In this context, static pressure from a fixed acoustic focus is difficult to perceive when using a modest number of acoustic transducers, such as the examples given above. Instead, to achieve maximum haptic sensation, the fields can be modulated in the range of 20-300 Hz.

The most basic way to accomplish modulation is to amplitude modulate. After a point is selected and driving phases determined from equation Error! Reference source not found., the amplitude of those phase values can be modulated. Starting at zero and following a smooth modulation envelopes results in less audible noise and are preferred for quiet operation. The narrower the overall bandwidth of the driving signal around the center ultrasonic carrier frequency, the less audible noise will be generated. Modulating with a sinusoid, for instance, minimizes bandwidth, for instance. If pulse-width-modulation (PWM) switching drive signals are used, it is important to consider low-pass signal and not simply translate amplitude to width linearly. The proper modulation width follows an arcsin function to produce maximally narrow-band signals.

Another modulation technique found in mid-air haptics is spatiotemporal-modulation (STM). Instead of modulating amplitude in a fixed location, STM instead preserves a high amplitude focus and translates this focus along a curve to form a repeating pattern of stimulation (with the repetition rate as the effective modulation frequency). As long as the curve is sufficiently large compared to the focus spot size, effective amplitude modulation is achieved along any fixed point on the curve. The multipoint arrangements in this invention can achieve the same effect by sequentially activating a sequence of focal points in a repeating pattern.

Rapidly activating a sequence of points can be achieved in multiple ways. First, simply switching from one point activation to another using different values of δ determined from equation Error! Reference source not found., will achieve the desired effect. The sudden shifts in phase, however, are likely to produce unwanted audible noise. To mitigate the noise effect, interpolating in between the activations can be a remedy. In one embodiment, the phases of each activation are smoothly transitioned from one δ to the next and back again. This can be done in linear steps or using variable steps such as a magnitude dictated by a sinusoid. Depending on the arrangement of activation, and points chosen, however, this technique may inadvertently activate unwanted points. In another embodiment, multiple points are activated by first ramping the amplitude to zero before changing phases. In other words, start with one δ, ramp the amplitude to zero, then ramp back up using a different δ. By sequentially ramping to zero from one point to the next, this assures only the desired points are activated.

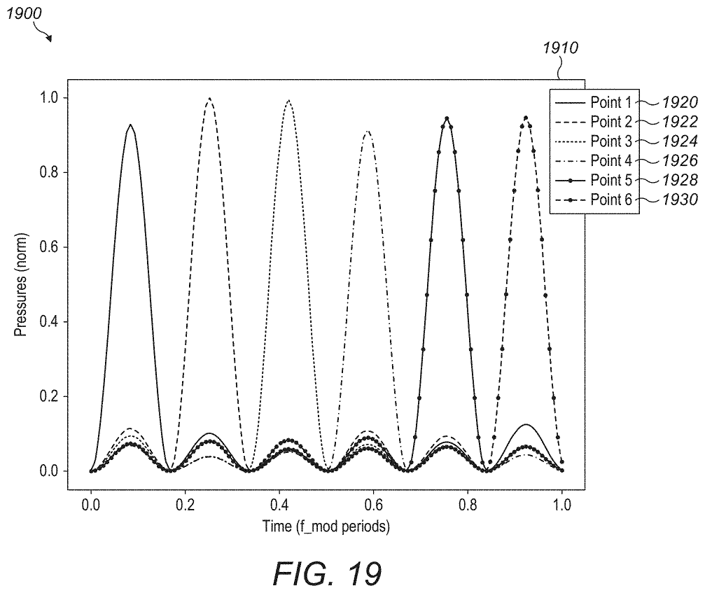

An example of this driving technique is shown in FIG. 19.

FIG. 19 shows a time-domain simulation 1900 of a 6-point, 117 transducer at 40 kHz embodiment. The focus points 1 through 6 1920 1922 1924 1926 1928 1930 are arranged in a circle with a 5 cm radius starting at [x,y]=[5,0] cm and proceeding counter clockwise at regular spacing around the origin at a height of z=10 cm. In this example, the graph 1910 shows amplitude of each point is ramped up and then back to zero with a sinusoidal profile. At the zero crossing, the activation is advanced to the next point in the sequence. F_mod in this example is the frequency to scan past every point. As a result, the frequency used for each sinusoidal profile is 6 times this value. The curves shown are the pressure at the location of each focus and the peak pressure is normalized to the highest of all points achieved. The variation expected and due to the physical size of the transducers.

Additional modulation possibilities are available if one considers different driving frequencies. The mathematical framework presented in this invention has assumed a monochromatic (single-frequency) field. To consider other frequencies in this notation, a time-varying function is used as modulation. For instance, activation at a new frequency f=f₀+Δf where f₀ is the carrier frequency, can be represented as,

x(t)=e^{2πiΔft}x₀

where x₀ is the activation at the carrier frequency. This illustrates how different frequencies can be represented as an activation which drifts in phase over time at a rate related to the difference in frequency. To use this, different channels must be driven in a series of frequencies such that at specific times different points are activated. For instance, the most basic way to use multiple frequencies to activate all points sequentially is to use,

$${x}_{m} ( t ) = \frac{1}{\sqrt{n}} {e}^{2 π {mf}_{mod} t} ,$$

where m is the group number, n is the total number of groups, and f_{mod} is the desired modulation frequency. Note that at a time

$$t = \frac{δ}{n {f}_{mod}} ,$$

equation Error! Reference source not found, is satisfied and the point given by δ is activated. This frequency configuration activates all points, in sequence, in a regular repeating pattern with a frequency given by f_{mod}. In terms of activation frequencies, this is equivalent to driving each group with f(δ)=f₀+δf_{mod}. For a system with two total points, driving with two frequencies is all that is required without any need to align any part of the relative phases. With 3 or more points, all signals must be started at zero (or some other value) together in order to precess at that the correct relative phases.

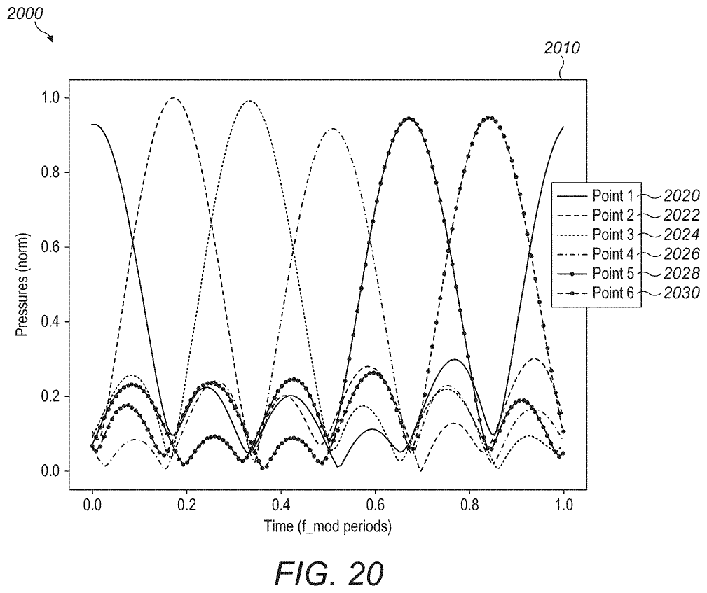

An example of this multi-frequency driving technique is shown in FIG. 20.

FIG. 20 shows a plot 2000 with a time-domain simulation of a 6-point, 117 transducer at 40 kHz embodiment, identical to FIG. 19, only now using a multifrequency technique. The focus points 1 through 6 2020 2022 2024 2026 2028 2030 are shown on graph 2010. In this example, all groups start at full amplitude and each driven with frequencies increasing by m*f_mod where m is the group (minus 1). The curves shown are the pressure at the location of each focus and the peak pressure is normalized to the highest of all points achieved. Note that with this driving technique, the widths of each pressure spike are wider, resulting in more energy being delivered to each point per cycle.

One benefit of the multifrequency technique is that any one group is only producing a monochromatic signal without any form of modulation. This is ideal from the perspective of nonlinear noise production. Without multiple frequencies to mix, unwanted audible sound is reduced. In addition, the resulting pressure envelopes versus time are wider than the amplitude modulation technique, resulting in more energy deposited to each focus point per cycle.

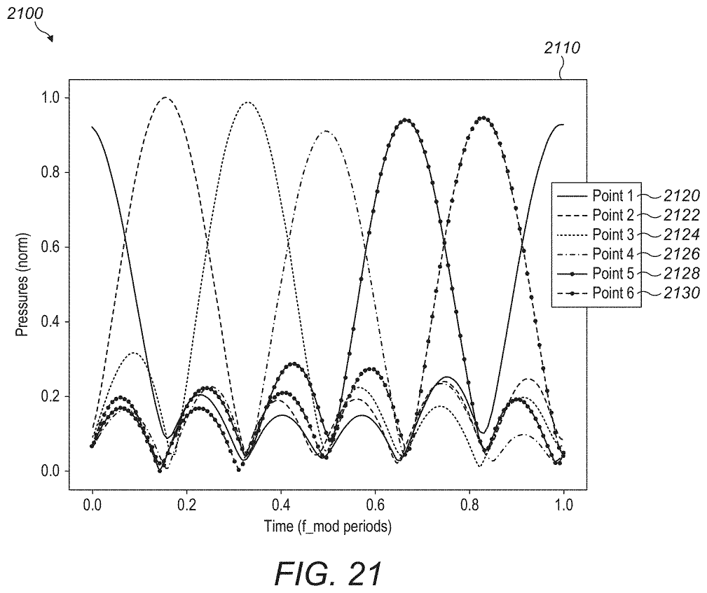

Frequencies lower than the carrier will have a negative Δf and can be used to the same effect. Simply changing the drives to f(6)=f₀−f_{mod} reverses the order of activation. Additionally, there is a symmetry to C′ which allows for Δf to proceed with positive values as groups count up or negative values as groups count down and these can be mixed. An example of using both positive and negative values of Δf is shown in FIG. 21.

Shown in FIG. 21 is a time-domain simulation 2100 of a 6-point, 117 transducer at 40 kHz embodiment, identical to FIG. 20, only now using a multifrequency technique using both positive and negative delta frequencies. The focus points 1 through 6 2120 2122 2124 2126 2128 2130 are shown on graph 2110. In this example, groups 2 and 3 are driven with increasing frequencies of f_mod and 2*f_mod respectively, while groups 6, 5, and 4 are driven with frequencies −f_mod, −2*f_mod and −3*f_mod respectively. The curves shown are the pressure at the location of each focus and the peak pressure is normalized to the highest of all points achieved. The results show subtle differences in the non-activated points. In addition, this uses a narrower bandwidth around 40 kHz compared to FIG. 20.

In this case, groups 2 and 3 have frequencies greater than the carrier while groups 5 and 6 have frequencies below the carrier. This has a subtle effect on the pressures in the non-activated points and may result in a better haptic depending on the arrangement of focus points and resulting transducers.

In many applications, not all points need to be activated at any one time. For instance, in a 6-point design, 3 of those points might be associated with one virtual button and the 3 others with a different virtual button. When a user interacts with the first button, it is not desirable to waste energy activating the second 3 points. This can be achieved with amplitude modulation, as discussed, but multifrequency activation has many benefits such as lower noise and higher power. While not all combinations of points can be activated with different frequencies, certain subsets can. Specifically, arrangements with a number of groups which have integer divisors have patterns which can be used for subset driving. In these cases, the activation vector for those groups have a pattern given by.

$${x}_{m}^{′} ( \frac{n}{d} ) = \frac{1}{\sqrt{n}} {e}^{\{ 2 π i \frac{m}{d} \}} .$$

Even numbered groups, for instance have a pattern of positive and negative activation for the n/2 group. If that group is held at 1/n, then only half of the points are activated. Likewise, if the group is held at −1/n, the other half are activated. The other groups must be driven in such a way as they line up with the necessary groups together at the same times. This can be accomplished with positive, negative or mixed Δf.

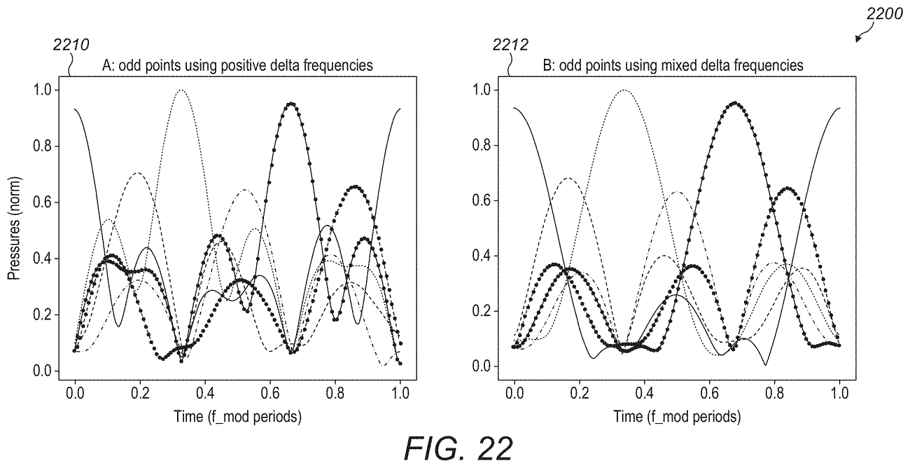

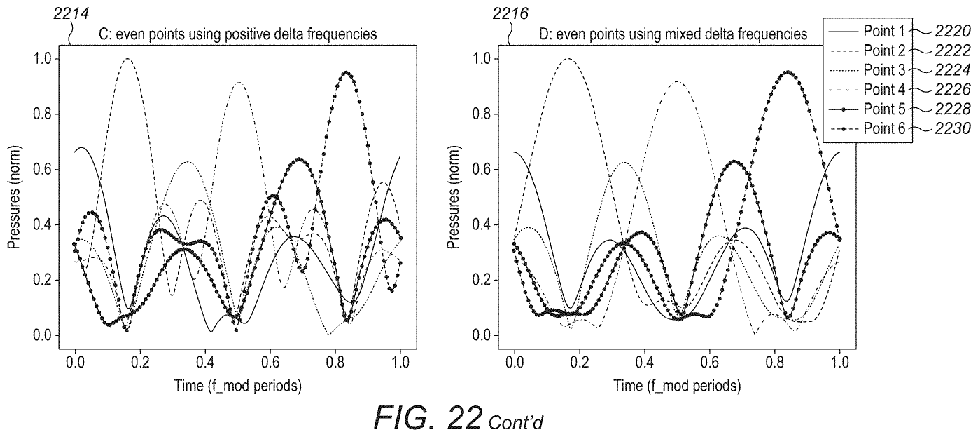

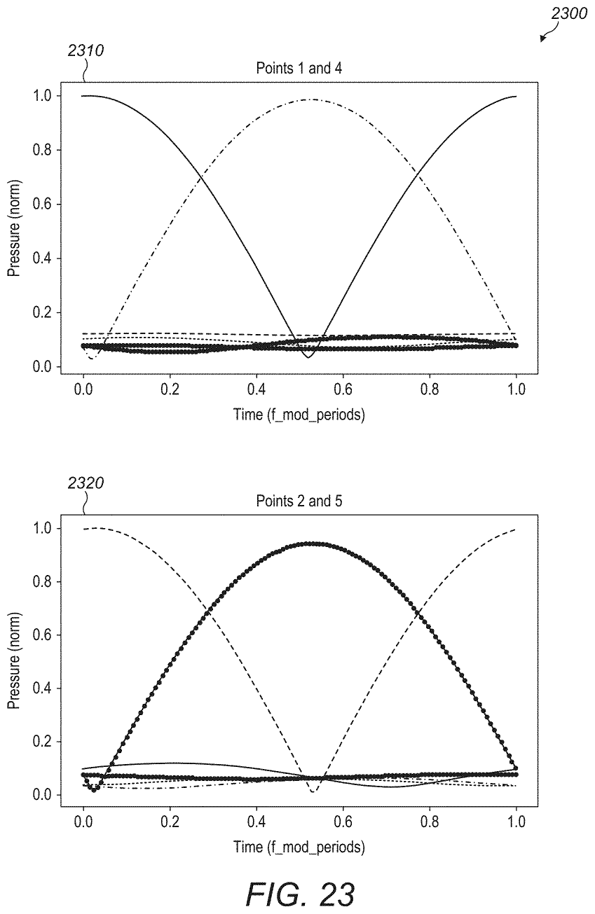

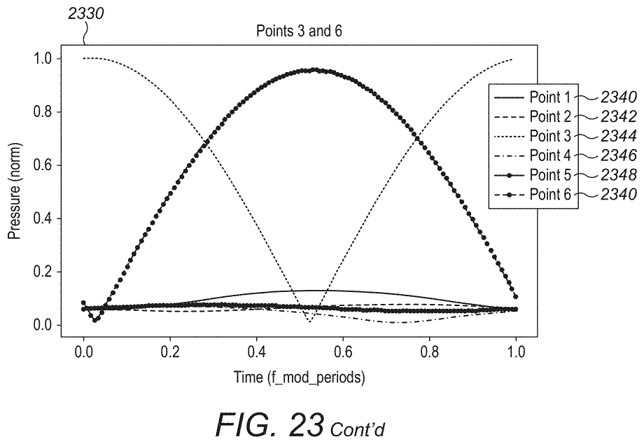

Examples of subset driving are shown in FIG. 22 and FIG. 23.

Shown in FIG. 22 is a time-domain simulation 2200 of a 6-point, 117 transducer at 40 kHz embodiment, identical to FIG. 20, only now illustrating various arrangements of 3-point multifrequency subset driving. Each plot A, B, C, D 2210 2212 2214 2216 graphs points 1 through 6 2220 2222 2224 2226 2228 2230. The curves shown are the pressure at the location of each focus and the peak pressure is normalized to the highest of all points achieved. Plot A 2210 holds the activation of groups 1 and 4 at 1/√6 with the others at m*f_mod. Plot B 2212 holds the activation of groups 1 and 4 at 1/√6 with groups 2 and 3 at f_mod and 2*f_mod respectively and groups 6 and 5 at −f_mod and −2*f_mod respectively. Plot C 2214 holds group 1 at 1/√6, group 4 at −1/√6 and the others at m*f_mod. Plot D 2216 holds group 1 at 1/√6, group 4 at −1/6, groups 2 and 3 at f_mod and 2*f_mod respectively, and groups 6 and 5 at −f_mod and −2*f_mod respectively. All activation combinations activate the proper points but by using mixed delta frequency the maximum Δf is minimized, resulting in greater pressure widths and more energy in each point.

Shown in FIG. 23 is a time-domain simulation 2300 of a 6-point, 117 transducer at 40 kHz embodiment, identical to FIG. 20, only now illustrating various arrangements of 2-point multifrequency subset driving. Each plot 2310 2320 2330 graphs points 1 through 6 2340 2342 2344 2346 2348 2350. The curves shown are the pressure at the location of each focus and the peak pressure is normalized to the highest of all points achieved. The top graph 2310 holds groups 1, 3, and 5 at 1/√6 and drives the remainder in phase at f_mod. This activates points 1 2340 and 4 2346. The middle graph 2320 is the same frequency driving conditions only with phase offsets of e^{2π(m-1)/6} where m is the group number. This activates points 2 2342 and 5 2348. The bottom graph 2330 is the same frequency driving conditions only with phase offsets of e^{4π(m-1)/6} where m is the group number. This activates points 3 2344 and 6 2350.

Using mixed Δf allows for a maximum of α*Δf deviation from the carrier frequency to activate the subset where α is the number of points being activated with a given subset.

Besides haptics, transducer boards arranged using methods in this invention can be used to produce steerable directional audio. In this embodiment, an activated point is modulated in such a way as to produce desired audible sound. By holding each group at the specific phases to activate a desired point, the audio is steered into that direction. Focus points close to the array will limit the resulting directionality but can still provide a desired sound to go along with a haptic or stand-alone. Focus points need not be placed close to the array, however, which is desirable for a long-range directional audio device. In that case, the desired focus and associated solution field is place far from the array and the resulting field resembles a beam. Different points allow for different beam directions and this results in a steerable audio beam.

IV. Additional Disclosure

A mid-air haptic device consisting of,
a) A plurality of ultrasonic transducers
b) A desired acoustic field
c) A solution field derived from the desired acoustic field
d) At least 2 locations derived from the solution field
e) At least 2 transducers located at the derived locations
f) A drive signal
g) Whereby the plurality of transducer substantially produce the desired acoustic field when driven together with the drive signal

A mid-air haptic device consisting of,
a) A plurality of ultrasonic transducers
b) A plurality of driving signals
c) at least 2 transducers connected to one drive signal
d) at least 2 transducers connected to a second drive signal
e) a plurality of focus points
f) where at least one focus point pressure increases* when both drive signals are driven in phase
g) where a different focus point pressure increases or maximized when at least one drive signal is changed.

### 3) Acoustic Field Manipulation Using Stored Solution Sampling

I. Sampling Stored Solutions for Acoustic Fields

A phased array of ultrasonic transducers can be used to produce acoustic fields by driving each element with a variety of phases and amplitudes. The amplitude and phase values for each transducer are referred to as activation coefficients. Deriving a set of activation coefficients for a desired field can be done many different ways. For the vast majority of these methods, to change the desired field, the algorithms must be repeated to generate a new set of coefficients.

This invention recognizes that for some changes in the acoustic field, many coefficients can be reused through simple transformations. In addition, if a solution is pre-calculated and includes extra values beyond what is required for a specific solution, then we can manipulate the field without needed to recalculate—we can simply sample different values within this stored solution.

Take, for example, an ultrasonic field from a 20×20 element square coplanar array which focuses at [x,y,z]=[0,0,10 cm] where the origin is located at the center of the array. There are 400 activation coefficients generated to produce this field. Next, take a device which is now only 16×16 elements. If we take the solution we produced for the 20×20 and only use the center 16×16 values, the array will still produce the [x,y,z]=[0,0,10 cm] focus point. Now, instead of the center 16×16 values, offset which transducers which are sampled by 1 in x. Expressing this in columns, instead of using the coefficients from columns 2-18, we instead use columns 1-17. This produces the same focus as before but our coordinate system has changed: instead of the origin at the center of the array, it is displaced by the pitch of one transducer element. If this pitch is, say, 1 cm then the 16×16 array now produces a focus 1 cm displaced in the opposite direction that we shifted the sampling. In effect, the focus has translated by 1 cm without having to calculate a new solution-we are simply sampling different stored values from the same solution.

Taking this a step further, the stored solution needn't be from a realistic array. A solution with arbitrarily small pitch can be generated and stored. Then, instead of translating by one full element pitch, the sampled solution can be translated with much smaller steps, allowing for higher-fidelity translation of the desired field.

First a solution is generated using a known method. In this example, the solution provides a focus at [x,y,z]=[0,0,0.1]m with 40 kHz ultrasound and has 1 mm pitch. To generate that exact field, the solution is sampled at the pitch of the real array which in this example is a 10.3 cm pitch square array.

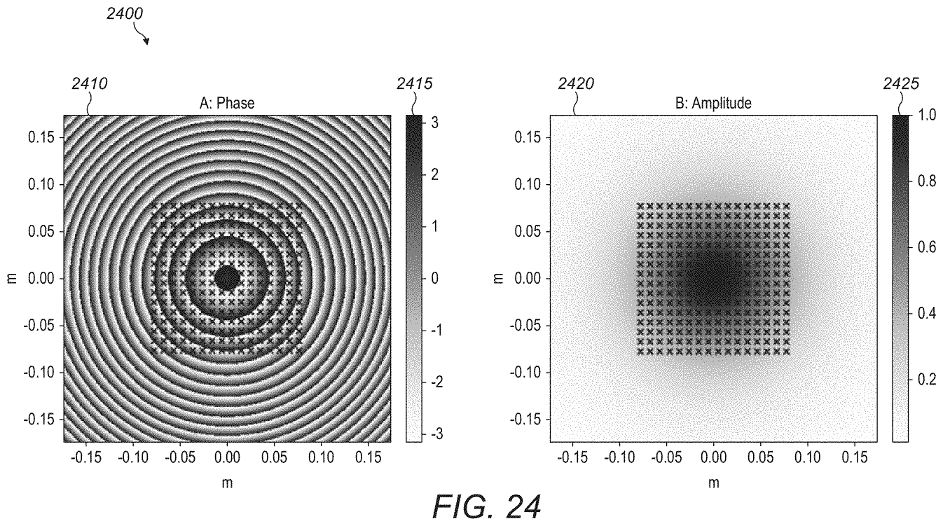

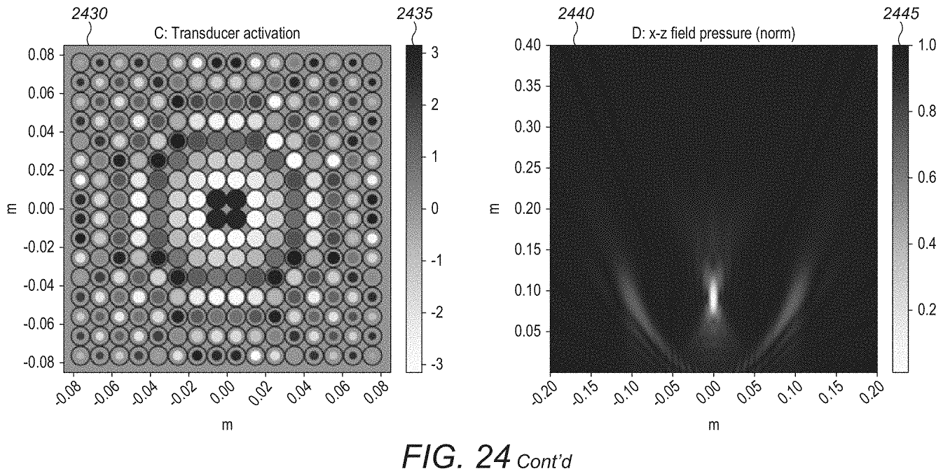

Shown in FIG. 24 is an example 256-element solution sampling 2400. Pre-generated solutions are given in graph A 2410 with intensity scale 2415 (phase in radians) and graph B 2420 with intensity 2425 (normalized amplitude). These are sampled at 1 mm pitch and generated to produce a focus at [x,y,z]=[0,0, 10 cm] relative to the center of the array at 40 kHz. The 256-element simulated array has 1.03 cm pitch and the sampled values are given by ‘x’s in graphs A 2410 and B 2420. Graph C 2430 with intensity scale 2435 in radians shows the resulting activation via sampling with phase given by shade and amplitude given by the radius of the inner, filled, circle. Graph D 2440 with intensity scale 2445 in normalized pressure shows an x-z cross-section of the resulting simulated field pressure normalized to maximum=1.0. As expected, the focus appears at [0,0,10 cm]. The grating lobes to either side of the focus are a consequence of the 1.03 cm pitch relative to the wavelength of 40 kHz (8.5 mm at STP).

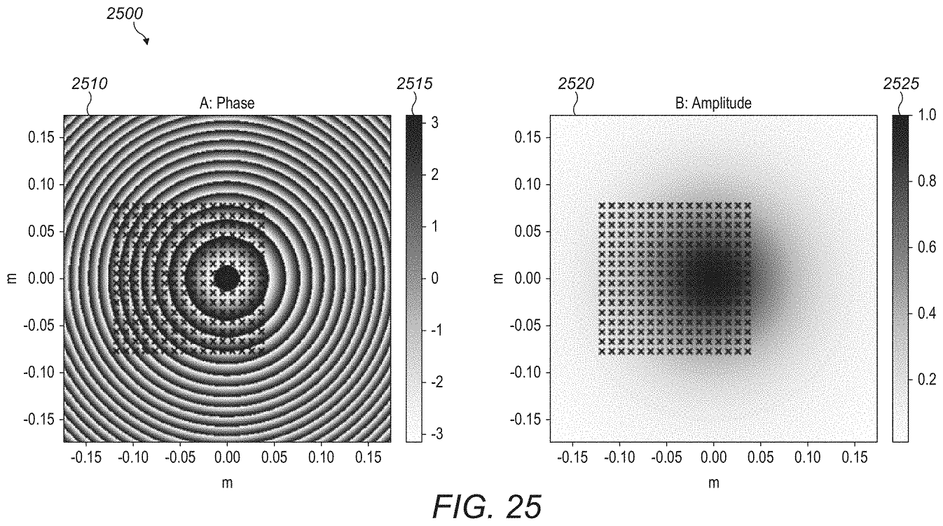

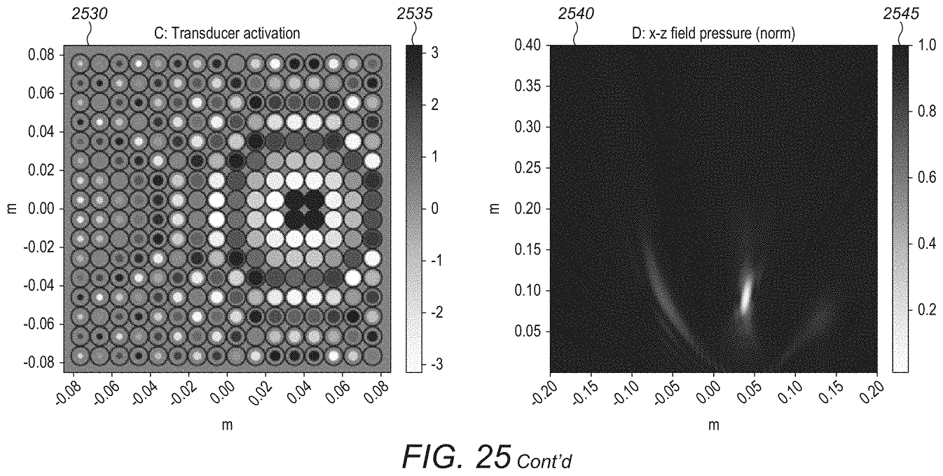

Translation of the field can be done by translating the sampled locations by the same amount in the opposite direction. Examples of this are given in FIGS. 25, 26, and 27.

FIG. 25 shows an example 256-element solution sampling with offset 2500. Pre-generated solutions are given in graph A with 2510 intensity scale 2515 (phase in radians) and graph B 2520 with intensity scale 2525 (normalized amplitude). These are sampled at 1 mm pitch and generated to produce a focus at [x,y,z]=[0,0, 10 cm] relative to the center of the array at 40 kHz. The 256-element simulated array has 1.03 cm pitch and the sampled values are given by ‘x’s in graphs A 2510 and B 2520. In this case they are offset by −4 cm in the x-direction. Graph C 2530 with intensity scale 2535 in radians shows the resulting sampling with phase given by shade and amplitude given by the radius of the inner, filled, circle. Graph D 2540 with intensity scale 2545 in normalized pressure shows an x-z cross-section of the resulting simulated field pressure normalized to maximum=1.0. As expected, the focus appears at [4 cm,0,10 cm].

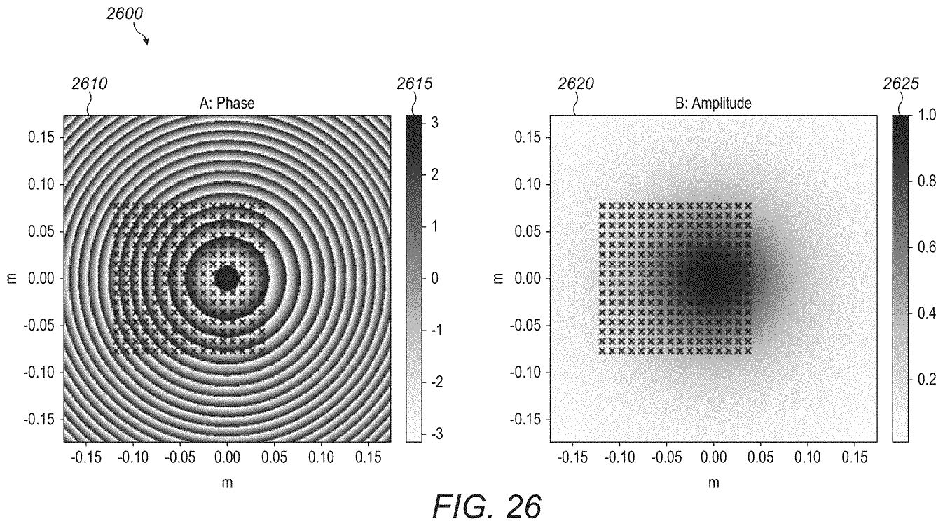

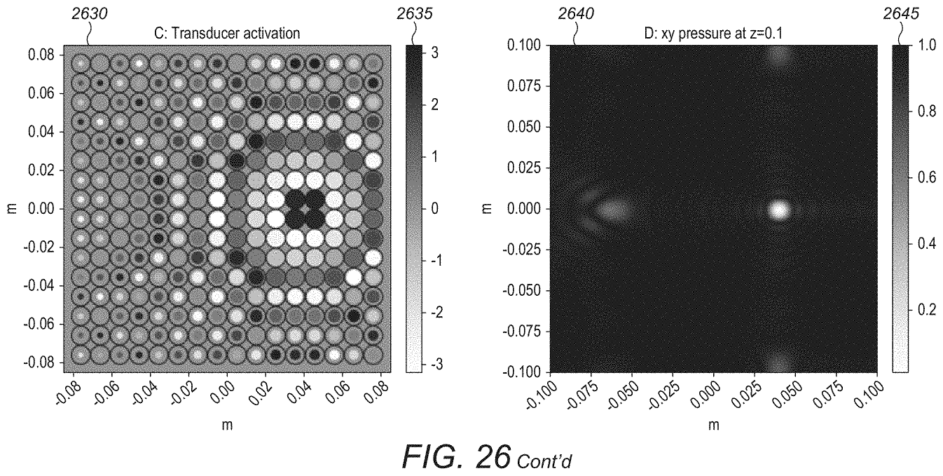

FIG. 26 shows example 256-element solution sampling with offset 2600.

Pre-generated solutions are given in graph A with 2610 intensity scale 2615 (phase in radians) and graph B 2620 with intensity scale 2625 (normalized amplitude). These are sampled at 1 mm pitch and generated to produce a focus at [x,y,z]=[0,0, 10 cm] relative to the center of the array at 40 kHz. The 256-element simulated array has 1.03 cm pitch and the sampled values are given by ‘x’s in graphs A 2610 and B 2620. In this case they are offset by −4 cm in the x-direction. Graph C 2630 with intensity scale 2635 in radians shows the resulting sampling with phase given by shade and amplitude given by the radius of the inner, filled, circle. Graph D 2640 with intensity scale 2645 in normalized pressure shows an x-y cross-section at z=10 cm instead of a x-z section at x=0 (as in FIG. 25).

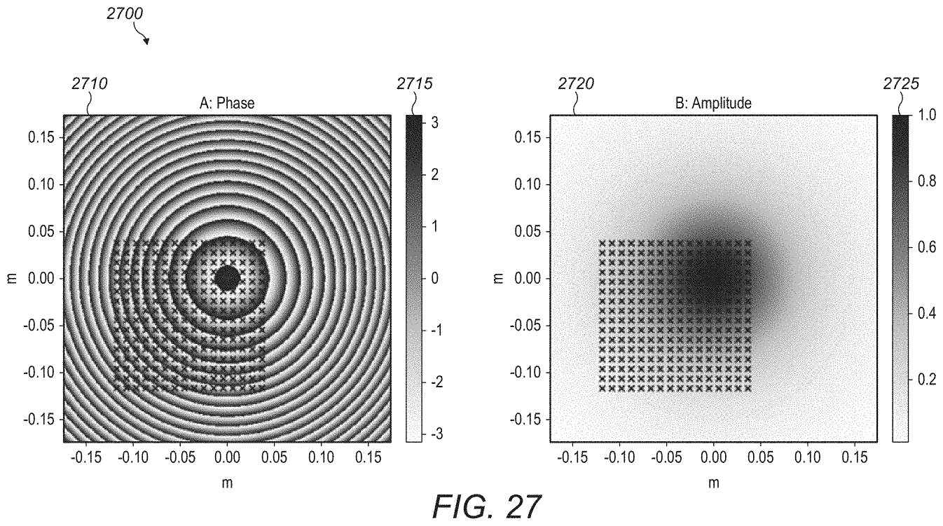

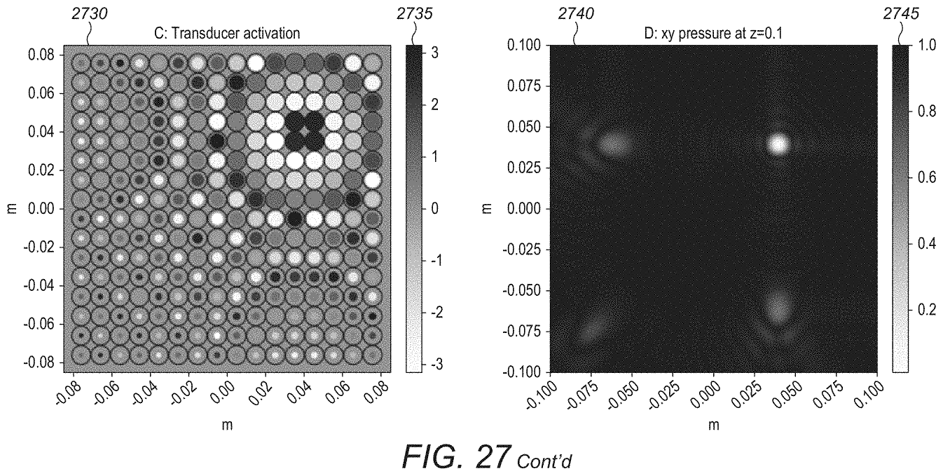

Shown in FIG. 27 is an example 256-element solution sampling with offset 2700. Pre-generated solutions are given in graph A 2710 with intensity scale 2715 (phase in radians) and graph B 2720 with intensity scale 2725 (normalized amplitude). These are sampled at 1 mm pitch and generated to produce a focus at [x,y,z]=[0,0, 10 cm] relative to the center of the array at 40 kHz. The 256-element simulated array has 1.03 cm pitch and the sampled values are given by ‘x’s in A and B. In this case they are offset by −4 cm in the x and y-direction. Graph C 2730 with intensity scale 2735 in radians shows the resulting sampling with phase given by shade and amplitude given by the radius of the inner, filled, circle. Graph D 2740 with intensity scale 2745 in normalized pressure shows an x-y cross-section of the resulting simulated field pressure normalized to maximum=1.0 at z=10 cm. As expected, the focus appears at [4,4,10] cm.

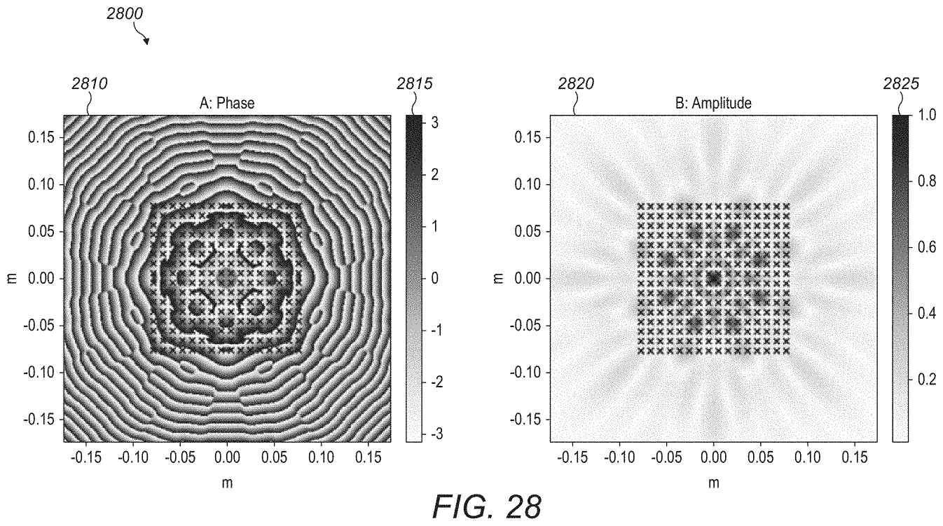

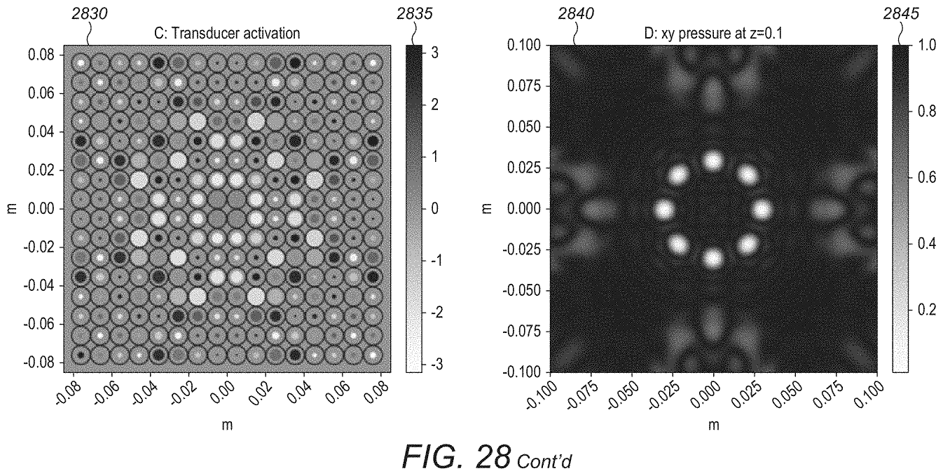

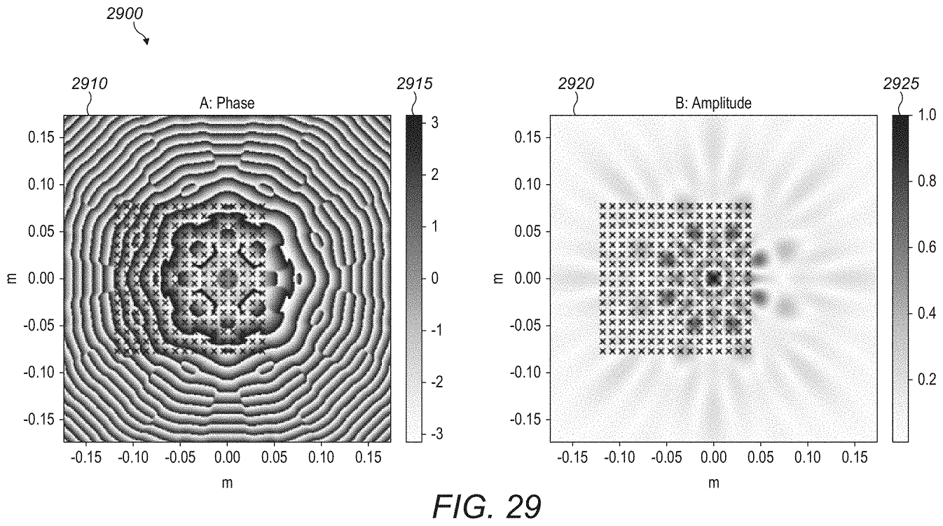

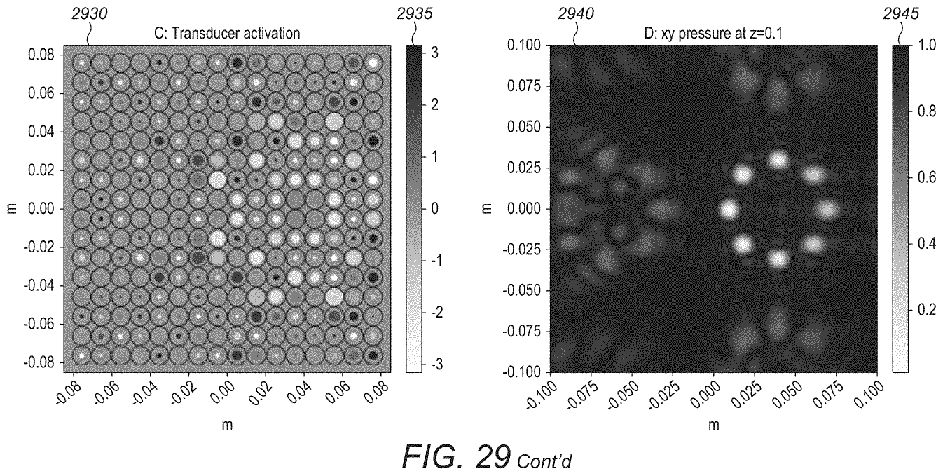

FIGS. 28 and 29 show examples using a more sophisticated solution producing 8 simultaneous focus points.

FIG. 28 shows an example 256-element solution sampling with offset 2800. Pre-generated solutions are given in graph A 2810 with intensity scale 2815 (phase in radians) and graph B 2820 with intensity scale 2825 (normalized amplitude). These are sampled at 1 mm pitch and generated to produce a ring of 8 focus points at a radius of 3 cm from x,y=0 relative to the center of the array at 40 kHz. The 256-element simulated array has 1.03 cm pitch and the sampled values are given by ‘x’s in graphs A 2810 and B 2820. Graph C 2830 having intensity scale 2835 in radians shows the resulting sampling with phase given by shade and amplitude given by the radius of the inner, filled, circle. Graph D 2840 having intensity scale 2845 in normalized pressure shows an x-y cross-section of the resulting simulated field pressure normalized to maximum=1.0 and at z=10 cm. This reproduces the 8-focal point field.

FIG. 29 shows an example 256-element solution sampling with offset 2900.

Pre-generated solutions are given in graph A 2910 having intensity scale 2915 (phase in radians) and graph B 2920 having intensity scale 2925 (normalized amplitude). These are sampled at 1 mm pitch and generated to produce a ring of 8 focus points at a radius of 3 cm from x,y=0 relative to the center of the array at 40 kHz. The 256-element simulated array has 1.03 cm pitch and the sampled values are given by ‘x’s in graphs A 2910 and B 2920. In this case the x-values are offset by −4 cm in the x-direction. Graph C 2930 with intensity scale 2935 in radians shows the resulting sampling with phase given by shade and amplitude given by the radius of the inner, filled, circle. Graph D 2940 with intensity scale 2945 in normalized pressure shows an x-y cross-section of the resulting simulated field pressure normalized to maximum=1.0 and at z=10 cm. This reproduces the 8-focal point field but offset by 4 cm in the x-direction. Points further from the origin of the array begin to lose pressure due to the more extreme angle.

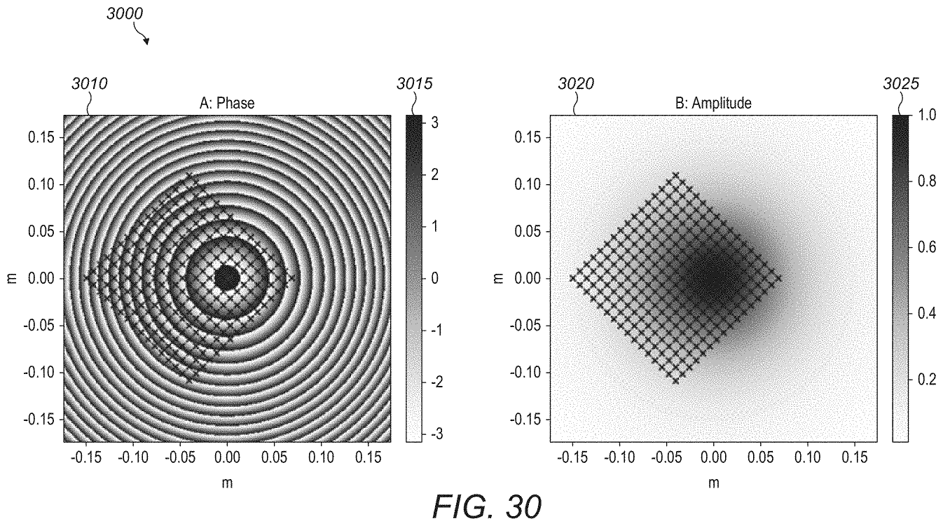

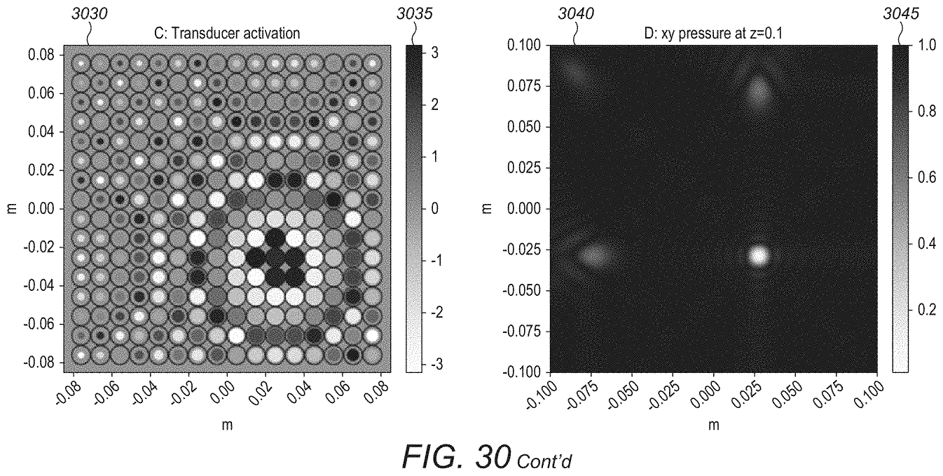

Rotation, like translation, is an equally valid coordinate transform for sampling the pre-generated solution. Solutions like a single focal point can be radially symmetric and a single rotation about the origin will not change the resulting field. But, in that case if rotation is followed by translation, a change in the field will manifest accordingly. An example of this is given in FIG. 30.

Shown in FIG. 30 is an example 256-element solution sampling with rotation offset 3000. Pre-generated solutions are given in graph A 3010 having intensity scale 3015 (phase in radians) and graph B 3020 having intensity scale 3025 (normalized amplitude). These are sampled at 1 mm pitch and generated to produce a focus at [x,y,z]=[0,0, 10 cm] relative to the center of the array at 40 kHz. The 256-element simulated array has 1.03 cm pitch and the sampled values are given by ‘x’s in graphs A 3010 and B 3020. In this case they are rotated by 45 degrees (clockwise) and offset by 4 cm in the negative x-direction. Graph C 3030 having intensity scale 3035 in radians shows the resulting sampling with phase given by shade and amplitude given by the radius of the inner, filled, circle. Graph D 3040 having intensity scale 3045 in normalized pressure shows an x-y cross-section of the resulting simulated field pressure normalized to maximum=1.0 at z=10 cm. As expected, the focus appears at [4/√2,−4/√2,10] cm, preserving the 4 cm distance from the origin and rotating in the opposite direction of the sampled rotation.

Like translation, the rotation in the field occurs in the opposite direction as the rotation in sampling.

A sub-class of solutions which include a single focus centered at [x,y]=[0,0] can be sampled in a way to change the solution plane along the z-axis. The transformation per-transducer is

x_{new}²+y_{new}²=z_{new}²−z_{old}²+x²+y²,

where x and y are the coordinates of the pre-transform transducer, z_{old} is the z-value of the original solution plane (such as the focus z-location for the single-focus example), z_{new} is the desired new solution plane, and x_{new} and y_{new} are the new x and y coordinates to sample the solution. This transform is perhaps more easily understood in cylindrical coordinates given by,

r_{new}²=z_{new}²−z_{old}²+r²

where r is the pre-transformation radial coordinate r_{new} is the new radius from the origin to sample. r_{new} can be converted back to x and y coordinates through normal cylindrical to cartesian coordinate transforms.

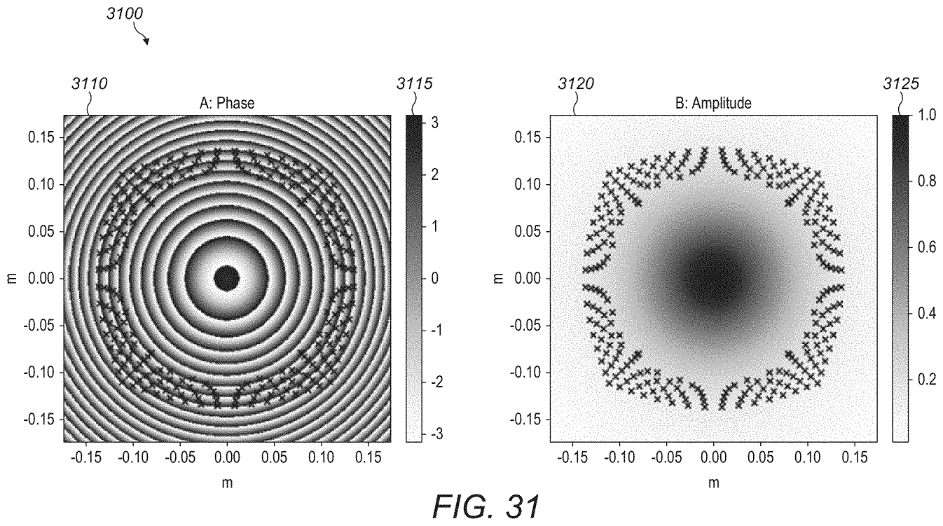

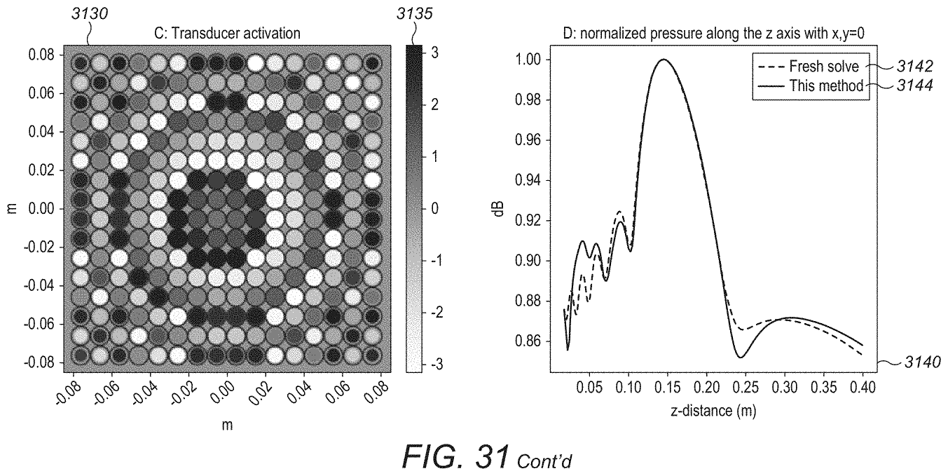

FIG. 31 shows an example of using this z-offset transformation to move a focus location from z=10 cm to z=15 cm 3100. Graph D 3140 gives a comparison to a newly generated solution for z=15 cm. Note that while there are differences away from the focus location, the pressure produced at the focus is nearly identical. The quality of this z-offset transformation will depend on the pitch of the stored solution. As z is adjusted further from the original focus location, the sampled points will approach each other. As this differences approaches the stored pitch, the focus quality will degrade as a result. If a large dynamic range of z-focus values is desired, one solution is to store the original solution at very fine pitch, thereby maintaining the quality of the sampled solution at very fine sampled spacing. Another solution is to transition to a different stored solution designed to focus at a larger range when that distance is approached. Transition techniques to new transducer locations as well as entirely new solutions are discussed below.

Specifically, FIG. 31 shows an example 256-element solution sampling with a z-offset transformation 3100. Pre-generated solutions are given in graph A 3110 having intensity scale 3115 (phase in radians) and graph B 3120 having intensity scale 3125 (normalized amplitude). These are sampled at 1 mm pitch and generated to produce a focus at [x,y,z]=[0,0, 10 cm] relative to the center of the array at 40 kHz. The 256-element simulated array has 1.03 cm pitch and the sampled values are given by x's in A 3110 and B 3120. In this case the sampling is adjusted by x_{new}²+y_{new}²=z_{new}²−z_{old}²+x²+y², with z_{new} given by 15 cm. Graph C 3130 having intensity scale 3135 in radians shows the resulting sampling with phase given by shade and amplitude given by the radius of the inner, filled, circle. In this case the amplitude is rescaled so that at least one transducer is at full drive and the rest are proportional to that value as described by the solution in graph B 3120. Graph D 3140 is a plot of the normalized pressure along the z-axis with x,y=0. The solid line 3144 is the simulation of the sampled solution (this invention). The dashed line 3142 is shows a new solution directed at z=15 cm for comparison. While differences are observed, deviation at the focus location (z=15 cm) are minimal.

The z-offset transformation can produce undefined solutions when z_{new} is desired to be smaller than z_{old}. As a result, applications of this technique should focus on only z_{new}>z_{old} to avoid this problem. New solutions with smaller z can be transitioned to as the desired z-focus location approaches the array. If this is not practical, in one embodiment, transducers with an undefined sample location use the stored phase and amplitude found at the origin of the stored solution. In another embodiment, transducers with an undefined sample location are disabled.

All transformations within the plane (translation or rotation) must be done before applying the z-transformation and the post-translation or rotation then fed into the z-offset transformation.

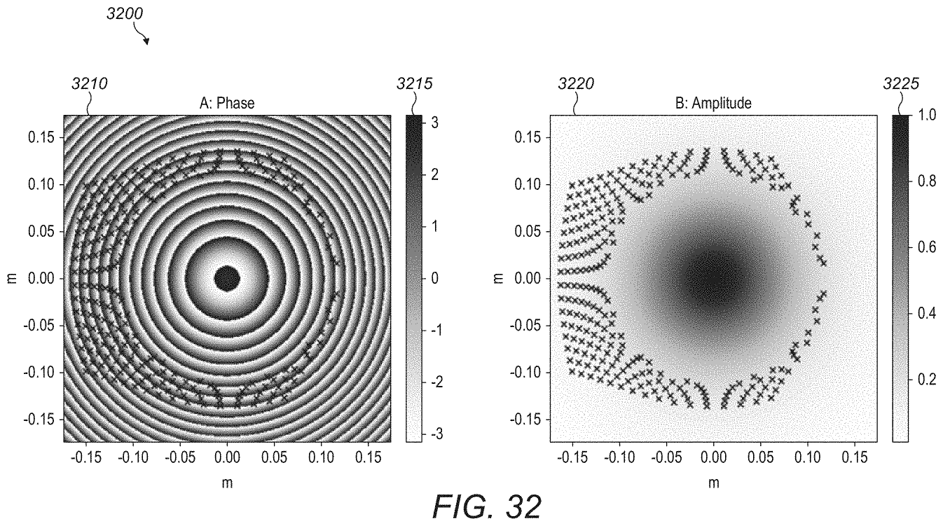

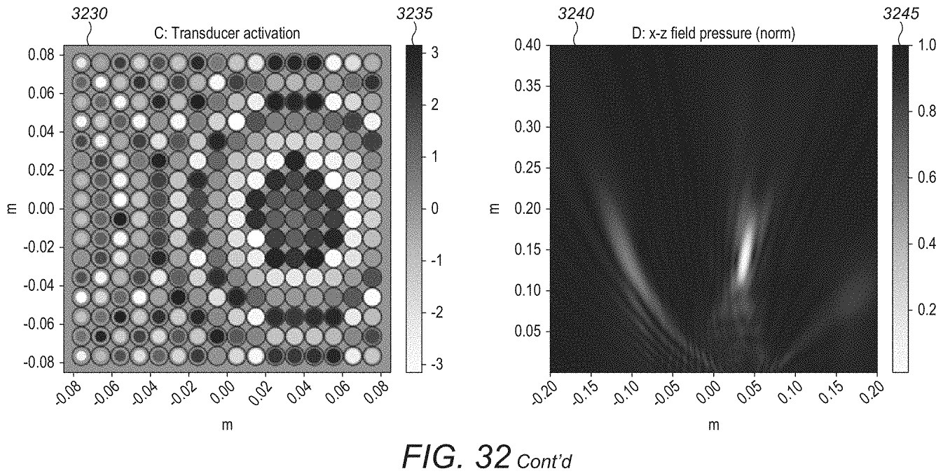

FIG. 32 illustrates an example of a translation followed by a z-offset transformation 3200. The z-offset transformation requires more computation than translation and could be beyond the capability of some hardware implementations to execute quickly. One operation that is possible after a z-offset transformation which is computationally inexpensive is to offset the solution from one transducer to an adjacent transducer. This shifts the resulting field by the pitch of the transducers in the offset-z plane. This could be done with a shift of one pitch unit or many or even including rotation or mirroring. Transducers near the edge or in some way do not have a solution to shift to can either be disabled or a new solution be generated for them via a new lookup-location calculation or direct computation.

Shown in FIG. 32 is an example 256-element solution sampling with a translation in x followed by a z-offset transformation 3200. Pre-generated solutions are given in graph 3210 having scale intensity 3215 A (phase in radians) and graph B 3220 having scale intensity 3225 (normalized amplitude). These are sampled at 1 mm pitch and generated to produce a focus at [x,y,z]=[0,0, 10 cm] relative to the center of the array at 40 kHz. The 256-element simulated array has 1.03 cm pitch and the sampled values are given by ‘x’s in Graphs A 3210 and B 3220. In this case the sampling is first translated in x by −4 cm and then adjusted by x_{new}²+y_{new}²=z_{new}²−z_{old}²+x²+y², with z_{new} given by 15 cm. Graph C 3230 having intensity scale 3235 in radians shows the resulting sampling with phase given by shade and amplitude given by the radius of the inner, filled, circle. In this case the amplitude is rescaled so that at least one transducer is at full drive and the rest are proportional to that value as described by the solution in Graph B 3220. Graph D 3240 having intensity scale 3245 in normalized pressure shows an x-z cross-section of the resulting simulated field pressure normalized to maximum=1.0. As expected, the focus appears at [4 cm,0,15 cm].

While transducer locations and stored solutions have largely been discussed in the context of rectilinear coordinates, this is by no means a requirement. Any coordinate system can be used as long as it maps to a 2-dimensional space. In this way, certain solutions can exploit symmetries to reduce computation, memory usage, or both. A solution to a single focus point, for instance, is radially symmetric, and can be stored as a function only of radius from the origin. After transforming the location of each transducer (through any of the above presented transformations), the radius from the origin then determines the driving phase and amplitude. While this reduces solution memory storage, it might not be the fastest implementation in hardware. In another embodiment, the solution is kept in rectilinear coordinates but only one quadrant is stored. Since the solution is symmetric about both the x and y axis, it is relatively easy to map a negative-x or negative-y coordinate to the positive equivalent, thereby reducing memory usage.

Certain transducer layouts can be used to simplify the transformations. Rectilinear arrangements make translation in x or y simple as the offset for one transducer applies to all, but changes in z take more computation.

Arrangements with many transducers at equal radius from the origin can simplify changes in z when x and y are zero, as one radius transformation will apply to multiple transducers.

The sampled solution amplitude represents only one possible amplitude in the solution. If, for example, none of the transducers are being driven at maximum, the solution can be scaled up to the point where at least one transducer is driven at full-scale. This scaling factor can be found by searching the array of sampled values and finding the max drive from the solution. To preserve the shape of the field, the remaining transducers can be scaled by the same factor.

Another application of scaling is to modulate the field. After searching the solution array for the maximum value, this determines then the range of the possible amplitudes. If less total amplitude is desired, for instance if amplitude modulation of the field is desired, all activation coefficients can be scaled together by a time-varying function. This can happen on a fixed sample arrangement or dynamically as the sampled locations are adjusted.

In another embodiment, the solution amplitude is ignored and only the phase sampled in the solution while leaving the amplitude at a fixed value (full-drive, for instance). For a single focus point solution, this will preserve any focus location, but may change the field away from the foci depending on the transformations applied to the sampled locations. It does, however, greatly simplify amplitude modulation as all transducers will receive the same amplitude.

Two (or more) sets of sampled activation coefficients can be summed (using complex phasor notation) to produce all output fields simultaneously. For this to function, first, the summed coefficients together need to be under the maximum drive for every transducer. If they exceed the max, the solution must be scaled (by the maximum value, or more) or clipped (all values over the maximum drive, are set to maximum while preserving phase). Second, it is not a guarantee that the field produced by the first solution will not interfere and change the other solutions in some meaningful way. Using the example of a single focus solution, sampled to produce two spatially distinct foci, depending on the spatial relationship of each focus to each other and the physical layout of the array, the fringing field from one focus can reduce the second or vice versa. In other arrangements of foci location, one could constructively interfere and increase the pressure of one or both foci beyond what was intended. In one embodiment, this is ignored-interference can be a rare occurrence in many arrangements.

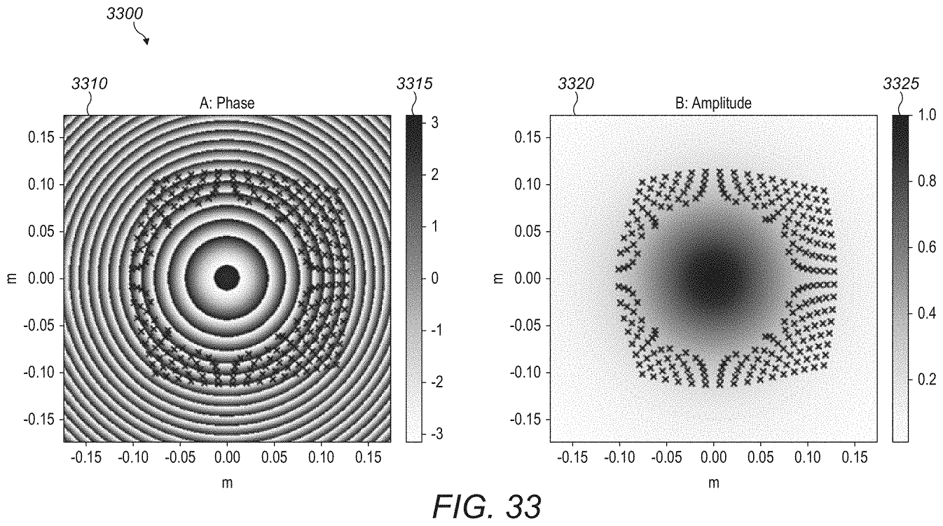

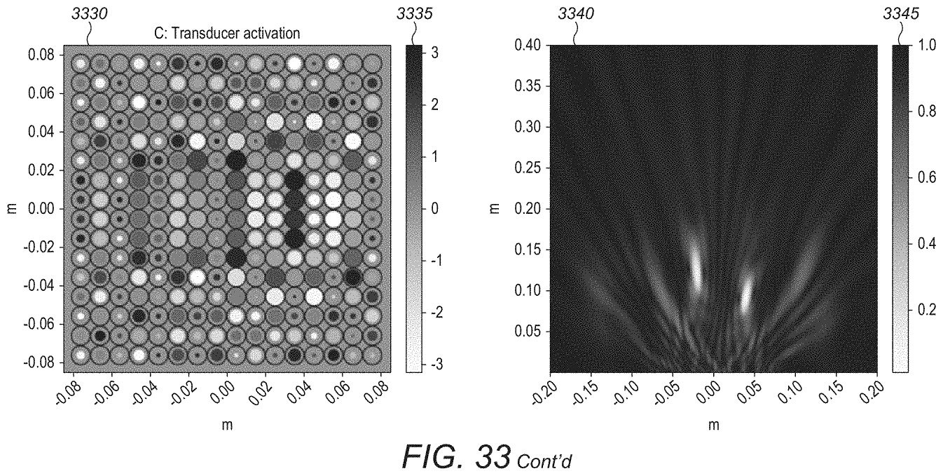

FIG. 33 illustrates an example simulation of two solutions being produced simultaneously without any phase rotation 3300. In another embodiment, the array output could be simulated and all possible combinations of points which cause interference could be predicted and avoided. In another embodiment, in cases of interference, the phase of one or more solutions are rotated to avoid or mitigate the interference. The locations which cause interference and what rotation values to use can be stored and reference during operation. In another embodiment, a machine learning model is trained using acoustic simulations or real data to predict locations of possible interference and return phases and amplitudes needed to remedy the interference for each solution.

FIG. 33 shows an example 256-element solution sampling, illustrating the sum of two solutions 3300. Pre-generated solutions are given in graph A 3310 having intensity scale 3315 (phase in radians) and graph B 3320 having intensity scale 3325 (normalized amplitude). These are sampled at 1 mm pitch and generated to produce a focus at [x,y,z]=[0,0, 10 cm] relative to the center of the array at 40 kHz. The 256-element simulated array has 1.03 cm pitch and one of the two sampled solutions are given by ‘x’s in graphs A 3310 and B 3320. In this case the sampling is first translated in x by +2 cm and then adjusted by x_{new}²+y_{new}²=z_{new}²−z_{old}²+x²+y², with z_{new} given by 13 cm. The other solution (not shown) is rectilinear sampling translated by −4 cm without a z-offset transformation (same as FIGS. 25 and 26). These two sampled solutions are summed (in complex phasor notation) with normalization coefficients 0.65 and 0.35 respectively. Graph C 3330 having intensity scale 3335 in radians shows the resulting solution with phase given by shade and amplitude given by the radius of the inner, filled, circle. In this case the amplitude is rescaled so that at least one transducer is at full drive and the rest are proportional to that value. Graph D 3340 having intensity scale 3345 in normalized pressure shows an x-z cross-section of the resulting simulated field pressure normalized to maximum=1.0. As expected, two foci appear at [−2 cm,0,13 cm] and [4 cm,0,10 cm].

Other methods also exist to manage possible interference between summed fields. The key to mitigating the interference is to predict the output of each field at key points of interest. With all fields estimated at all points of interest, the results can be summed to predict final field. Points of interest can include focus points, points of known objects nearby the array, a reflective surface, or similar. Any one field can be driven by a different phase than is stored in the solution by rotating the phase of all activation coefficients by the same amount. This affects every point in the produced field by the same amount and the sum at each point of interest will be similarly affected. This divides the problem into two separate problems: 1. How to estimate the field at arbitrary points of interest and 2. How to choose phases of individual field solutions so that interference is minimized.

Estimating the field has a number of solutions. In one embodiment, a mathematical model of each transducer's acoustic field is used to estimate the contribution of each transducing element to each point of interest. The sum of all these contributions multiplied by their individual activation coefficients (all in complex phasor notation) is then the estimate of the field at the point of interest. In another embodiment of the invention, a complete simulation of the field when it is focused at each location in the interactive volume is stored in memory and then referenced as at each point of interest for each focus location. Interpolation may need to be used if the stored solution is at low resolution and higher resolution is needed. In another embodiment, a mathematical model of the field around a focal point is used rather than a model from individual transducer. This model includes the steering direction and distance from the array and can be validated against measured data. Yet another embodiment uses a machine-learning model which performs the same calculation and is trained with simulation and/or experimental data.

After the field is estimated at each point of interest a phase-oracle algorithm can be used to rotate phases and scale amplitudes of each solution to optimize the output. Power iteration on the phase of each solution's activation and resulting phase of each point of interest is one method. Other methods exist in the literature.

Transitioning from one set of sampled coefficients to another requires care to avoid sharp changes in the acoustic field which can lead to audible artifacts. Note that this transition includes both transformations within one solution as well as transitions to a completely different stored solution which can include a different transformation. In one embodiment, the system limits the magnitude of the change of each coefficient in the complex phasor domain. If the desired change is larger than this magnitude, the system steps the activation coefficient by the maximum amount allowed until the desired value is reached. If the desired change is modified before reaching the previously desired value, the system starts stepping in the new direction from its last state. In another embodiment, this step is dynamically sized so that the interpolated value contains a minimum bandwidth of modulation. An example of this is a sinusoidal profile with the start and finish of the transition approaching a zero time-derivative. In another embodiment, a proportional-integral-derivative (PID)-type controller framework is used to manage the transitions for each coefficient. In another embodiment, the real and imaginary part of the activation coefficient are fed to a low-pass frequency filter of arbitrary architecture. The output of this filter is used as the driving coefficient. In another embodiment, the stored solution itself is used as a moderator of transition speed by limiting the next-sampled solution value to be within a certain maximum distance within the solution. If the desired solution is more than one distance-step away from the current, then it chooses the value most towards the desired value within the limits of the distance-limit. For example, if the solution is in cartesian coordinates, one could limit the change to be an adjacent cell within the 2-dimensional solution and the direction to step would proceed along the direction in the difference vector with the highest magnitude. This direction is updated with each change in desired solution. In yet another embodiment, the amplitude of the drive is reduced to zero (via a linear or variable-step ramp) and then ramped back up at the new phases, thus avoiding a sharp transition. This method is the most extreme as the ramp would take time and during this period the fields would be lower in magnitude. This technique could be used in concert with others and only utilized when some criteria is entered such as the average degree of change required.

To change to a new field, in most cases every transducer requires a new driving condition. When all transducers are changed simultaneously (such as in the same acoustic cycle), the changing fields act in unison to produce audible artifacts. To mitigate this effect, the system can limit the number of transducers which receive changes per acoustic cycle. In one embodiment, only one transducer is changed per acoustic cycle. This transducer could be chosen to maximize the change in the field (such as magnitude change), at random, or some other metric. In another embodiment, the system would limit the number of transducers allowed to change to some value n where n is less than the total number of transducers in the system. The selection of transducers could be made at random or with a quality metric. An example quality metric would be magnitude of the complex driving difference sum. Another could be the n largest magnitude changes. The change in sampling could be limited so that every transducer has a chance to transition before choosing a new set of samplings, but this is not required. If requested changes build up faster than the coefficients are allowed to change, however, then the field will no longer be manifesting as desired, and could be difficult to predict, but will tend preferentially to uniform noise.

The solution density used is a balance between memory and field accuracy. The more dense the solution field stored, the finer the system will be able to manipulate the field. This includes all of the transforms given above. In particular, when a solution is modified with a z-offset transformation, this necessarily groups the sampled values closer together. As long as the sampled separation is much larger than the pitch of the solution, the field produced will be close to ideal. If the sampling starts to give the same value to multiple transducers, then the system will tend towards uniform beaming behavior. In one embodiment, a higher-resolution can be simulated using interpolation of adjacent solution values. In another embodiment, losses compression is used to reduce the memory usage of a stored solution which is then decompressed in real-time or into memory before use.

Using a set of basis functions with an independent time variable and solving a least squares system to achieve lossy compression of the transducer drive conditions may be considered as another method to achieve a further trade-off, in this case memory and decoding complexity. A set of basis functions may be sampled at a number of points in time to form an A matrix, the intended drive conditions for a given transducer form a b vector and the compressed set of coefficients x that may be reconstructed into a set of functions whose summations approximate the original drive conditions when the linear system Ax=b is solved off-line. This linear system may be written as:

$$A x = b = [ \begin{matrix}{f}_{1} ( {t}_{1} ) & … & {f}_{m} ( {t}_{1} ) \\ ⋮ & ⋱ & ⋮ \\ {f}_{1} ( {t}_{N} ) & … & {f}_{m} ( {t}_{N} )\end{matrix} ] [ \begin{matrix}{x}_{1} \\ ⋮ \\ {x}_{m}\end{matrix} ] = [ \begin{matrix}α ( {t}_{1} ) \\ ⋮ \\ α ( {t}_{N} )\end{matrix} ]$$

where there are m basis functions f₁(t), . . . , fₘ(t), N samples of the transducer drive conditions where at least part of the transducer drive condition under consideration is α(t).

As harmonic fields that repeat in time (but more slowly than the carrier frequency) are often the most useful, these can be represented as basis functions with periodic boundary conditions and can have a simple trigonometric or wavelet decomposition that allow for example series of sines, sawtooth waves or square waves with different frequencies to reconstruct a set of transducer drive conditions that may be then applied to the array by evaluating the summation over time. While this kind of implementation would generally require multiplications due to the presence of different coefficients, other methods may be used to take advantage of specific choices of basis function such as CORDIC for trigonometric functions, additive or subtractive counters for sawtooth waves and bit-wise manipulation for square wave generation among others.

Normalizing the sampled solution so that at least one transducer (or all transducers) have maximum drive generates the maximum pressure in the field possible from the array. If, however, a lower pressure is desired, the system can normalize the array activation coefficients with a lower value. In some instances, such as controlling the pressure produced at a focal point solution, a specific pressure is desired. In those cases, the pressure at one or many points of interest from the full-power solution must be estimated, this then can be used as a scaling factor to proportionally scale the solution's amplitudes down to the desired value. Various methods of field estimation have been discussed above and all could be used in this context. Other solutions exist, however, if points of interest follow reduced degrees of freedom.

One example of reduced degrees-of-freedom is if the system only needs to control the pressure at a single focal point solution. In one embodiment, the resulting focus pressure for every translation and z-offset transformation is simulated or measured in advance and stored on the device. Sampling of this solution provides a scaling value to use to scale the sampled solution to the desired pressure. Resolution of the focus solution pressure need not be higher than lambda/10 where lambda is the wavelength of ultrasound used. If memory is an issue, a lower resolution can be used and sampling could be rounded or interpolated. In another embodiment, the only pressure stored in memory is the default solution pressure, without translation or transformation. When the solution is resampled, the offset from the default distance from the origin of the array is calculated and the default pressure is scaled by the reciprocal of the new distance. For example, if the original solution has a pressure P₀ at a distance of r₀, a reasonable approximation of the pressure P at a new distance r is given by

$$P = \frac{{P}_{0} {r}_{0}}{r} .$$

This approach works for single focus solutions or more complicated field solutions. In another embodiment, an alternate equation is used as a pressure estimate which better matches simulation or experiment such as a polynomial or more sophisticated fit to real or simulated data. In another embodiment, a machine-learning model is trained with real or simulated data to predict pressure for a given offset from the original solution and then is used to scale the solution.

For multipoint solution summation, the pressure estimate for each solution is used to scale each solution before summation to assure appropriate levels. For instance, if one solution provides a pressure of 1 (in scaled units) and the other pressure provides a pressure of 0.5 and the desire is to have each solution at the same pressure, the solution would be to weight the second solution with double the amplitude of the first one. In that way, the resulting output would be similar.

In summary, this invention provides a method of sampling a stored solutions within an acoustic phased array which manipulates the output field in a controlled way. This reduces computation requirements and increases flexibility of simple acoustic phased array systems.

II. Additional Disclosure

1. An acoustic phased array system comprising,

A plurality of transducers with known positions and orientations

### Memory

A set of driving phases stored in memory
A mapping of the stored driving phases to each transducer
A second, distinct mapping of the stored driving phases
A electronic diving circuit
The electronic driving circuit uses the first mapping to power the transducers at the specified phases
The electronic driving unit then uses the second mapping to power the transducers at the specified phases
2) A system as in 1, where amplitude is stored alongside phase in memory and is included in the mapping.
Subclaims involving various transforms of the mapping
Subclaims involving pressure estimation and scaling
Subclaims involving multipoint possibilities and how to sum them.
Subclaims involving interpolation of the solution
Subclaims involving storing multiple solutions in memory.
Subclaims involving transition techniques.

### 4. Spatio-Temporal Modulation Using Multiple Carrier Frequencies

I. Introduction

Spatial modulation may be generated by generating paths through space for control points of relatively high acoustic pressure to travel along. Haptics may be created in this way along both open and closed paths. By creating a diffraction pattern from a phased array at a single carrier frequency with the phase changing progressively along the curve, when the same pattern is produced by phased arrays with multiple carrier frequencies, the phase movement along the path can be made to generate the emergent effect of a moving high acoustic pressure region.

Referring back to the beat frequencies equation:

$$= 2 \vert {φ}_{1} ( x ) \vert cos ( \frac{{ρ}_{1} + {ρ}_{2}}{2} ) cos ( \frac{{ρ}_{1} - {ρ}_{2}}{2} ) + ( \vert {φ}_{2} ( x ) \vert - \vert {φ}_{1} ( x ) \vert ) cos ( {ρ}_{2} )$$

where 1 and 2 are interchangeable due to the symmetry of cosine around the origin, and:

ρₖ=arg(φₖ(X))+ωₖt+ϕₖ.

Given that in each case, a phased array may be assumed to be creating the spatially defined complex-valued functions φₖ(x), as these are controlled in phase, ϕₖ may be absorbed into this function and so set to zero. The phase angle of the low frequency component may then be written as:

ρ′=(arg(φ₁(x))−arg((φ₂(x)))+(ω₁−ω₂)t,

where (ω₁−ω₂)t can be described as the progressive part of the phase angle in the low frequency, with arg(φ₁(x))−arg(φ₂(x)) describing the phase offset for each spatial location at that low frequency.

Both carrier frequencies are expected in most embodiments to be high frequencies with a small difference, so components that are only high frequency, such as the component proportional to the difference between the absolute amplitudes (|φ₂(x)|−|φ₁(x)|)cos(ρ₂) can be neglected. However, the objective here is to maximize the effect of the low frequency component cos ½(ρ₁−ρ₂). The most efficient approach is therefore two-fold, first maximising each |φₖ(x)| while minimising the difference between them (as difference would result in wasted high frequency signal that would not be modulated), and second ensuring spatially neighbouring locations differ in phase ρ′ to create movement over each low frequency period.

One way to describe the target field given a desired speed of movement v(x) is by writing the phase angle in the form of an Eikonal equation:

|∇ρ′|=|∇(arg(φ₁(x))−arg((φ₂(x)))|=v(x),

with the implication that this may be achieved in multiple dimensions yielding moving lines or surfaces, where initial conditions can denote times where the haptics is present and may be solved for using a differential equation formulation coupled with an algorithm such as fast marching.

Equally, for simple scenarios constructing ∇ρ′ as the direction and magnitude of the apparent low frequency movement is straightforward and does not require a solver algorithm to yield a set of phases that can be used to generate a high acoustic pressure point with apparent motion at the low frequency modulation. This can be achieved by heuristics, such as for example taking a closed curve and a desired number of points and for a constant speed of movement, determining the length of the curve and generating a set of control points that generate the phases required at each point along the curve by dividing the segment of the curve travelled by the total curve length and multiplying through by the number of 2π rotations desired. In general, painting a contiguous set of points with similar amplitude magnitude and moving phase generates a point of high acoustic pressure with apparent movement.

II. Solving for Acoustic Sources

Once the sets of points have been set up with amplitude and phase, then to create these points a ‘phase plate’ or some region of space which is intended to act as a source must be populated with virtual acoustic sources which are solved for which will then create the field specified. This has also been referred to as a ‘solution field’. One method to achieve this is by using an iteratively re-weighted quadratic maximization.

Taking the set of unit amplitude and zero phase sources, these can be evaluated at any location (x,y,z) yielding a column vector of linear complex-valued acoustic outputs (such as pressure or medium particle velocity) from acoustic sources as Ψ(x,y,z):

$$Ψ = [ \begin{matrix}{Ψ}_{1} ( x , y , z ) \\ ⋮ \\ {Ψ}_{n} ( x , y , z )\end{matrix} ] ,$$

Taking a spatially defined complex-valued weighting function w(x,y,z) (initialised to one to begin with at any target point) the basis vector of source contributions for any target point may be reweighted, yielding:

f_{q}(xⱼ,yⱼ,zⱼ)=v_{q}·w̅(̅x̅ⱼ̅,̅y̅ⱼ̅,̅z̅ⱼ̅)̅·Ψ_{q}(xⱼ,yⱼ,zⱼ),

where the overline denotes the operation of complex-conjugate and v_{q} is a real weighting on the acoustic source function that may be used to control the proportion of each source used, in the case that sources are over- or under-utilised. Then a column vector may be defined as for m control points:

$$f = [ \begin{matrix}{v}_{1} \cdot {\sum }_{j = 1}^{m} {f}_{1} ( {x}_{j} , {y}_{j} , {z}_{j} ) \\ ⋮ \\ {v}_{q} \cdot {\sum }_{j = 1}^{m} {f}_{q} ( {x}_{j} , {y}_{j} , {z}_{j} ) \\ ⋮ \\ {v}_{n} \cdot {\sum }_{j = 1}^{m} {f}_{n} ( {x}_{j} , {y}_{j} , {z}_{j} )\end{matrix} ] ,$$

where the summation over m may be replaced by a continuous integral if required.

Then using linearity, this may be multiplied component-wise by complex activation values ‘driving’ each source (x_{q}) leading to the vector:

$$m = [ \begin{matrix}{x}_{1} \cdot {v}_{1} \cdot {\sum }_{j = 1}^{m} {f}_{1} ( {x}_{j} , {y}_{j} , {z}_{j} ) \\ ⋮ \\ {x}_{q} \cdot {v}_{q} \cdot {\sum }_{j = 1}^{m} {f}_{q} ( {x}_{j} , {y}_{j} , {z}_{j} ) \\ ⋮ \\ {x}_{n} \cdot {v}_{n} \cdot {\sum }_{j = 1}^{m} {f}_{n} ( {x}_{j} , {y}_{j} , {z}_{j} )\end{matrix} ] ,$$

where n is the number of acoustic sources. Driving an array of acoustic transducers at a fixed frequency with such an input x vector to maximise an acoustic quantity encoded in a matrix M may be expressed as a linear algebra problem, so that the intention is to:
maximize x^{H}Mx
subject to x^{H}x=1,
and x∈ [symbol] ⁿ.

This may be solved by taking the dominant eigenvector of the matrix M, as the statement of the problem is also equivalently the definition of an eigenvector, here x where:

$$x = [ \begin{matrix}{x}_{1} \\ ⋮ \\ {x}_{q} \\ ⋮ \\ {x}_{n}\end{matrix} ] ,$$

This may be solved by taking the dominant eigenvector of the matrix M, as the statement of the problem is also the definition of an eigenvector, here x. Building the matrix M can be written now as:

m^{H}m=x^{H}Mx=x^{H}ff^{H}x,

so,

M=ff^{H}.

Therefore, the iterative method may be obtained by on each iteration determining the dominant eigenvector, weighting the output vectors to yield on average the correct amplitude level and then reweighting the amplitude between each control point using the weight update equation:

$${w}_{t + 1} ( {x}_{j} , {y}_{j} , {z}_{j} ) := {w}_{t} ( {x}_{j} , {y}_{j} , {z}_{j} ) \cdot \frac{{Ψ}_{r}^{′} ( {x}_{j} , {y}_{j} , {z}_{j} )}{{Ψ}_{t}^{′} ( {x}_{j} , {y}_{j} , {z}_{j} )} ,$$

where Ψ′ᵣ(xⱼ,yⱼ,zⱼ) is the desired total complex-valued linear acoustic quantity and Ψ′_{y}(xⱼ,yⱼ,zⱼ) is the sum generated by the solution at iteration t as:

$${Ψ}_{t}^{′} ( {x}_{j} , {y}_{j} , {z}_{j} ) = {\sum }_{q = 1}^{n} {x}_{q , t} \cdot {v}_{q , t} \cdot {f}_{q} ( {x}_{j} , {y}_{j} , {z}_{j} ) ,$$

so although this iteratively re-weighted maximization method cannot easily produce zero control points, it is well suited to generating fields for this multiple frequency method for generating high acoustic output points with apparent movement at the beat frequency.

If the two frequencies are close enough, then the solution may be reused for both acoustic source systems, although separate solutions may always be obtained for each carrier frequency.

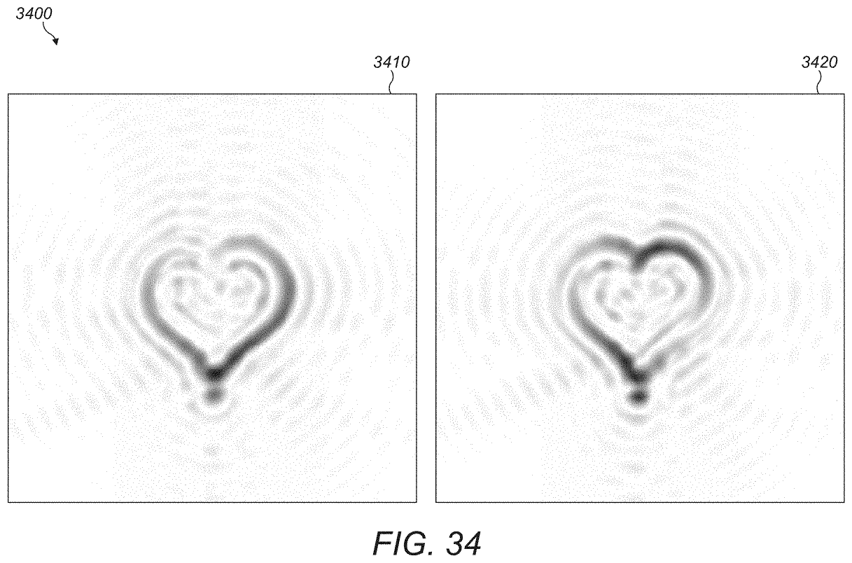

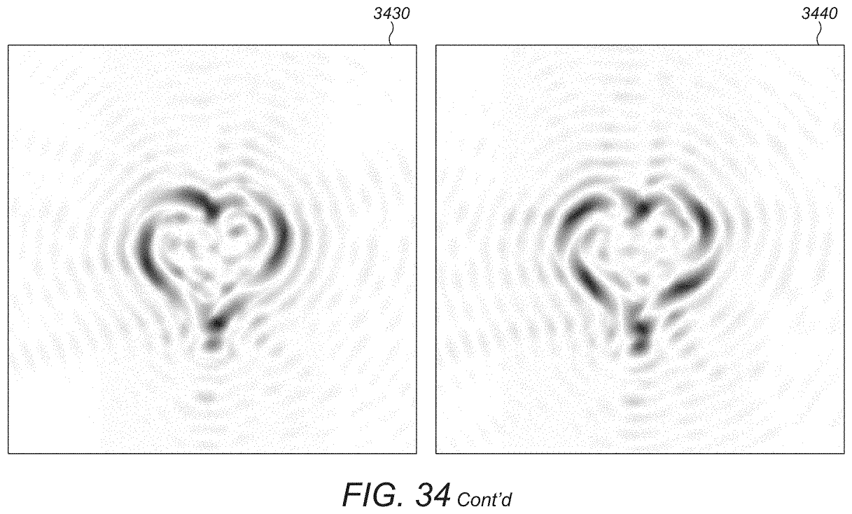

As shown in FIG. 34, constructing movement for closed curves is subject to some restrictions due to the winding number of the phase only taking integer values.

Specifically, FIG. 34 shows slices of the acoustic field 3400 generated from one of the carrier frequencies, where shading is linearly proportional to amplitude and phase angle. This creates a haptic point running around a heart-shaped closed curve. Presented here are four different phase winding counts to create different perceived movement speeds on the skin using the same difference frequency. The top left 3410 completes 2π, top right 3420 completes 4π, bottom left 3430 completes 8π and bottom right 3440 completes 12π, where each corresponds to a haptic frequency of the point completing the trajectory of 1, ½, ¼ and ⅙ of the difference frequency respectively. Note the linear shading in phase angle may distort the appreciation of the amplitude of the result.

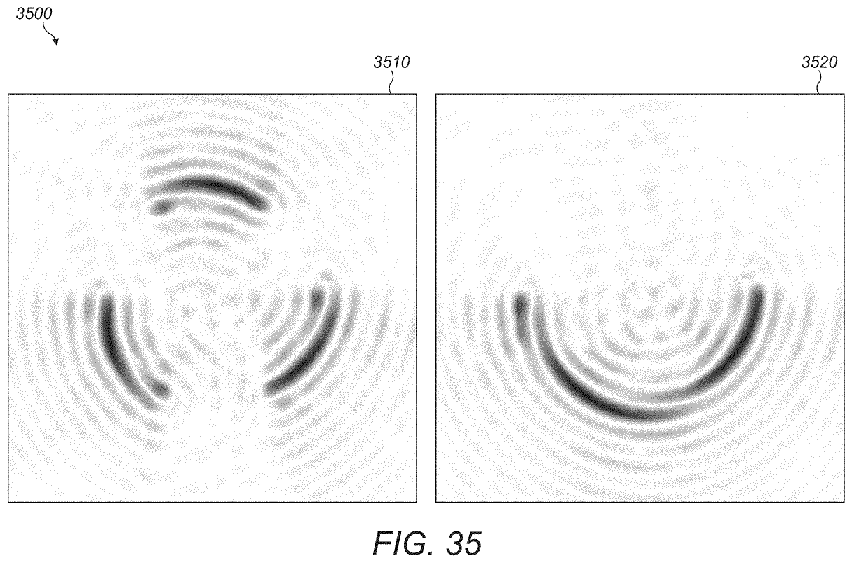

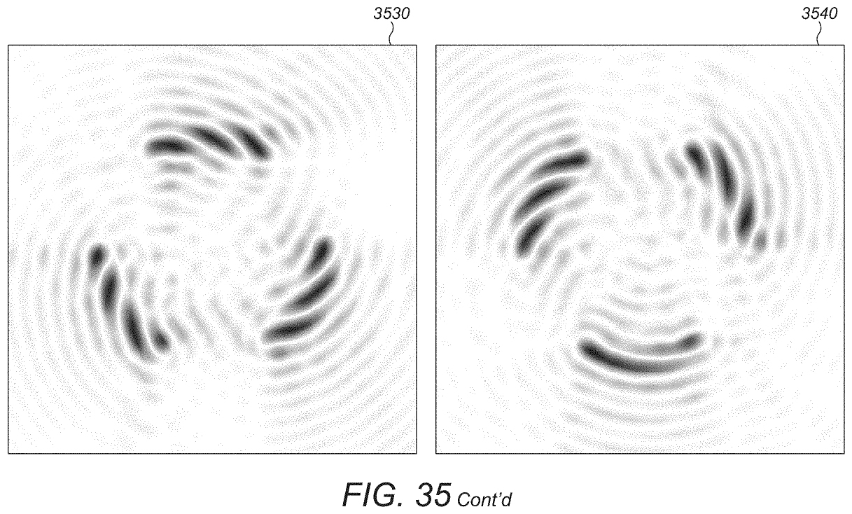

In FIG. 35, it is shown that fewer restrictions are present when dealing with open curves and that asymmetry, multiple curve segments and different speeds are possible within the same field.

Specifically, FIG. 35 shows a slice of the acoustic field 3500 generated from one of the carrier frequencies, where shading is linearly proportional to amplitude and phase angle. Here it is shown that the movements need not be restricted to continuous curves (top left 3510), need not be symmetrical (3520 top right), need not be a round multiple of 2π (bottom left 3530, 16π/6) and need not have each segment of discontinuous curve have the same point speed (bottom right 3540).

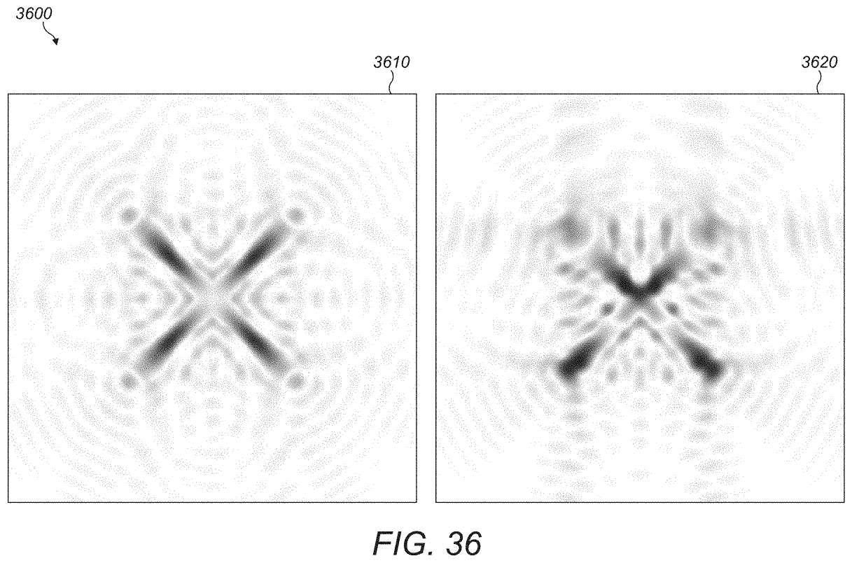

In FIG. 36, it is shown that different directions of travel are possible by manipulating the direction of ∇ρ′.

Specifically, FIG. 36 shows slices of the acoustic field 3600 generated from one of the carrier frequencies, where shading is linearly proportional to amplitude and phase angle. Here it shown that there is also freedom to choose the apparent movement direction of the generated points. While the left sensation 3610 is generated radially, the right sensation 3620 has two orthogonal lines that cross together through the center point.

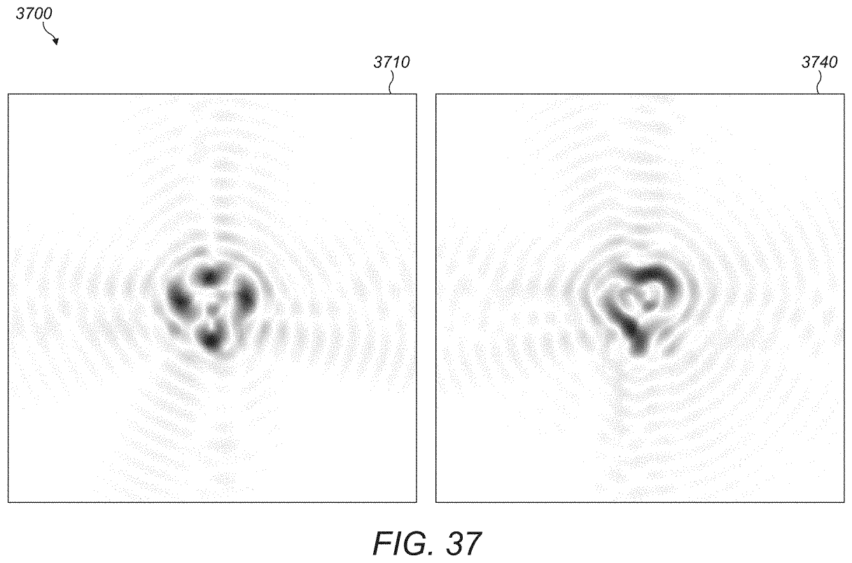

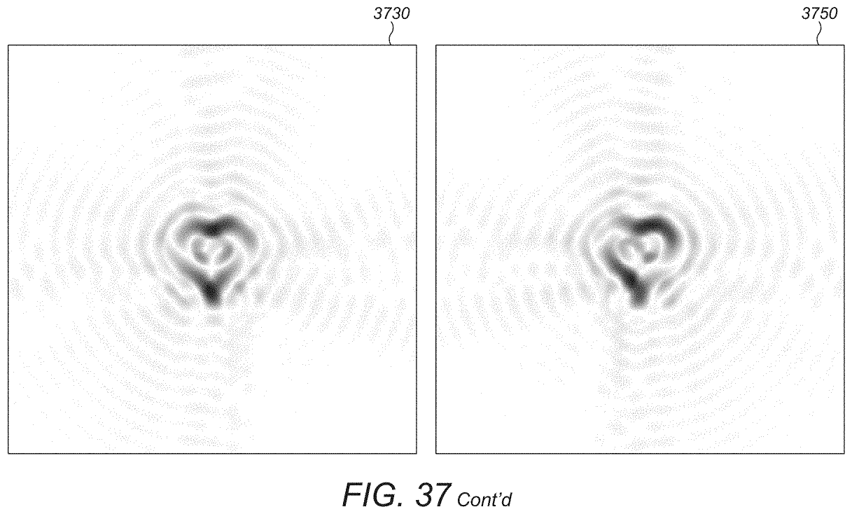

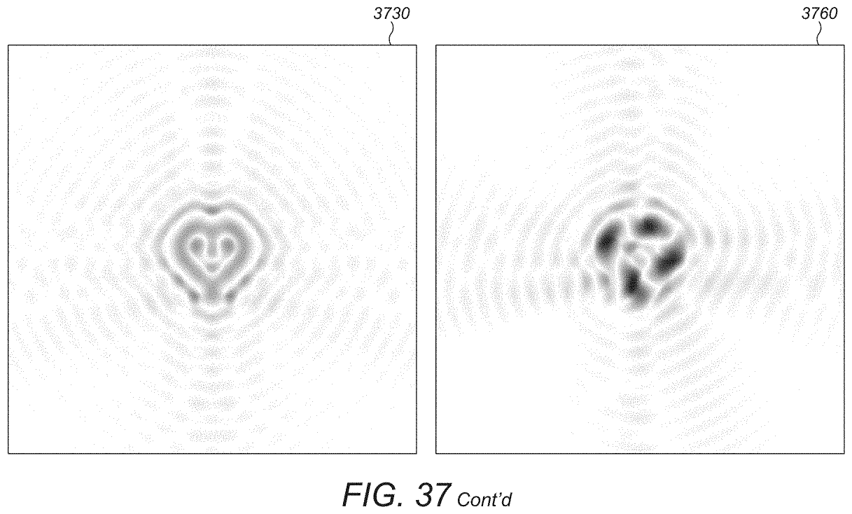

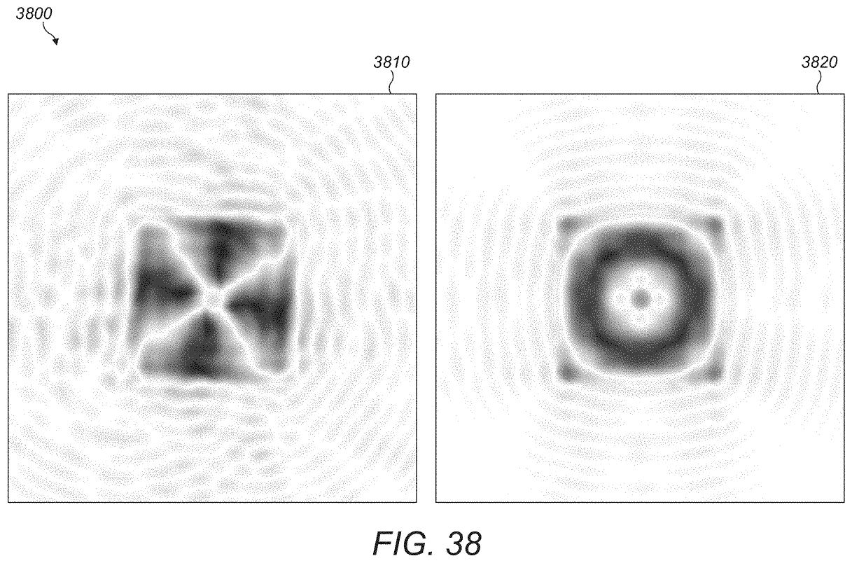

FIG. 37 shows a variety of different field partitioning schemes that yield the same scenario of a small heart shape in the center of the field with four high acoustic pressure regions, as shown in many of the later figures. FIG. 38 shows that the method is not limited to simple paths, as wavefronts and other features may be constructed that are not simple control points.

Specifically, FIG. 37 shows slices of the acoustic field 3700 generated from each of the carrier frequencies, where shading is linearly proportional to amplitude and phase angle. The left column 3710 3720 3730 is the first frequency and the right column 3740 3750 3760 is the second frequency, subtracting each phase configuration across the top 3710 3740, center 3720 3750 and bottom 3730 3760 rows generates the same four point system moving around a small heart shape.

FIG. 38 shows an acoustic field 300 with slices 3810 3820 generated from one of the carrier frequencies, where shading is linearly proportional to amplitude and phase angle. These show that the approach is not limited to control points but can create higher dimensional phase features.

One way to generate phased arrays using the ‘phase plates’ or solution fields described above is to populate transducers on locations of similar amplitude and phase. This has been described elsewhere, specifically in U.S. Ser. No. 63/156,829, filed on Mar. 4, 2021, which is incorporated by reference in its entirety.

Starting with a complex-valued solution, first a projection is made to a particular phase. Next, transducers are placed starting with the largest values and proceeding down to lower values in order. When a transducer is placed, an exclusion region based on the size of the transducer and its minimum spacing to other transducers is formed. Solution field values in this exclusion region are not considered for the next placement. When multiple solution fields are considered simultaneously, the exclusion region formed is applied to all fields. Fields are prioritized for population based on the sum of the solution field values for each placed transducer for each respective field. By populating based on a given projection, and driving all the transducers in phase, the desired acoustic field based on the solution field is produced.

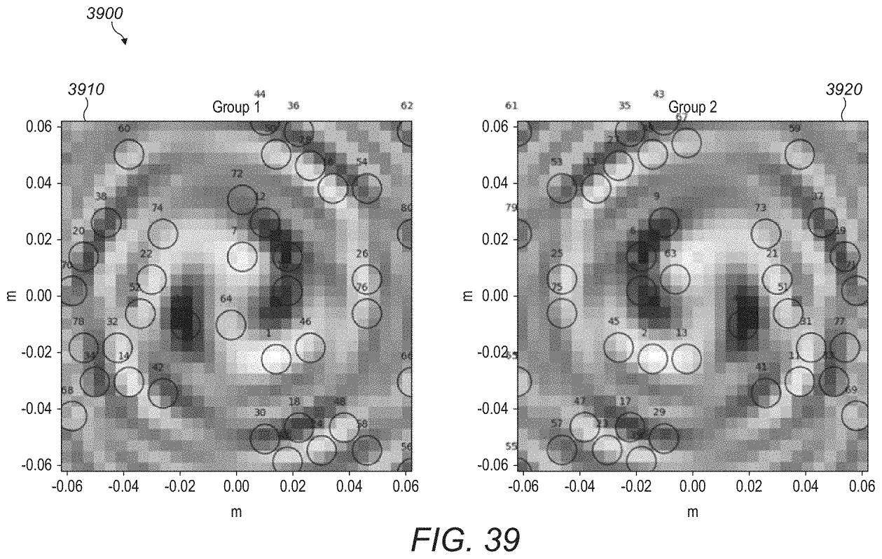

Error! Reference source not found. FIG. 39 shows the construction of a transducer layout populated using a solution field generated to form a heart-shaped high-pressure region at z=10 cm. As shown in FIG. 33, the field which results from this solution produces a shape of high pressure with one or more high-pressure regions moving around the shape at the carrier frequency. Various methods exist to generate solutions which change the rate and direction of these high-pressure regions along the same curve. For instance, adding more phase winding slows the movement of said regions, but also adds more. The example shown in Error! Reference source not found.ure 39 changes the movement by mirroring the solution field along the y-axis. Due to the symmetry of the field, this reverses the helicity of the high-pressure region's movement.

Specifically, FIG. 39 shows a grouped-transducer layout design 3900 based upon solution fields generated to form a heart-shaped pattern in a plane at z=10 cm. This corresponds to the upper-left simulation 3410 in FIG. 34. The solution fields shown are real projections with light values positive and dark values negative. Transducers for each of group 1 3910 and group 2 3920 are shown as circles. Some circles are truncated due to the extent of the solution field in this particular visualization. The fields are mirrored about they-axis to produce fields of opposite helicity which yields discrete high-pressure points when summed.

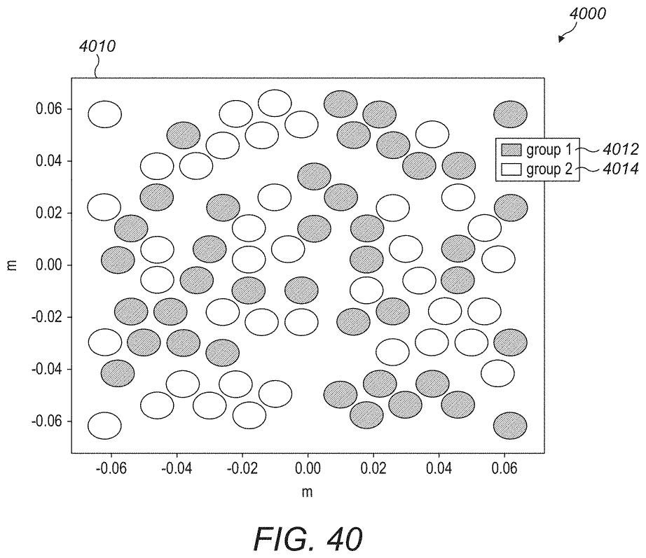

FIG. 40 shows the populated transducer array 4000 produced by solution fields group 1 4012 and group 2 4014 from FIG. 39.

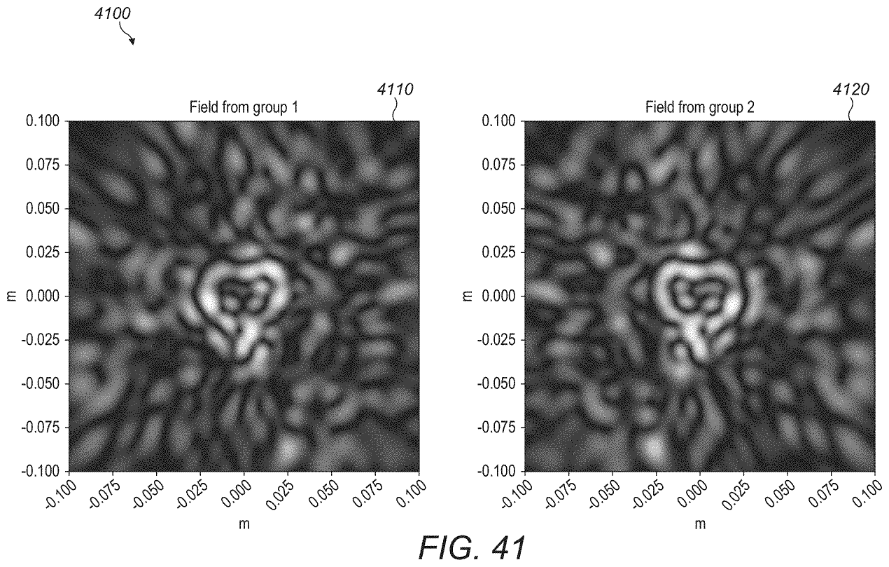

FIG. 41 shows a simulation of the normalized pressure amplitude at z=10 cm generated by each of group 1 4110 and group 2 4120 as shown in FIG. 40 at 40 kHz. A heart-shape is clearly visible in each plot. Each group is driven independently and in phase to form each field. The amplitude is shown rather than a real projection for clarity.

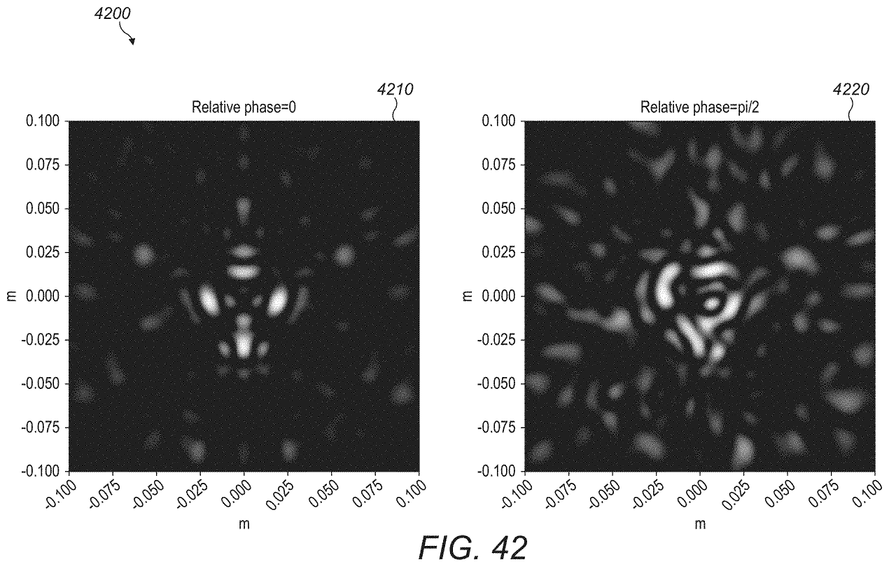

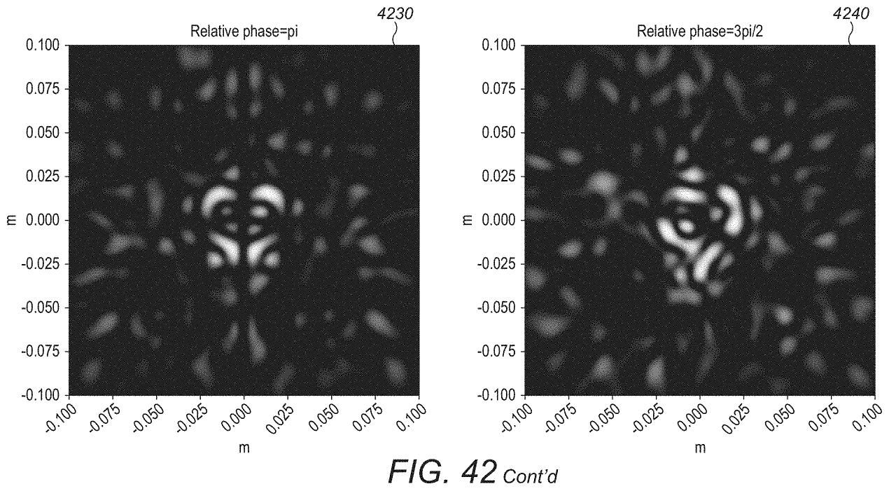

Producing these two fields simultaneously results in 4 high-pressure points which lie on the heart-shape as in FIG. 42, upper-left. Adjusting the relative phase of each group, the 4 points process around the heart-shape. This can yield a spatiotemporal haptic by adjusting the relative phase in a steady manner, repeating at a frequency for which human skin is most sensitive such as 100 Hz. One way this can be realized by driving one group at 50 Hz above the carrier frequency and one group 50 Hz below, as although due to the two on the denominator creating a modulation of 50 Hz, the modulation of the envelope by both positive and negative portions of the low-frequency sinusoid creates high acoustic pressure regions, which then have an apparent motion at 100 Hz, since as shown in FIG. 42 they are not distinct. The relatively small difference relative to an ultrasonic carrier frequency such as 40 kHz will preserve the heart-shaped solution while providing a continually, smoothly changing relative phase.

Specifically, FIG. 42 shows a normalized pressure field 4200 produced by an acoustic field simulation of the array shown in FIG. 40 at 40 kHz at z=10 cm with relative phase between groups 1 and 2 above each plot 4210 4220 4230 4240. The 4 points shown in the upper-left FIG. 4210 smoothly move around the heart-shape clockwise as the phase progresses.

### 5) Conclusion

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Moreover, in this document, relational terms such as first and second, top and bottom, and the like may be used solely to distinguish one entity or action from another entity or action without necessarily requiring or implying any actual such relationship or order between such entities or actions. The terms “comprises.” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. An apparatus comprising:
Singular Value Decomposition (SVD) with Tikhonov Regularization and Mini-Batch, Stochastic Gradient Descent with Momentum (MSGDM).

2. An method comprising:
adjusting in the placement of transducers, generating arrays which allow for variable focus points using a limited set of driving signals.
